(19) United States
(12) Patent Application Publication
(10) Pub. No.: US 2007/0182634 A1
(43) Pub. Date: Aug. 9, 2007

(54) Antenna device

(76) Inventors: Atsushi Yamamoto, Kadoma-shi (JP); Hiroshi Iwai, Kadoma-shi (JP); Koichi Ogawa, Kadoma-shi (JP); Shotaro Nishimura, Kadoma-shi (JP); Hirotaka Ishihara, Kadoma-shi (JP)

Correspondence Address: WENDEROTH, LIND & PONACK L.L.P., 2033 K. STREET, NW, SUITE 800, WASHINGTON, DC, 20006, US

(21) Appl. No.: 10/577,685

(22) PCT Filed: Oct. 28, 2004
(86) PCT No.: PCT/JP04/16000

§ 371 Date: Mar. 26, 2007

(30) Foreign Application Priority Data
Oct. 30, 2003 (JP) 2003-370137
Nov. 5, 2003 (JP) 2003-372601

(51) Int. Cl. H01Q 1/38

(52) U.S. Cl. 343/700 MS

(57) ABSTRACT

Four antenna units arranged adjacent to each other are respectively connected to switches, and are connected to load impedance elements via the switches, or connected to an output terminal and a comparator via a switch. Another ends of the load impedance elements are grounded. The comparator judges which antenna unit receives a radio signal having the maximum signal level among the antenna units. A controller controls the switches and the switch so that the antenna unit that receives the radio communication signal having the maximum signal level is connected to the output terminal and the other antenna units are connected to the load impedance elements.

### TECHNICAL FIELD

The present invention relates to an antenna apparatus including a plurality of antenna units arranged adjacent to each other and capable of radiating a main beam of a sector pattern and a radio communication apparatus using the antenna apparatus.

### BACKGROUND ART

An example of a sector pattern antenna apparatus according to a prior art is disclosed in the Patent Document 1. The sector pattern antenna apparatus according to the prior art is characterized in that a ground plate, a radiating element and reflecting plates provided on both sides and in a rear surface of the radiating element constitute each sector, and the reflecting plates on the both sides of the radiating element each include at least one fin in order to downsize a sectionalized three-dimensional corner reflector antenna apparatus, and to provide an antenna apparatus having uniformed antenna characteristics between sectors. In the above-mentioned arrangement, it is preferable that the ground plate, the reflecting plates and the fin are integrally formed to be made of the same metal, the respective sectors are radially arranged in a circular shape, and one of the sectors is selected by a switch. The number of fins and the size of each of the fins are designed in accordance with required antenna characteristics.

FIG. 2 of the Patent Document 1 discloses a radiation directivity of a prototype antenna when a length of each of side conductors is 2λ, (λ is a wavelength of a reference frequency f0 of a transmitted and received radio wave), a corner angle between the side conductors is 30 degrees, and a height of the side conductors and a reflecting conductor is 0.6λ in the case of the sector pattern antenna apparatus according to the prior art. In the prototype antenna, two electrically conductive fins are provided, the width and the length of the electrically conductive fins are set to 0.2λ and 1λ, respectively, and an interval between the reflecting conductor behind the radiating element and the antenna element is 0.4λ. In the above-mentioned example, the radiation directivity characteristic on the horizontal plane indicates a sector pattern beam of 36 degrees in a 3 dB beam width as shown in FIG. 2 (a) of the Patent Document 1, while the tilt angle of 26 degrees and the 3 dB beam width of 34 degrees are obtained in a radiation directivity characteristic on the vertical plane as shown in FIG. 2 (b). In the absence of the electrically conductive fin, the sector pattern beam results in the 3 dB beam width of 42 degrees, and this leads to that the presence of the electrically conductive fin serves to narrow the 3 dB beam width by 6 degrees. In addition, the radiation directivity characteristic on the vertical plane without any electrically conductive fin are the same as those with the electrically conductive fin having the tilt angle of 26 degrees and having the 3 dB beam width of 32 degrees.

Therefore, in the sector pattern antenna apparatus of the three-dimensional corner reflector antenna with the electrically conductive fin, which is recited in the Patent Document 1, the beam width in the radiation directivity characteristic on the horizontal plane alone can be sharpened with almost no change made to the shape and the tilt angle of the radiation directivity characteristic on the vertical plane because of the effect of controlling an electromagnetic field distribution obtained by the electrically conductive fin. As described above, according to the sector pattern antenna apparatus recited in the Patent Document 1, a superior small-sized antenna apparatus can be realized having a simple structure and a desired horizontal directivity.

Patent Document 1: Japanese patent laid-open publication No. JP-09-135115-A.

### DISCLOSURE OF THE INVENTION

1. Problems to be Solved by the Invention

However, the sector pattern antenna apparatus according to the prior art included the following problems. As described above, the sector pattern antenna apparatus according to the prior art has an antenna height (height of the reflecting conductor) of 0.6 wavelengths, which makes it difficult to say the sector antenna apparatus is thin. When the antenna is arranged on the ceiling or the like in the room, it is desirable for the antenna to have a small size and a thin shape to be inconspicuous. For example, when a radio frequency is 900 MHz, then the 0.6 wavelengths correspond to 198 mm, and a total height including a cover of the antenna apparatus becomes consequently at least a height equal to or larger than 200 mm. Therefore, it is such a problem that the above-mentioned antenna can be easily noticed because of the difficulty in providing a thin shape thereof.

An essential object of the present invention is, in order to solve the aforementioned problems, to provide an antenna apparatus having a reduced antenna height as compared with the prior art, having a reduced size, and having a reduced height, and capable of radiating the main beam of the sector pattern having a directivity strengthened in a desired direction and further changing the directivity and a radio communication apparatus including the antenna apparatus.

2. Means for Solving the Problems

According to the present invention, there is provided an antenna apparatus including a plurality of antenna units, at least one load impedance element, and control means. The plurality of antenna units respectively transmits and receives a radio signal using a main beam of a sector pattern thereof. The control means controls the antenna apparatus so that the antenna unit that transmits and receives the radio signal of the plurality of antenna units is connected to a radio communication apparatus circuit and the other antenna units are connected to the load impedance element.

In the above-mentioned antenna apparatus, the plurality of antenna units is arranged so that directions of the main beams of the respective antenna units are different to each other.

In addition, in the above-mentioned antenna apparatus, the plurality of antenna units is arranged so that directions of the main beams of the respective antenna units are orthogonal to each other.

Further, in the above-mentioned antenna apparatus, the control means controls the antenna apparatus so that the antenna unit that receives the radio signal having the maximum signal level among the radio signals received by the respective antenna units is connected to the radio communication apparatus circuit.

In the above-mentioned antenna apparatus, the plurality of antenna units is respectively formed by waveguide array antenna apparatus including a plurality of waveguide antenna units provided on a ground conductor, and each of waveguide antenna units includes a rectangular waveguide and an antenna element. Each of the rectangular waveguides includes the ground conductor, a ceiling conductor facing the ground conductor, and two side conductors that connect the ground conductor with the ceiling conductor and face each other, and has one end short-circuited by a terminating conductor and an open end. The open ends of the respective rectangular waveguides are arranged on corresponding sides of a polygon on the ground conductor having sides of the same number as that of the rectangular waveguides, and the rectangular waveguides extend outward from the corresponding sides of the polygon on the ground conductor. One ends of the respective antenna elements are electrically connected to the ceiling conductors in vicinity of the open ends of the respective rectangular waveguides, and another ends thereof are electrically connected to each of a plurality of feeding points arranged on the ground conductor. The waveguide antenna units respectively transmit and receive the radio signal using a predetermined directivity characteristic at the open ends of the rectangular waveguides constituting the waveguide antenna units.

In this case, the plurality of waveguide antenna units has substantially the same structure as each other, the open ends of the respective rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

In the above-mentioned antenna apparatus, the plurality of antenna units is respectively formed by a waveguide array antenna apparatus including a plurality of waveguide antenna units provided on a ground conductor, and each of the waveguide antenna units includes a rectangular waveguide and an antenna element. Each of the rectangular waveguides includes the ground conductor, a ceiling conductor facing the ground conductor, and two side conductors that connect the ground conductor with the ceiling conductor and face each other, and has one end short-circuited by a terminating conductor and an open end. The open ends of the respective rectangular waveguides are arranged on corresponding sides of a polygon on the ground conductor having sides of the same number as that of the rectangular waveguides, the rectangular waveguides extend outward from the corresponding sides of the polygon on the ground conductor, and at least one of the rectangular waveguides includes at least one slot formed in the ceiling conductor in a width direction of the rectangular waveguide. One ends of the respective antenna elements are electrically connected to the ceiling conductors in vicinity of the open ends of the respective rectangular waveguides, and another ends thereof are electrically connected to each of a plurality of feeding points arranged on the ground conductor. The waveguide antenna units respectively transmit and receive the radio signal using a predetermined directivity characteristic at the open ends of the rectangular waveguides constituting the waveguide antenna units.

In this case, the waveguide array antenna apparatus includes slots of the same number as an integral multiple of number of the feeding points, the slots are provided in each of the ceiling conductors constituting the waveguide antenna units of the same number as that of the feeding points, the numbers of the slots provided on the respective ceiling conductors are equal to each other, the plurality of the waveguide antenna units has the same structure as each other, the open ends of the rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

In addition, the slots are respectively formed at positions between connecting points with the antenna elements of the ceiling conductors, and the terminating conductors.

Further, at least one part of an internal space in each of the rectangular waveguides is filled with a dielectric material.

Still further, the ground conductor is made of an electrical conductor pattern formed on a first surface of a dielectric substrate having first and second surfaces opposing to each other. The respective ceiling conductors are made of an electrical conductor pattern formed on the second surface of the dielectric substrate. The side conductors and the terminating conductors are respectively formed by a plurality of through-hole conductors formed by filling through holes formed in the dielectric substrate in a thickness direction thereof with conductors.

In the above-mentioned antenna apparatus, the plurality of antenna units is respectively formed by a waveguide array antenna apparatus including a plurality of waveguide antenna units provided on a ground conductor, and each of the waveguide antenna units includes a rectangular waveguide and an antenna element. Each of the rectangular waveguides includes the ground conductor, a ceiling conductor facing the ground conductor, and two partitioning-wall conductors that connect the ground conductor with the ceiling conductor and face each other, and the rectangular waveguides are arranged in such manner that the partitioning-wall conductors are respectively shared between the two rectangular waveguides adjacent to each other. Each of the rectangular waveguides includes one end short-circuited by a terminating conductor and an open end, the open ends of the respective rectangular waveguides are arranged on corresponding sides of a polygon on the ground conductor having sides of the same number as that of the rectangular waveguides, and the rectangular waveguides extend outward from the corresponding sides of the polygon on the ground conductor. One ends of the respective antenna elements are electrically connected to the ceiling conductors in vicinity of the open ends of the respective rectangular waveguides, and another ends thereof are electrically connected to each of a plurality of feeding points arranged on the ground conductor. The waveguide antenna units respectively transmit and receive the radio signal using a predetermined directivity characteristic at the open ends of the rectangular waveguides constituting the waveguide antenna units.

In this case, the plurality of waveguide antenna units has the same structure as each other, the open ends of the respective rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

In the above-mentioned antenna apparatus, the plurality of antenna units is respectively formed by a waveguide array antenna apparatus including a plurality of waveguide antenna units provided on a ground conductor, and each of the waveguide antenna units includes a rectangular waveguide and an antenna element. Each of the rectangular waveguides includes the ground conductor, a ceiling conductor facing the ground conductor, and two partitioning-wall conductors that connect the ground conductor with the ceiling conductor and face each other, and the rectangular waveguides are arranged in such manner that the partitioning-wall conductors are respectively shared between the two rectangular waveguides adjacent to each other. Each of the rectangular waveguides has one end short-circuited by a terminating conductor and an open end, and the open ends of the respective rectangular waveguides are arranged on corresponding sides of a polygon on the ground conductor having sides of the same number as that of the rectangular waveguides. The rectangular waveguides extend outward from the corresponding sides of the polygon on the ground conductor, and at least one of the rectangular waveguides includes at least one slot formed in the ceiling conductor in a width direction of the rectangular waveguide. One ends of the respective antenna elements are electrically connected to the ceiling conductors in vicinity of the open ends of the respective rectangular waveguides, and another ends thereof are electrically connected to each of a plurality of feeding points arranged on the ground conductor. The waveguide antenna units respectively transmit and receive the radio signal using a predetermined directivity characteristic at the open ends of the rectangular waveguides constituting the waveguide antenna units.

In this case, the waveguide array antenna apparatus includes slots of the same number as an integral multiple of number of the feeding points, slots are provided in the ceiling conductors constituting the waveguide antenna units of the same number as that of the feeding points, the numbers of the slots provided in respective ceiling conductors are equal to each other, and the plurality of the waveguide antenna units has the same structure as each other. The open ends of the rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

In addition, the slots are respectively formed at positions between connecting points with the antenna elements of the ceiling conductors, and the terminating conductors.

Further, at least one part of an internal space in each of the rectangular waveguides is filled with a dielectric material.

Still further, the ground conductor is made of an electrical conductor pattern formed on a first surface of a dielectric substrate having first and second surfaces opposing to each other. The ceiling conductors are each made of an electrical conductor pattern formed on the second surface of the dielectric substrate. The partitioning-wall conductors and the terminating conductors are respectively formed by a plurality of through-hole conductors formed by filling through holes formed in the dielectric substrate in a thickness direction thereof with conductors.

### EFFECTS OF THE INVENTION

Accordingly, the antenna apparatus according to the first invention includes the plurality of antenna units each transmitting and receiving the radio signal using the main beam of the sector pattern, at least one load impedance element, and the control means for controlling the same apparatus so that the antenna unit for transmitting and receiving the radio signal of the plurality of antenna units is connected to the radio communication apparatus circuit and the other antenna unit is connected to the load impedance element. Therefore, the antenna apparatus can be realized for maintaining small and thin shape, having a simple structure, and being capable of radiating the radio wave in the desired direction with concentrating the power of the radio wave, and further, controlling the same apparatus so that the main beam having the maximum radiation gain is set in the direction in which the radio wave is desirably transmitted and received.

In addition, according to the antenna apparatus of the second invention, there is provided a waveguide array antenna apparatus including the plurality of waveguide antenna units provided on the ground conductor, each of the waveguide antenna units including a rectangular waveguide and an antenna element. In this case, each of the waveguide antenna units transmits and receives the radio signal according to the predetermined directivity characteristic at the open ends of the rectangular waveguides constituting the waveguide antenna units. Therefore, the antenna apparatus can be reduced in size, weight and thickness in shape and simply structured, and then, the antenna elements of the respective waveguide antenna units can be switched over or the output signals from the respective antenna elements are controlled to be combined so that the strengthened beam as compared with the prior art is radiated in the direction of the radio signal desirably transmitted and received.

Further, the slot is formed in the respective rectangular waveguides so that the directivity characteristic can be realized having the main beam achieving a larger gain. When the respective rectangular waveguides are arranged in the housing having a rectangular-parallelepiped shape, for example, it is possible to further downsize the antenna apparatus.

### BRIEF DESCRIPTION OF THE DRAWINGS

FIG. 1 is a perspective view showing a configuration of a waveguide array antenna apparatus according to a first embodiment of the present invention.

FIG. 2 is a perspective view showing a detailed configuration of a waveguide antenna unit 601a including an antenna element 13a shown in FIG. 1.

FIG. 3 is a perspective view showing an electric field distribution of the waveguide antenna unit 601a shown in FIG. 2.

FIG. 4 is a perspective view showing a magnetic current distribution of the waveguide antenna unit 601a shown in FIG. 2.

FIG. 5 is a block diagram showing an exemplified configuration of a switch for selectively changing a directivity characteristic of the waveguide array antenna apparatus shown in FIG. 1.

FIG. 6 is a perspective view showing a configuration of a waveguide array antenna apparatus according to a first implemental example of the first embodiment of the present invention.

FIG. 7 is a characteristic chart showing a frequency characteristic of a reflection coefficient S₁₁ of the waveguide array antenna apparatus shown in FIG. 6.

FIG. 8 is a characteristic chart of a radiation directivity characteristic at a frequency of 2.5 GHz of the waveguide array antenna apparatus shown in FIG. 6, showing a radiation directivity characteristic on the X-Y plane.

FIG. 9 is a characteristic chart of a radiation directivity characteristic at a frequency of 2.5 GHz of the waveguide array antenna apparatus shown in FIG. 6, showing a radiation directivity characteristic on the Z-X plane.

FIG. 10 is a characteristic chart of a radiation directivity characteristic on the X-Y plane of the waveguide array antenna apparatus when antenna elements 13a to 13d shown in FIG. 6 are operated to be selectively switched over.

FIG. 11 is a perspective view showing a configuration of a waveguide array antenna apparatus according to a second implemental example of the first embodiment of the present invention.

FIG. 12 is a characteristic chart of a radiation directivity characteristic of the waveguide array antenna apparatus shown in FIG. 11, showing a radiation directivity characteristic on the X-Y plane.

FIG. 13 is a characteristic chart of a radiation directivity characteristic of the waveguide array antenna apparatus shown in FIG. 11, showing a radiation directivity characteristic on the Z-X plane.

FIG. 14 is a characteristic chart of a radiation directivity characteristic on the X-Y plane of the waveguide array antenna apparatus when antenna elements 13a to 13d shown in FIG. 11 are operated to be selectively switched over.

FIG. 15 is a perspective view showing a configuration of a waveguide antenna unit 601a of a waveguide array antenna apparatus according to a first modified example of the first embodiment of the present invention.

FIG. 16 is a perspective view showing a configuration of a waveguide antenna unit 601a of a waveguide array antenna apparatus according to a second modified example of the first embodiment of the present invention.

FIG. 17 is a perspective view showing a configuration of a waveguide antenna unit 601a of a waveguide array antenna apparatus according to a third modified example of the first embodiment of the present invention.

FIG. 18 is a perspective view showing a configuration of a waveguide antenna unit 601a of a waveguide array antenna apparatus according to a fourth modified example of the first embodiment of the present invention.

FIG. 19 is a perspective view showing a configuration of a waveguide antenna unit 601a of a waveguide array antenna apparatus according to a fifth modified example of the first embodiment of the present invention.

FIG. 20 is a perspective view showing a configuration of a waveguide array antenna apparatus according to an implemental example of the fifth modified example of the first embodiment of the present invention.

FIG. 21 is a characteristic chart of a radiation directivity characteristic at a frequency of 2.5 GHz of the waveguide array antenna apparatus shown in FIG. 20, showing a radiation directivity characteristic on the X-Y plane.

FIG. 22 is a characteristic chart of a radiation directivity characteristic at a frequency of 2.5 GHz of the waveguide array antenna apparatus shown in FIG. 20, showing a radiation directivity characteristic on the Z-X plane.

FIG. 23 is a perspective view showing a configuration of a waveguide array antenna apparatus according to a sixth modified example of the first embodiment of the present invention.

FIG. 24 is a block diagram showing an example of a combining circuit for changing the directivity characteristic of the waveguide array antenna apparatus shown in FIG. 1.

FIG. 25 is a perspective view showing a configuration of a waveguide array antenna apparatus with slots according to a second embodiment of the present invention.

FIG. 26 is a perspective view showing a detailed configuration of a waveguide antenna unit 602a with a slot including an antenna element 13a shown in FIG. 25.

FIG. 27 is a sectional view of the waveguide antenna unit 602a with the slot shown in FIG. 26 cutting along an X-Z surface.

FIG. 28 is a perspective view showing an electric field distribution of the waveguide antenna unit 602a with the slot shown in FIG. 26.

FIG. 29 is a perspective view showing a magnetic current distribution of the waveguide antenna unit 602a with the slot shown in FIG. 26.

FIG. 30 is a perspective view showing a configuration of a waveguide array antenna apparatus with slots according to an implemental example of the second embodiment of the present invention.

FIG. 31 is a characteristic chart showing a frequency characteristic of a reflection coefficient S₁₁ of the waveguide array antenna apparatus with the slots shown in FIG. 30.

FIG. 32 is a characteristic chart of a radiation directivity characteristic at a frequency of 2.5 GHz of the waveguide array antenna apparatus with the slots shown in FIG. 26, showing a radiation directivity characteristic on the X-Y plane.

FIG. 33 is a characteristic chart of a radiation directivity characteristic at a frequency of 2.5 GHz of the waveguide array antenna apparatus with the slots shown in FIG. 26, showing a radiation directivity characteristic on the Z-X plane.

FIG. 34 is a perspective view showing a configuration of a waveguide array antenna apparatus of type integrally incorporated in a housing according to a third embodiment of the present invention.

FIG. 35 is a perspective view showing a configuration of a waveguide array antenna apparatus of type integrally incorporated in a housing according to an implemental example of the third embodiment of the present invention.

FIG. 36 is a characteristic chart of a radiation directivity characteristic at a frequency of 2.6 GHz of the waveguide array antenna apparatus of type integrally incorporated in the housing shown in FIG. 35, showing a radiation directivity characteristic on the X-Y plane.

FIG. 37 is a characteristic chart of a radiation directivity characteristic at a frequency of 2.6 GHz of the waveguide array antenna apparatus of type integrally incorporated in the housing shown in FIG. 35, showing a radiation directivity characteristic on the Z-X plane.

FIG. 38 is a perspective view showing a configuration of a waveguide array antenna apparatus with slots and of type integrally incorporated in a housing according to a fourth embodiment of the present invention.

FIG. 39 is a perspective view showing a configuration of a waveguide array antenna apparatus with slots and of type integrally incorporated in a housing according to a first implemental example of the fourth embodiment of the present invention.

FIG. 40 is a characteristic chart showing a frequency characteristic of a reflection coefficient S₁₁ of the waveguide array antenna apparatus with the slots and of type integrally incorporated in the housing shown in FIG. 39.

FIG. 41 is a characteristic chart of a radiation directivity characteristic at a frequency of 2.3 GHz of the waveguide array antenna apparatus with the slots and of type integrally incorporated in the housing shown in FIG. 32, showing radiation directivity characteristic on the X-Y plane.

FIG. 42 is a characteristic chart of a radiation directivity characteristic at a frequency of 2.3 GHz of the waveguide array antenna apparatus with the slots and of type integrally incorporated in the housing shown in FIG. 32, showing a radiation directivity characteristic on the Z-X plane.

FIG. 43 is a perspective view showing a configuration of a waveguide array antenna apparatus with slots and of type integrally incorporated in a housing according to a second implemental example of the fourth embodiment of the present invention.

FIG. 44 is a characteristic chart showing a frequency characteristic of a reflection coefficient S₁₁ of the waveguide array antenna apparatus with the slots and of type integrally incorporated in the housing shown in FIG. 35.

FIG. 45 is a perspective view showing a configuration of a waveguide array antenna apparatus according to a fifth embodiment of the present invention formed by filling an internal part of the antenna apparatus according to the first embodiment with a dielectric material.

FIG. 46 is a perspective view showing a configuration of a waveguide array antenna apparatus with slots according to a sixth embodiment of the present invention formed by filling an internal part of the antenna apparatus according to the second embodiment with the dielectric material.

FIG. 47 is a perspective view showing a configuration of a waveguide array antenna apparatus integrally incorporated in a housing according to a seventh embodiment of the present invention formed by filling an internal part of the antenna apparatus according to the third embodiment with the dielectric material.

FIG. 48 is a perspective view showing a configuration of a waveguide array antenna apparatus with slots and of type integrally incorporated in a housing according to an eighth embodiment of the present invention formed by filling an internal part of the antenna apparatus according to the fourth embodiment with the dielectric material.

FIG. 49 is a perspective view showing a configuration of a waveguide array antenna apparatus according to a ninth embodiment of the present invention.

FIG. 50 is a top view showing a configuration of a waveguide array antenna apparatus according to a tenth embodiment of the present invention.

FIG. 51 is a top view showing a configuration of a waveguide array antenna apparatus according to an eleventh embodiment of the present invention.

FIG. 52 is a block diagram showing a configuration of a sector pattern antenna apparatus according to a twelfth embodiment of the present invention.

FIG. 53 is a perspective view showing an external appearance of a specific example of a configuration of the sector pattern antenna apparatus shown in FIG. 52.

FIG. 54 is a perspective view showing an external appearance of one part of the sector pattern antenna apparatus shown in FIG. 53.

FIG. 55 is a perspective view showing a design example of a test model of the sector pattern antenna apparatus shown in FIG. 53.

FIG. 56 is a graph of measurement results of the sector pattern antenna apparatus shown in FIG. 55, showing a frequency characteristic of an input-end reflection coefficient of the antenna apparatus.

FIG. 57 is a graph of measurement results of the sector pattern antenna apparatus shown in FIG. 55, showing a frequency characteristic of an isolation of the antenna apparatus.

FIG. 58 is a graph of measurement results of the sector pattern antenna apparatus shown in FIG. 55, showing a radiation characteristic on the horizontal plane;

FIG. 59 is a graph of measurement results of the sector pattern antenna apparatus shown in FIG. 55, showing a radiation characteristic on the vertical plane;

FIG. 60 is a block diagram showing a configuration of a sector pattern antenna apparatus according to a first implemental example of the twelfth embodiment of the present invention.

FIG. 61 is a graph of measurement results of the sector pattern antenna apparatus shown in FIG. 60, showing a radiation gain and a relative gain with respect to a reactance value Xc.

FIG. 62 is a graph of measurement results of the sector pattern antenna apparatus shown in FIG. 60, showing a radiation characteristic on the horizontal plane;

FIG. 63 is a graph of measurement results of the sector pattern antenna apparatus shown in FIG. 60, showing a radiation characteristic on the vertical plane;

FIG. 64 is a block diagram showing an example of the configuration of a sector pattern antenna apparatus according to the first implemental example of the twelfth embodiment of the present invention.

FIG. 65 is a block diagram showing an example of a configuration of a sector pattern antenna apparatus according to a second implemental example of the twelfth embodiment of the present invention.

FIG. 66 is a graph of measurement results of the sector pattern antenna apparatus shown in FIG. 65, showing a radiation gain and a relative gain with respect to reactance values Xb=Xc=Xd.

FIG. 67 is a graph of measurement results of the sector pattern antenna apparatus shown in FIG. 65, showing a radiation characteristic on the horizontal plane;

FIG. 68 is a graph of measurement results of the sector pattern antenna apparatus shown in FIG. 65, showing a radiation characteristic on the vertical plane;

FIG. 69 is a block diagram showing an example of a configuration of a sector pattern antenna apparatus according to a third implemental example of the twelfth embodiment of the present invention.

FIG. 70 is a graph of measurement results of the sector pattern antenna apparatus shown in FIG. 69, showing a radiation gain and a relative gain with respect to reactance values Xb=Xd.

FIG. 71 is a graph of measurement results of the sector pattern antenna apparatus shown in FIG. 69, showing a radiation characteristic on the horizontal plane;

FIG. 72 is a graph of measurement results of the sector pattern antenna apparatus shown in FIG. 69, showing a radiation characteristic on the vertical plane;

FIG. 73 is a graph of measurement results of the sector pattern antenna apparatus shown in FIG. 69, showing a half-power angle of a sector pattern with respect to reactance values Xb=Xd.

FIG. 74 is a block diagram showing a configuration of a sector pattern antenna apparatus according to a first modified example of the twelfth embodiment of the present invention.

FIG. 75 is a block diagram showing a configuration of a sector pattern antenna apparatus according to a second modified example of the twelfth embodiment of the present invention.

FIG. 76 is a block diagram showing a configuration of a sector pattern antenna apparatus according to a third modified example of the twelfth embodiment of the present invention.

FIG. 77 is a block diagram showing a configuration of a sector pattern antenna apparatus according to a fourth modified example of the twelfth embodiment of the present invention.

FIG. 78 is a block diagram showing a configuration of a sector pattern antenna apparatus according to a fifth modified example of the twelfth embodiment of the present invention.

FIG. 79 is a block diagram showing a configuration of a sector pattern antenna apparatus according to a sixth modified example of the twelfth embodiment of the present invention.

### DESCRIPTION OF NUMERICAL REFERENCES

9 . . . feeding terminal,
10a, 10b, 10c 10d, 10e, 10f, 81a. . . connecting point,
11 . . . ground conductor,
12a, 12b, 12c, 12d. . . feeding point,
13a, 13b, 13c, 13d. . . antenna element,
14a, 14b, 14c 14d. . . terminating conductor,
15a, 15b, 15c, 15d, 15e, 15f. . . ceiling conductor,
16a1, 16a2, 16b1, 16b2, 16c1, 16c2, 16d1, 16d2 . . . side conductor,
17 . . . switch,
18 . . . received signal power judging unit,
19a, 19a-1, 19b-1, 19c-1, 19d-1, 19a-2 . . . matching conductor,
20a, 20a-1, 91, 92 . . . directivity characteristic controlling conductor,
21 . . . radome,
22a, 22b, 22c, 22d. . . amplitude adjuster circuit,
23a, 23b, 23c, 23d. . . phase shifter,
24 . . . combiner,
25 . . . antenna controller,
30a, 30b, 30c, 30d. . . slot,
31a, 31b, 31c, 31d. . . partitioning-wall conductor,
40 . . . dielectric material,
42 . . . through hole,
42c. . . through-hole conductor,
90 . . . radio communication apparatus circuit,
91 . . . controller,
92 . . . radio transmitter circuit,
93 . . . radio receiver circuit,
94 . . . circulator,
501a-501f, 502a-502d, 503a-503d, 504a-504d. . . rectangular waveguide,
601a-601f, 602a-602d, 603a-603d, 604a-604d. . . waveguide antenna unit,
701a, 701b, 701c, 701d. . . antenna unit,
702a, 702b, 702c, 702d, 704 . . . switch,
702A . . . switch device,
703a, 703b, 703c, 703d, 703a1, 703a2 . . . load impedance element,
705 . . . controller,
706 . . . output terminal,
707, 707A, 707B . . . comparator,
708 . . . signal combiner and distributor,
711 . . . ground conductor,
712a, 712b, 712c, 712d. . . feeding point,
713a, 713b, 713c, 713d. . . antenna element,
714a, 714b, 714c, 714d. . . matching conductor,
715a, 715b, 715c, 715d. . . ceiling conductor,
716a, 716b, 716c, 716d. . . slot,
717a, 717b, 717c, 717d. . . terminating conductor,
718a, 718b, 718c, 718d. . . partitioning-wall conductor,
801a, 801b, 801c, 801d. . . rectangular waveguide,
SW1, SW2, SW3, SW4 . . . switch, and
T11, T12, T13, T14, T21, T22, T23, T24 . . . terminal.

### DETAILED DESCRIPTION OF EMBODIMENTS

Hereinafter, embodiments of the present invention are described referring to the drawings. Like components are provided with the same reference symbols, and a three-dimensional XYZ coordinate system shown in each drawing is used with reference to the descriptions below.

### First Embodiment

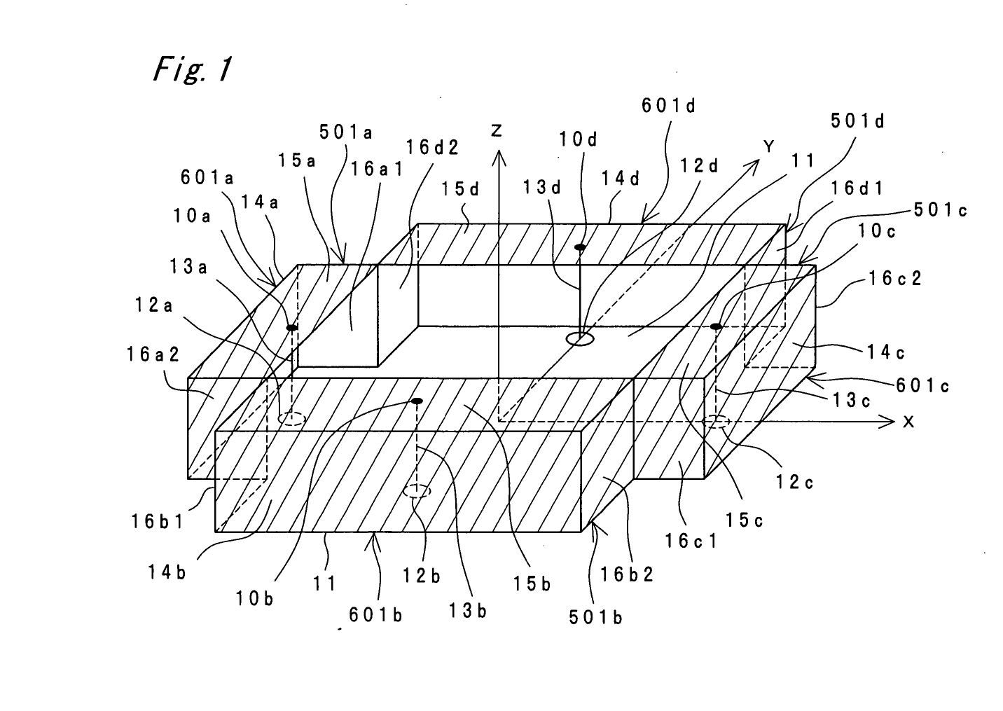

FIG. 1 is a perspective view showing a configuration of a waveguide array antenna apparatus according to a first embodiment of the present invention.

The waveguide array antenna apparatus is provided on a single ground conductor 11, and includes four waveguide antenna units 601a, 601b, 601c and 601d respectively including four rectangular waveguides 501a, 501b, 501c and 501d, and antenna elements 13a, 13b, 13c and 13d. These four waveguide antenna units 601a to 601d are provided so that main beams of respective radiation directivity characteristics have directions different from and orthogonal relative to each other. Therefore, a directivity characteristic of the waveguide array antenna apparatus can be changed when the antenna elements 13a to 13d that transmit and receive a radio signal are selectively switched over. The respective rectangular waveguides 501a to 501d include the ground conductor 11, the ceiling conductors 15a, 15b, 15c and 15d facing the ground conductor 11, and the side conductors (16a1 and 16a2), (16b1 and 16b2), (16c1 and 16c2) and (16d1 and 16d2) that respectively connect the ground conductor 11 with the ceiling conductors 15a to 15d, and further, have one ends short-circuited by terminating conductors 14a, 14b, 14c and 14d, and open ends. The open ends of the respective rectangular waveguides 501a to 501d are arranged on sides of a square shape (not shown) on the ground conductor 11, and the respective rectangular waveguides 501a to 501d extend outward from the sides of the square shape on the ground conductor 11.

In addition, one ends of the antenna elements 13a to 13d are electrically connected to the ceiling conductors 15a to 15d near the open ends of the rectangular waveguides 501a to 501d, while another ends thereof are electrically connected to feeding points 12a, 12b, 12c and 12d arranged on the ground conductor 11. Further, the waveguide antenna units 601a to 601d each transmit and receive the radio signal in accordance with a predetermined radiation directivity characteristic at the open ends of the rectangular waveguides 501a to 501d constituting the respective waveguide antenna units 601a to 601d. Because respective rectangular waveguides 501a to 501d are provided on the ground conductor 11 in the directions different from and orthogonal to each other, the main beams having the radiation directivity characteristics of these four waveguide antenna units 601a to 601d have the directions different to and orthogonal to each other. Therefore, the directivity characteristic of the waveguide array antenna apparatus can be changed when the respective antenna elements 13a to 13d that transmit and receive the radio signal are selectively switched over.

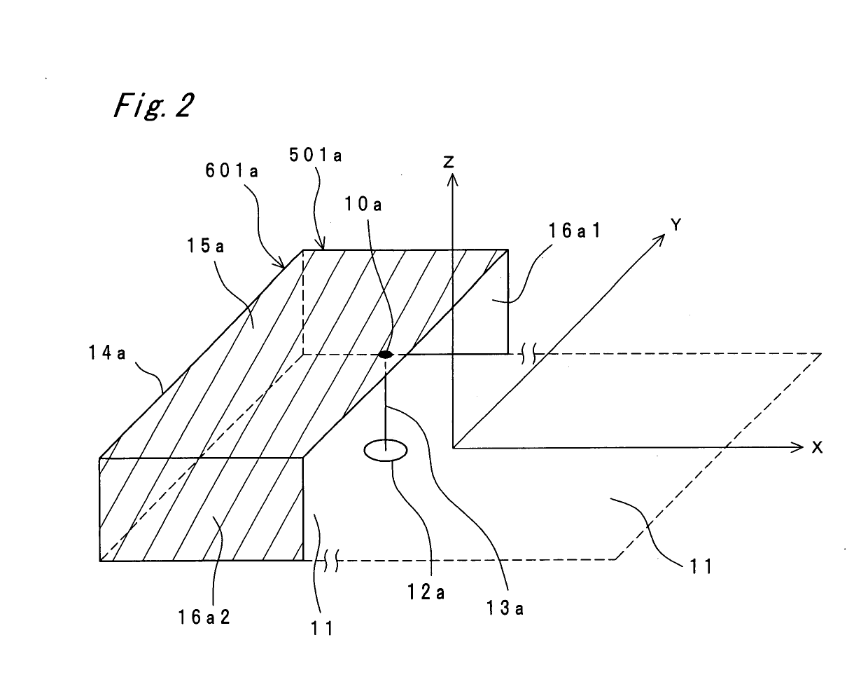

FIG. 2 is a perspective view showing a detailed configuration of the waveguide antenna unit 601a including the antenna element 13a, which is one part of the waveguide array antenna apparatus shown in FIG. 1.

Referring to FIG. 2, the waveguide antenna unit 601a includes the ground conductor 11 having the bottom surface arranged on the X-Y plane, the rectangular ceiling conductor 15a arranged on the top surface of the waveguide array antenna apparatus according to the present embodiment facing the ground conductor 11, and the rectangular waveguide 501a formed by the rectangular side conductors 16a1 and 16a2 that respectively connect the ground conductor 11 with the ceiling conductor 15a and face each other. The one end of the rectangular waveguide 501a is sealed so as to be short-circuited by the rectangular terminating conductor 14a, while another end of the rectangular waveguide 501a is free of the seal by the terminating conductor so as to be in an open state (hereinafter, the end is referred to as an open end). The ground conductor 11, the side conductors 16a1 and 16a2, the ceiling conductor 15a and the terminating conductor 14a are mechanically and electrically connected to each other, and then, those constitute the rectangular waveguide 501a for transmitting the radio signal in the direction parallel to the X direction having the sealed left end (the end in the −X direction), and formed in a shape of a substantially rectangular parallelepiped.

Next, one end of the antenna element 13a made of an electrical conductor wire or line is mechanically and electrically connected to a connecting point 10a in vicinity of the right end of the ceiling conductor 15a on the bottom surface thereof (near the end in the +X direction) and at the center in the Y direction (the length from the connecting point 10a through the terminating conductor 14c is set to the length of ¼ wavelengths of a guide wavelength from the terminating conductor 14c or the length obtained by multiplying the ¼ wavelengths by an odd number) by means of soldering. The antenna elements 13a vertically extends downward from the connecting point 10a, and further, another end of the antenna element 13a is connected to the feeding point 12a electrically insulated from the ground conductor 11, in a circular hole formed on the X axis on the ground conductor 11. The feeding point 12a is electrically connected to, for example, a central conductor of a coaxial cable, and a ground conductor of the coaxial cable is electrically connected to the ground conductor 11. Then, the radio signal is fed from a radio communication apparatus circuit 90 to the feeding point 12a via the coaxial cable.

The size of the rectangular waveguide 501a depends on the lowest frequency of the radio signal to be radiated, which means that the rectangular waveguide 501a is required to have such a size that the radio signal of the lowest frequency can be transmitted.

The waveguide antenna units 601b, 601c and 601d respectively including the antenna elements 13b, 13c and 13d are constituted in a manner similar to that of above. In the waveguide array antenna apparatus shown in FIG. 1, the waveguide antenna units 601 a and 601c respectively including the antenna elements 13a and 13c are arranged on the X axis with the open ends thereof facing each other, and the waveguide antenna units 601b and 601d respectively including the antenna elements 13b and 13d are arranged on the Y axis with the open ends thereof facing each other. At that time, the open ends of the rectangular waveguides 501a to 501d are provided so that they are arranged on the corresponding sides of the square shape on the ground conductor 11. Therefore, the side conductors 16a1 and 16d2 are electrically and mechanically connected to each other at the open ends of the rectangular waveguides 501a and 501d. In a manner similar to that of above, the side conductors 16a2 and 16b1 are electrically and mechanically connected to each other at the open ends of the rectangular waveguides 501a and 501b, the side conductors 16b2 and 16c1 are electrically and mechanically connected to each other at the open ends of the rectangular waveguides 501b and 501c, and the side conductors 16c2 and 16d1 are electrically and mechanically connected to each other at the open ends of the rectangular waveguides 501c and 501d.

The space surrounded by the housing formed by the ceiling conductors 15a to 15d, the terminating conductors 14a to 14d, the side conductors 16a1 and 16a2 to 16d1 and 16d2, and the ground conductor 11 is referred to as an antenna internal part hereinafter. A space on the reverse side of the antenna internal part relative to the ceiling conductors 15a to 15d, the terminating conductors 14a to 14d, the side conductors 16a1 and 16a2 to 16d1 and 16d2 or the ground conductor 11 is referred to as an antenna external part.

In the present embodiment, as an example, the ground conductor 11, the terminating conductors 14a to 14d, the side conductors 16a1 and 16a2 to 16d1 and 16d2 and the ceiling conductors 15a to 15d are electrically connected, the feeding points 12a to 12d are arranged on the X axis or Y axis, and the antenna elements 13a to 13d are each made of an electrical conductor wire or line vertical to the X-Y plane.

Next is described an operation of the waveguide array antenna apparatus according to the present embodiment referring to FIGS. 1 to 5.

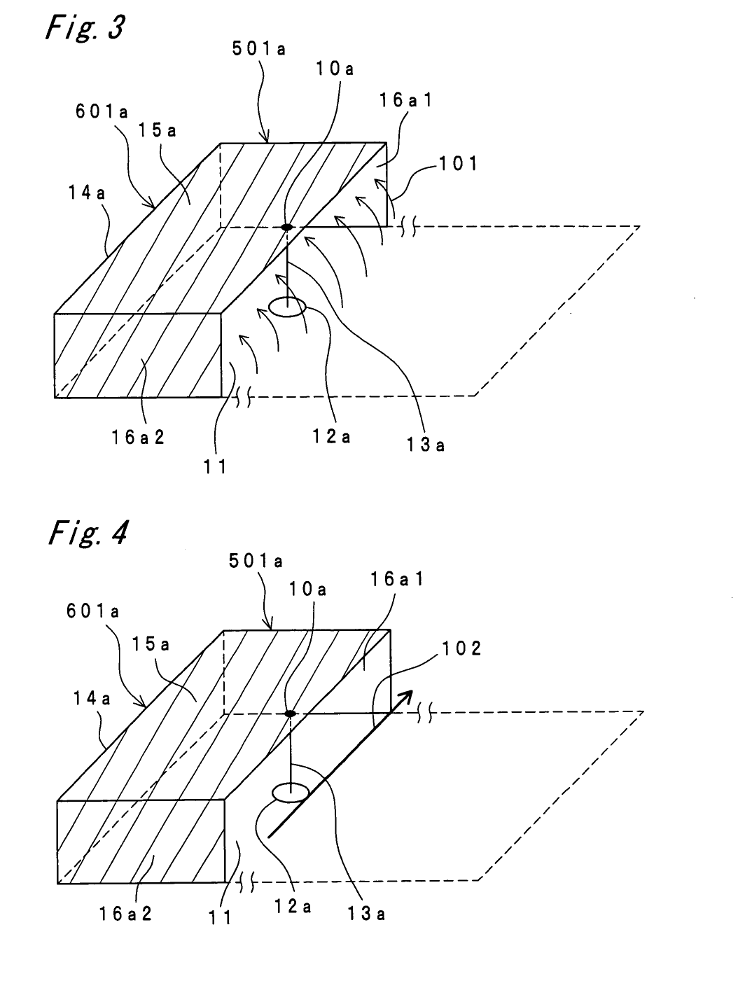

First of all, is described a principle of the operation of the waveguide array antenna apparatus according to the present embodiment when the radio signal is fed to only the antenna element 13a. FIG. 3 is a perspective view showing an electric field distribution of the waveguide antenna unit 601a shown in FIG. 2. FIG. 4 is a perspective view showing a magnetic current distribution of the waveguide antenna unit 601a shown in FIG. 2.

In the waveguide antenna unit 601a, radiation of an radio wave is performed by excitation of the antenna element 13a, and the radio wave is radiated by an electric field 101 generated between the ceiling conductor 15a and the ground conductor 11. The electric field 101 generated between the ceiling conductor 15a and the ground conductor 11 has the direction shown in FIG. 3. Replacing the electric field 101 with the magnetic current for description, a linear magnetic current 102 in parallel to the Y axis as shown in FIG. 4 can be mentioned as an example. It is noted that the radio wave is radiated by the magnetic current 102. The amplitude of the magnetic current 102 changes according to substantially a sine function, showing zero at both ends in the Y direction and showing the maximum value at the center in the Y direction. In other words, the waveguide antenna unit 601a shows a dipole directivity characteristic of the linear magnetic current 102 in parallel to the Y axis. The dipole allows a bi-directionality of a vertical polarization to be obtained on the X-Y plane and Y-Z plane and an omni-directivity on the Z-X plane.

The waveguide antenna unit 601a shown in FIG. 2 includes the ground conductor 11 located in the −Z direction for the dipole of the magnetic current 102, and the ground conductor 11 serves as a reflection plate. As a result, the radio wave is radiated intensively in the +Z direction. Further, the waveguide antenna unit 601a includes the terminating conductor 14a in the −X direction, which serves as a reflection plate, and this shows the directivity intensified in the +X direction. The configuration of the waveguide antenna unit 601a allows the directivity intensified in the +Z direction and +X direction of the XYZ coordinate system.

Therefore, the radio wave is radiated intensively in the +Y direction when the radio signal is fed to the antenna elements 13b of the waveguide array antenna apparatus shown in FIG. 1, the radio wave is radiated intensively in the −X direction when the radio signal is fed to the antenna element 13c, and the radio wave is radiated intensively in the −Y direction when the radio signal is fed to the antenna element 13d. In the waveguide array antenna apparatus according to the present embodiment, a switch (not shown) connected to the respective antenna elements 13a to 13d and for switching over to select the antenna element with a fed radio signal is used to operate the antenna element having the intensified directivity in the desired direction. As a result, a directivity changeover antenna apparatus can be realized for being capable of changing the direction of the radiated radio wave. This leads to coverage in a range of 360 degrees on the horizontal plane.

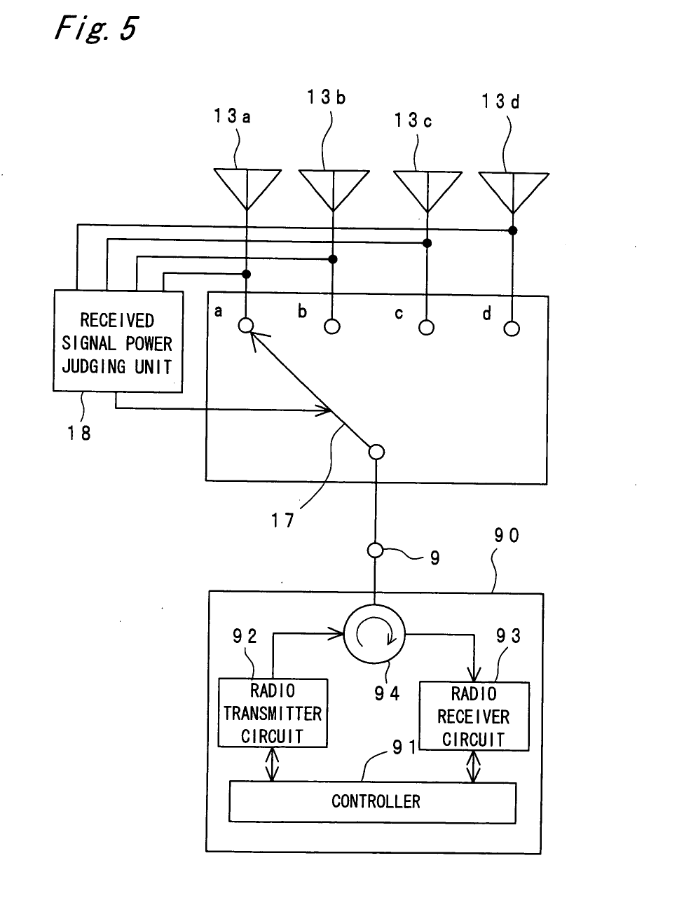

In addition, in the above-mentioned embodiment, the waveguide array antenna apparatus is described with reference to the example of radiating the radio wave therefrom. However, the same configuration can be applied when the radio wave (radio signal) is received. FIG. 5 is a block diagram showing an exemplified configuration of the switch for selectively changing the directivity characteristic of the waveguide array antenna apparatus shown in FIG. 1. In the example shown in the drawings, the radio communication apparatus circuit 90 is connected to the antenna element (one of 13a to 13d) having the intensified directivity in a direction, in which the radio wave arrives via the feeding terminal 9 and the feeding cable so that a larger received power can be obtained.

Referring to FIG. 5, the radio communication apparatus circuit 90 includes a radio transmitter circuit 92, a radio receiver circuit 93, a controller 91 for controlling operations of these circuits 92 and 93, and a circulator 94. The radio transmitter circuit 92 digitally modulates a radio carrier wave in accordance with an inputted digital data signal (including, for example, audio, image, various data and the like), and thereafter, generates the radio signal through power amplification. The radio signal is radiated from one of the antenna elements selected as described earlier (one of 13a to 13d) via the circulator 94, while the radio signal received via one of the selected antenna elements (one of 13a to 13d) is inputted to the radio receiver circuit 93 via the circulator 94 of the radio communication apparatus circuit 90. The radio receiver circuit 93 executes processings such as high-frequency amplification, frequency conversion, intermediate-frequency amplification and demodulation on a received radio signal so as to extract a digital data signal included in the received radio signal. Thus, the entire apparatus shown in FIG. 5 constitutes the radio communication apparatus. Any apparatus described in detail later may also include the antenna apparatus including the plurality of antenna elements and the radio communication apparatus circuit 90, and this constitutes the radio communication apparatus.

Referring to FIG. 5, when the radio wave arrives from the +X direction, for example, the feeding cable is connected to the antenna element 13a via a switch 17. More concretely, as shown in FIG. 5, a received signal power judging unit 18 judges power levels of the radio waves (or signal levels of the radio wave) received via the respective antenna elements 13a to 13d to control the switch 17 so that the antenna element having the maximum power level of the received radio wave is operated. As a result, the directivity changeover antenna apparatus can be realized for being capable of selectively changing the direction of the main beam to the direction of the arrived radio wave. This leads to coverage in a range of 360 degrees range on the horizontal plane.

### First Implemental Example of the First Embodiment

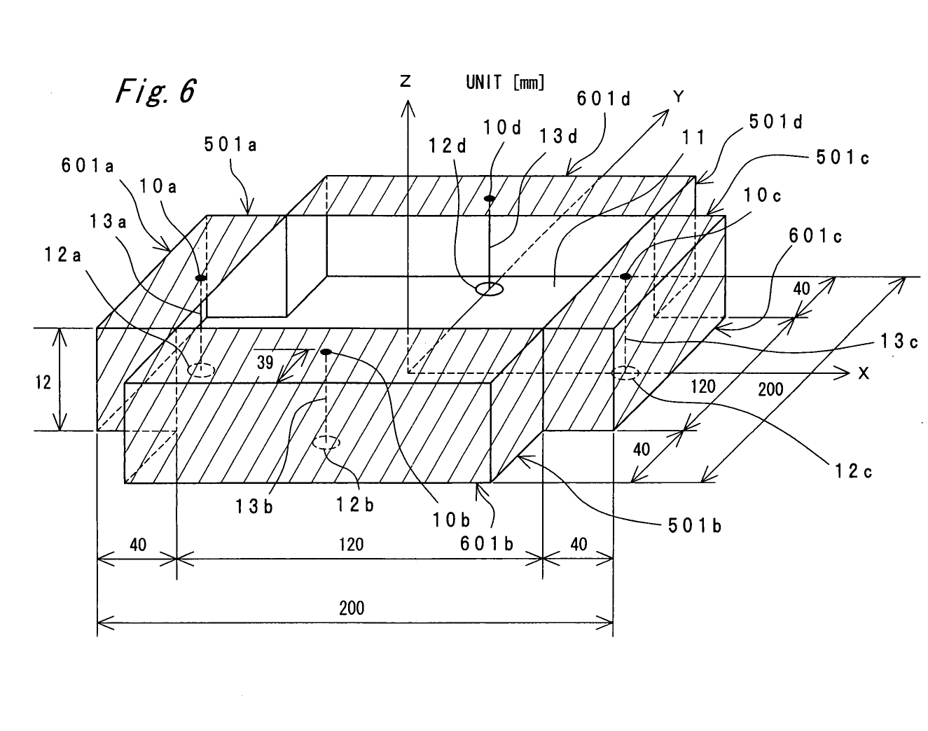

Next, a prototype waveguide array antenna apparatus actually manufactured is shown in FIG. 6. FIG. 6 is a perspective view showing a configuration of a waveguide array antenna apparatus according to a first implemental example of the first embodiment of the present invention.

Referring to FIG. 6, as an example, a length of the terminating conductors 14a to 14d on the X-Y plane relative to a width of the rectangular waveguides 501a to 501d is 120 mm, and a length of the terminating conductors 14a to 14d and the side conductors 16a1 and 16a2 to 16d1 and 16d2 in the Z axis direction relative to a height of the rectangular waveguides 501a to 501d is 12 mm. A length of the side conductors 16a1 and 16a2 to 16d1 and 16d2 on the X-Y plane and a width of the ceiling conductors 15a to 15d relative to a depth of the rectangular waveguides 501a to 501d are 40 m. The feeding points 12a to 12d are respectively arranged on the X axis or the Y axis.

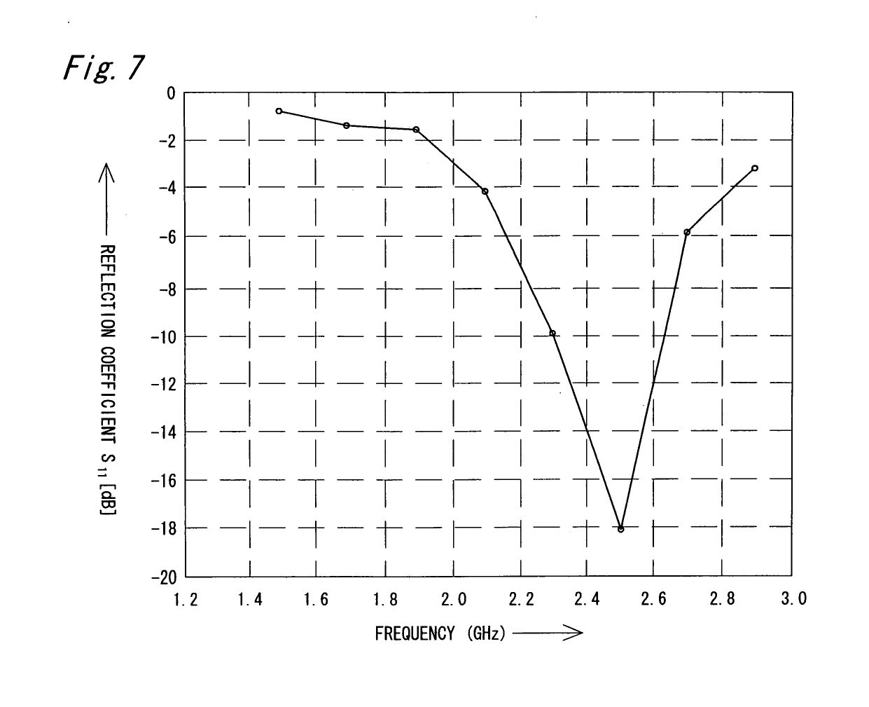

Below are described characteristics when the waveguide array antenna apparatus has the dimensions shown in FIG. 5 in respective characteristic charts shown in FIGS. 7 to 10. FIG. 7 is a characteristic chart showing a frequency characteristic of a reflection coefficient S₁₁ of the waveguide array antenna apparatus shown in FIG. 6. It is understood from FIG. 7 that the waveguide array antenna apparatus shown in FIG. 6, which is a prototype of the present embodiment, resonates at a frequency of 2.5 GHz showing a favorable reflection characteristic. Because the waveguide array antenna apparatus has a symmetrical shape, the same characteristics can be obtained when the radio signal is fed to the antenna elements 13b, 13c and 13d.

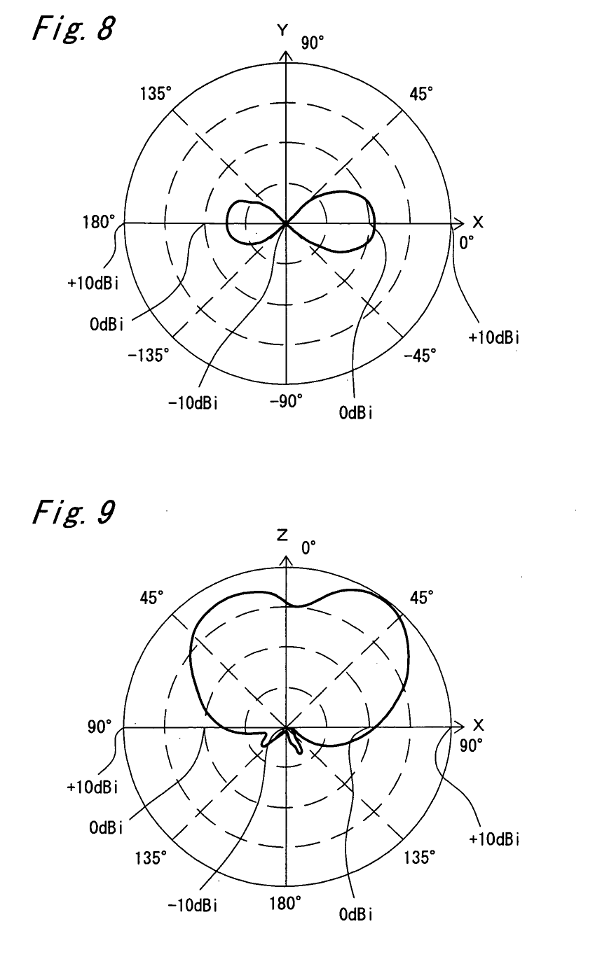

FIGS. 8 and 9 are characteristic charts of a radiation directivity characteristic when the radio signal having the frequency of 2.5 GHz is fed to the antenna element 13a of the waveguide array antenna apparatus shown in FIG. 6, where the radiation directivity characteristic on the X-Y plane (on the horizontal plane) is shown in FIG. 8, and the radiation directivity characteristic on the Z-X plane (on the vertical plane) is shown in FIG. 9. In FIGS. 8 and 9, scales in the characteristic charts relating to the radiation directivity characteristic are spaced at the interval of 10 dB, and the unit is dBi based on a radiation power of an ideal point wave source. It is understood from FIG. 9 that the radiation of the radio wave shows the directivity intensified in the +Z direction and +X direction, and the waveguide array antenna apparatus according to the present embodiment has a simple structure and realizes a directivity intensified in one direction. The maximum radiation is directed to the angle of 35 degrees from the Z axis toward the +X direction on the vertical plane. At this angle, the relatively large gain of 9.5 dBi was obtained, and the gain of 1.0 dBi was obtained in the positive direction on the X axis on the horizontal plane.

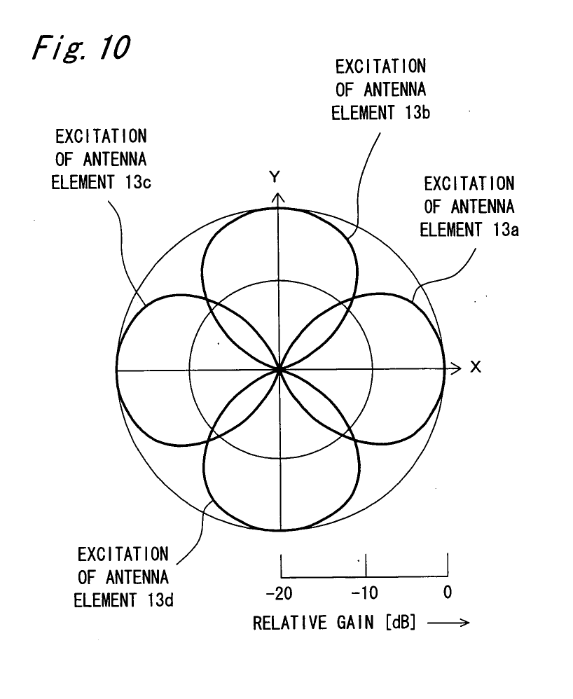

FIG. 10 is a characteristic chart of a radiation directivity characteristic on the X-Y plane of the waveguide array antenna apparatus when the antenna elements 13a to 13d shown in FIG. 6 are operated to be selectively switched over. In the characteristic chart, only the main beam of the radiation directivity characteristic is shown, while side lobes are omitted. When the antenna elements with fed radio signals are thus changed, the direction of the radiated radio wave can be changed. In the above-mentioned embodiment, the waveguide array antenna apparatus is described with reference to the example of radiating the radio wave therefrom. However, the same configuration can be applied when the radio wave is received. In that case, the feeding cable (not shown) is connected to the antenna element having the directivity intensified in the direction of the arrived radio wave so that a larger received power can be obtained. For example, when the radio wave arrives from the +X direction, the antenna 13a is connected to the feeding cable via the switch 17 as shown in FIG. 5

According to the waveguide array antenna apparatus according to the present embodiment constituted as described above, the antenna apparatus can be realized for being capable of radiating the power of the radio wave with concentration in the direction of the desirably transmitted radio wave. Further, the waveguide array antenna apparatus according to the present embodiment realizes the antenna apparatus having a height in the Z axis direction of 0.1 wavelengths at the operation frequency of 2.5 GHz, which is a very thin antenna apparatus.

In the above-mentioned embodiment and the implemental example, the waveguide array antenna apparatus having the symmetrical structure relative to the Z-X plane and the Z-Y plane is described. Such a structure has such an advantageous effect that the directivity characteristic of the radio wave radiated from the waveguide array antenna apparatus is symmetrical relative to the Z-X plane and the Z-Y plane.

As described above, according to the waveguide array antenna apparatus of the present embodiment, the antenna apparatus can be realized having a reduced size, weight and thickness in shape, having a simplified structure and capable of selectively switching over the main beam having the intensified directivity in the directions different from each other.

### Second Implemental Example of the First Embodiment

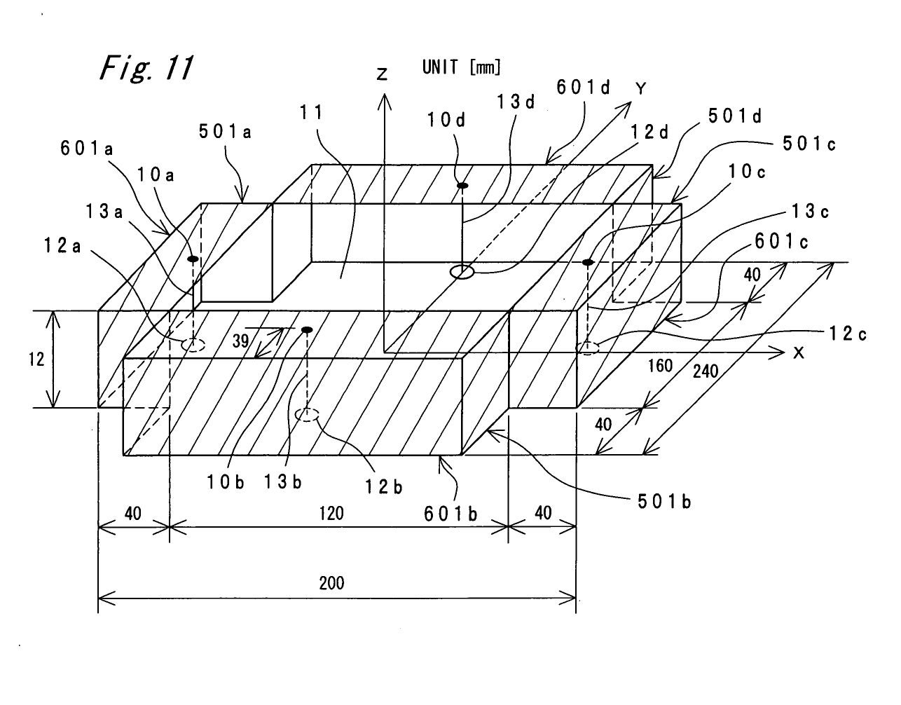

FIG. 11 is a perspective view showing a configuration of a waveguide array antenna apparatus according to a second implemental example of the first embodiment of the present invention.

In the first implemental example of the present embodiment, the waveguide array antenna apparatus symmetrical relative to the Z-X plane and the Z-Y plane and having the same sectional shapes on the Z-X plane and the Z-Y plane is described. However, the present invention is not limited thereto. For example, when a space into which the radio wave is radiated is extended in the ±X direction, the antenna apparatus may be formed into a shape extended in the Y direction as shown in FIG. 11. Referring to FIG. 11, the width of the waveguide antenna units 601a and 601c including the antenna elements 12a and 12c (namely, corresponding to the lengths of the terminating conductor 14a and 14c and the ceiling conductors 15a and 15c in the Y axis direction) is extended to reach 160 mm, and accompanying with this, the ground conductor 11 is also extended in the Y axis direction. The width of the waveguide antenna units 601b and 602d including the antenna elements 12b and 12d as well as the other dimensions are the same as those of the implemental example of FIG. 6.

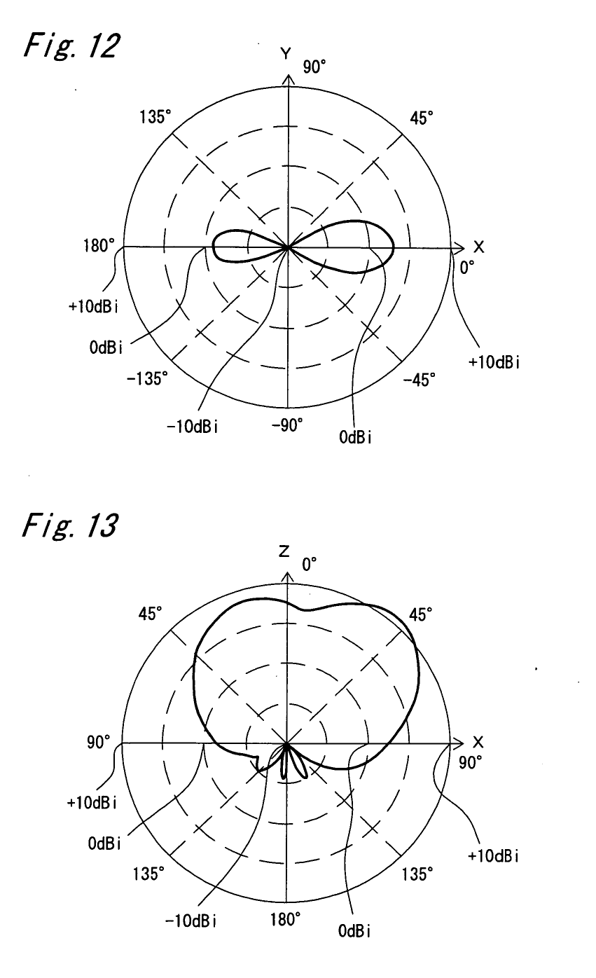

FIGS. 12 and 13 are characteristic charts of radiation directivity characteristics when the radio signal is fed to the antenna element 13a of the waveguide array antenna apparatus shown in FIG. 11, where the radiation directivity characteristic on the X-Y plane is shown in FIG. 12, and the radiation directivity characteristic on the Z-X plane is shown in FIG. 13. According to the characteristic charts, the maximum radiation is directed to the angle of 35 degrees from the Z axis toward the +X direction on the vertical plane, the relatively large gain of 10.5 dBi was obtained, and the gain of 3.0 dBi was obtained in the positive direction on the X axis on the horizontal plane. The structure shown in FIG. 11 intensifies the directivity in the ±X direction. Comparing FIG. 12 with FIG. 8, it is understood that the gain is increased by 2 dB on the horizontal plane when the width of the rectangular waveguides 501a and 501c including the antenna elements 13a and 13c of the waveguide array antenna apparatus is increased by 40 mm in the Y axis direction.

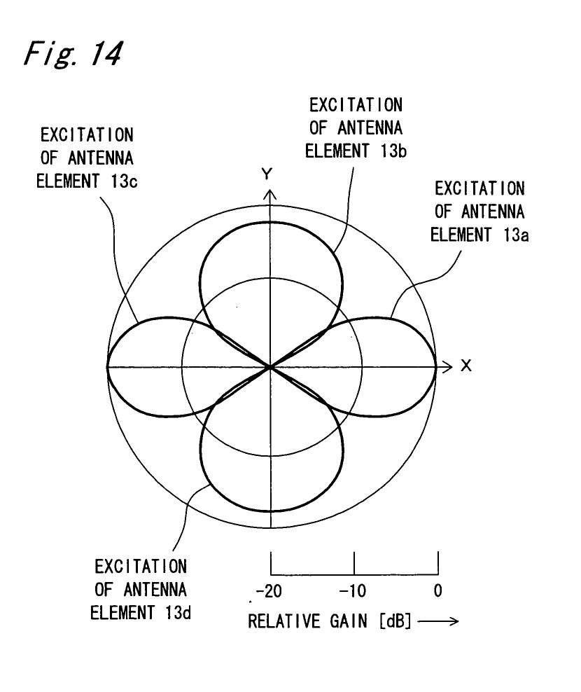

FIG. 14 is a characteristic chart of a radiation directivity characteristic on the X-Y plane of the waveguide array antenna apparatus when the antenna elements 13a to 13d shown in FIG. 11 are operated to be selectively switched over. In the characteristic chart, only the main beam of the radiation directivity characteristic is shown, and the side lobes are omitted. As is apparent from FIG. 14, in the waveguide array antenna apparatus according to the present implemental example, the directivity intensified in the X direction, and the antenna suitable for the radiation space extended in the ±X direction can be provided. Thus, the antenna apparatus having the radiation directivity characteristic that is the most suitable for the radiation space can be realized by changing the lengths of the waveguide array antenna apparatus in the X direction and Y direction.

In the present embodiment, the waveguide array antenna apparatus having the structure symmetrical relative to the Z-X plane and Z-Y plane is described as an example. However, the present invention is not limited thereto. For example, the waveguide array antenna apparatus may have a structure symmetrical relative to only one of the Z-X plane and Z-Y plane in order to obtain a desired radiation directivity characteristic or input impedance characteristic. According to the structure, the antenna apparatus can be realized having a radiation directivity characteristic that is the most suitable for the radiation space.

In the present embodiment, the waveguide array antenna apparatus in which the antenna elements 13a to 13d are each made of an electrical conductor wire or line is described as an example. However, the present invention is not limited thereto. For example, the antenna elements 13a to 13d may be made of an electrical conductor having a plate shape. This leads to that the desired input impedance characteristic can be obtained so that the antenna apparatus having a lessened reflection loss and having a higher efficiency can be effectively realized.

### Modified Examples of the First Embodiment

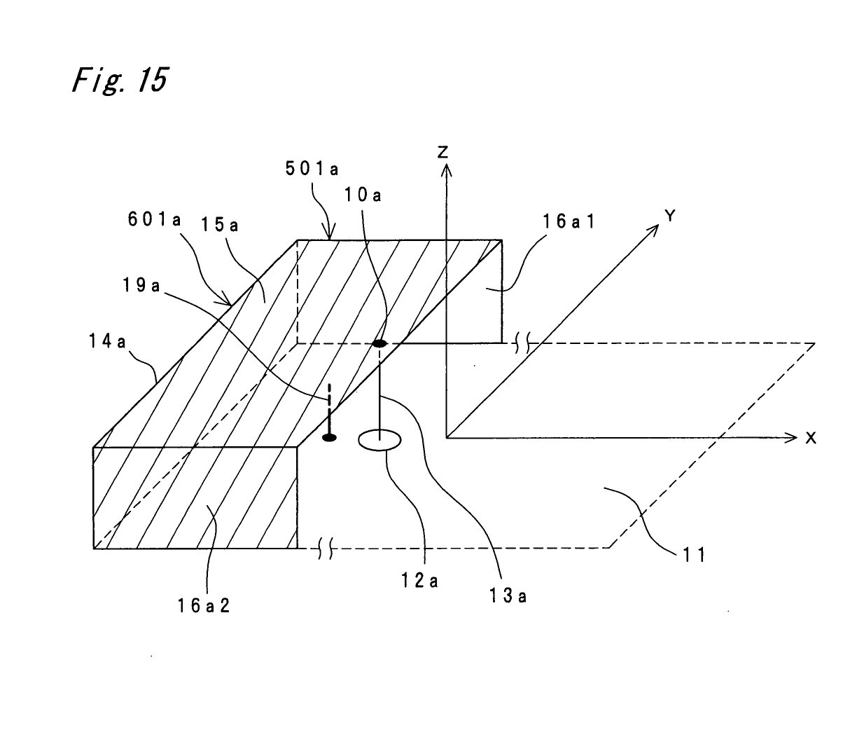

FIG. 15 is a perspective view showing a configuration of a waveguide antenna unit 601a of a waveguide array antenna apparatus according to a first modified example of the first embodiment of the present invention.

In order to obtain the desired input impedance characteristic, as shown in FIG. 15, a matching conductor 19a may be additionally provided in the configuration of the waveguide antenna unit 601a shown in FIG. 2. In the waveguide antenna unit 601a shown in FIG. 15, the matching conductor 19a made of a linear conductor is electrically connected to the ground conductor 11 at a position on the X axis of the ground conductor 11 in parallel to the antenna element 13a and slightly shifted from the antenna 13a in the −X direction (that is a position slightly shifted from the antenna element 13a in the direction toward the terminating conductor 14a and near the feeding point 12a) and extends upward from the connecting point on the ground conductor 11. The matching conductor 19a has a length shorter than the height of the rectangular waveguide 501a (that is the height of the terminating conductor 14a and the side conductors 16a1 and 16a2). In the case of providing the matching conductor 19a, the electric field in the vicinity of the antenna element 13a, and the current flowing in the antenna element 13a can be changed. Accordingly, the input impedance of the waveguide array antenna apparatus can be changed so that the input impedance of the waveguide array antenna apparatus substantially corresponds to a characteristic impedance of the coaxial cable. This leads to that the desired input impedance characteristic can be obtained so that the antenna apparatus having a less reflection loss to have a higher efficiency can be effectively realized.

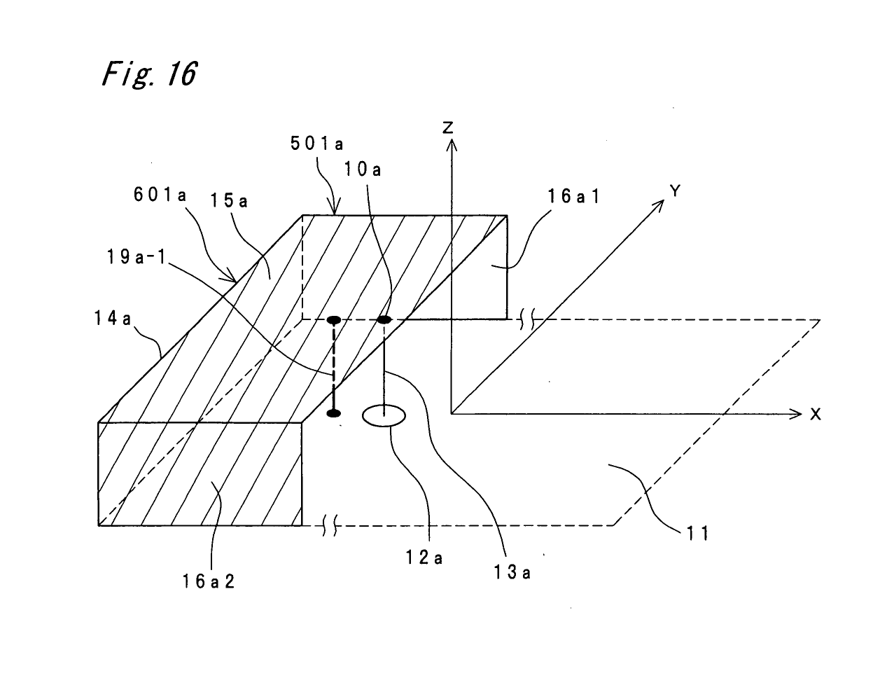

FIG. 16 is a perspective view showing a configuration of a waveguide antenna unit 601a of a waveguide array antenna apparatus according to a second modified example of the first embodiment of the present invention. In order to obtain the desired impedance characteristic, as shown in FIG. 16, a matching conductor 19a-1 having the same length as that of the antenna element 13a may be additionally connected in parallel to the antenna element 13a of the configuration of the waveguide antenna unit 601a shown in FIG. 2. In the case of providing the matching conductor 19a-1, one end of the matching conductor 19a-1 is connected to the ground conductor 11, while another end thereof is connected to the ceiling conductor 15a.

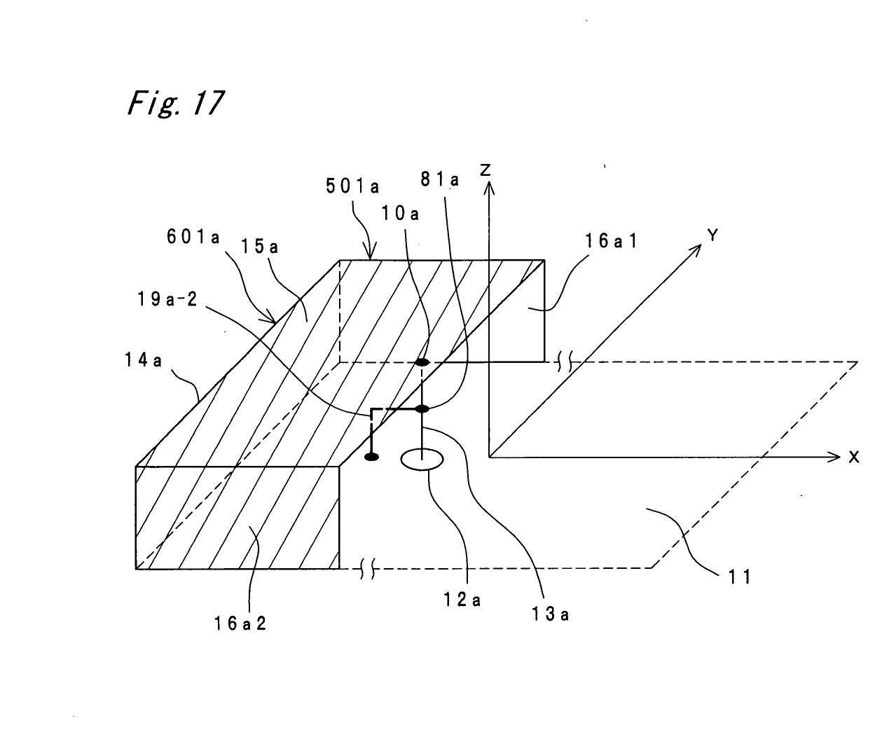

FIG. 17 is a perspective view showing a configuration of a waveguide antenna unit 601a of a waveguide array antenna apparatus according to a third modified example of the first embodiment of the present invention.

In order to obtain the desired impedance characteristic, as shown in FIG. 17, a matching conductor 19a-2 may be additionally provided in the waveguide antenna unit 601a shown in FIG. 2. Referring to FIG. 17, the matching conductor 19a-2 of a linear conductor is electrically connected to the ground conductor 11 and extends upward from the connecting point on the ground conductor 11, and then, bent substantially at the right angle and electrically connected to a connecting point 81a substantially at the central part of the antenna element 13a. This leads to that the current flowing in the antenna element 13a can be directly changed via the matching conductor 19a-2 so that the impedance characteristic can be effectively largely changed. Therefore, the input impedance of the waveguide array. antenna apparatus can be changed so that, for example, the input impedance of the waveguide array antenna apparatus can be substantially equal to the characteristic impedance of the coaxial cable. As a result, the desired input impedance can be obtained, and the antenna apparatus can be realized having a less reflection loss and having a higher efficiency. The method of adjusting the impedance of the antenna element 13a is described with reference to FIGS. 15 to 17. The respective modified examples have the same advantageous effect as that of the other antenna elements 13b to 13d.

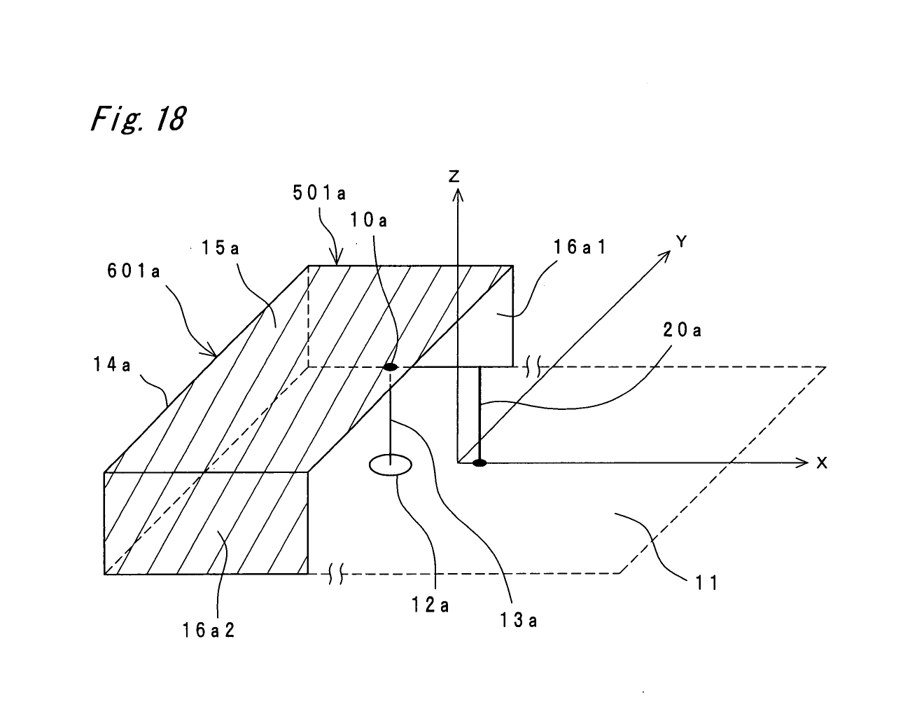

FIG. 18 is a perspective view showing a configuration of a waveguide antenna unit 601a of a waveguide array antenna apparatus according to a fourth modified example of the first embodiment of the present invention. In order to change the radiation directivity characteristic of the waveguide array antenna apparatus according to the present embodiment, a directivity characteristic controlling conductor 20a is additionally provided in the waveguide antenna unit 601a of FIG. 2 as shown in FIG. 18.

Referring to FIG. 18, the directivity characteristic controlling conductor 20a made of a linear conductor is provided on the X axis on the top surface of the ground conductor 11 to be positioned in the positive direction on the X axis relative to the antenna element 13a. One end of the directivity characteristic controlling conductor 20a is connected to the ground conductor 11 at the connecting point 10a, and the directivity characteristic controlling conductor 20a extends upward from the one end. The directivity characteristic controlling conductor 20a has a length substantially equal to the height of the rectangular waveguide 501a or a length slightly shorter than the same. Because the directivity characteristic controlling conductor 20a operates as a wave director, such a specific effect that the directivity of the radio wave radiated from the waveguide antenna unit 601a is sharpened in the +X direction can be obtained as compared with the configuration without any directivity characteristic controlling conductor 20a. The method of adjusting the directivity characteristic of the antenna element 13a is described as an example. However, the same advantageous effect can be obtained in the case of the other antenna elements 13b to 13d.

In the fourth modified example shown in FIG. 18, the directivity characteristic controlling conductor 20a is made of a linear electrical conductor. However, it may be made of an electrical conductor having a shape other than the linear shape. For example, a helical-type matching conductor made of an electrical conductor wire having a spiral shape or a conductor wire bent in a shape of L-letter may constitute the directivity characteristic controlling conductor 20a. Accordingly, the waveguide array antenna apparatus can be reduced in thickness in shape without failing to have the effect of having the sharpened directivity described above.

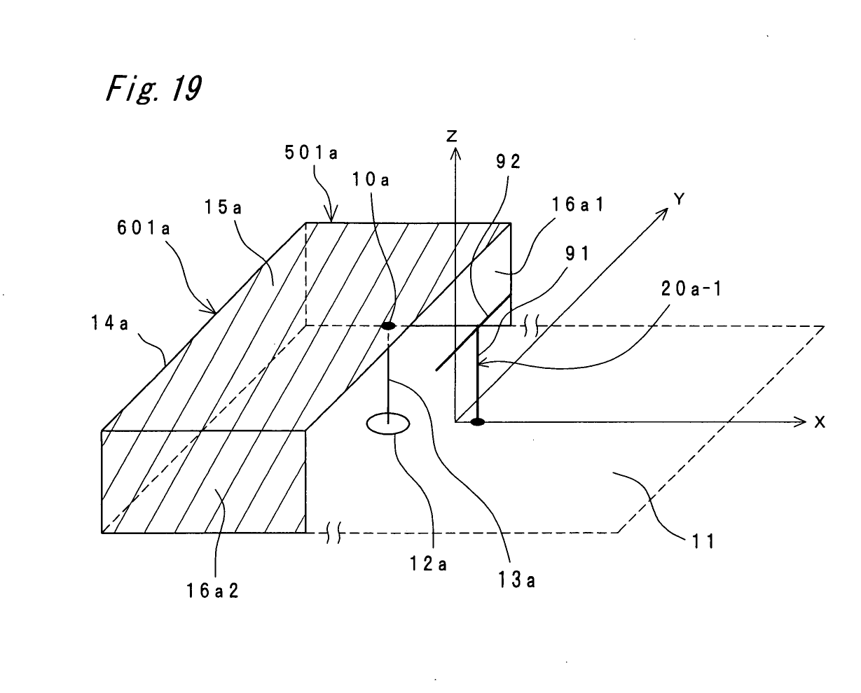

FIG. 19 is a perspective view showing a configuration of a waveguide antenna unit 601a of a waveguide array antenna apparatus according to a fifth modified example of the first embodiment of the present invention.

The configuration shown in FIG. 19 is characterized in that a directivity characteristic controlling conductor 20a-1 is provided at a connecting point at a position on the ground conductor 11 on the X axis shifted from the antenna element 13a in the +X direction in the configuration of the waveguide antenna unit 601a shown in FIG. 2. The directivity characteristic controlling conductor 20a-1 includes a linear conductor 91 in parallel to the Z axis and a linear conductor 92 in parallel to the Y axis. One end of the linear conductor 91 is electrically connected to the ground conductor 11. The linear conductor 91 further extends upward and has a length equal to or slightly shorter than the height of the rectangular waveguide 501a. Another end of the linear conductor 91 is connected to an intermediate part of the linear conductor 92. It is most desirable in the above-mentioned configuration that the linear conductor 91 in parallel to the Z axis be connected at the central part of the linear conductor 92 in parallel to the Y axis, and a sum of the length of the linear conductor 91 in parallel to the Z axis and half the length of the linear conductor 92 in parallel to the Y axis result in approximately the ¼ wavelengths. The lengths of the linear conductors 91 and 92 are thus set, and then, the directivity characteristic controlling conductor 20a-1 may resonate when the radio signal is fed to the waveguide array antenna apparatus, which has a larger advantageous effect in sharpening the directivity as compared with the lengths set to different values. The configuration of the waveguide antenna unit 601a including the directivity characteristic controlling conductor 20a shown in FIG. 18 is designed to mainly improve the directivity characteristic on the Z-X plane of the waveguide array antenna apparatus. When the configuration shown in FIG. 19 is adopted, the directivity characteristic on the X-Y plane of the waveguide array antenna apparatus can be also changed.

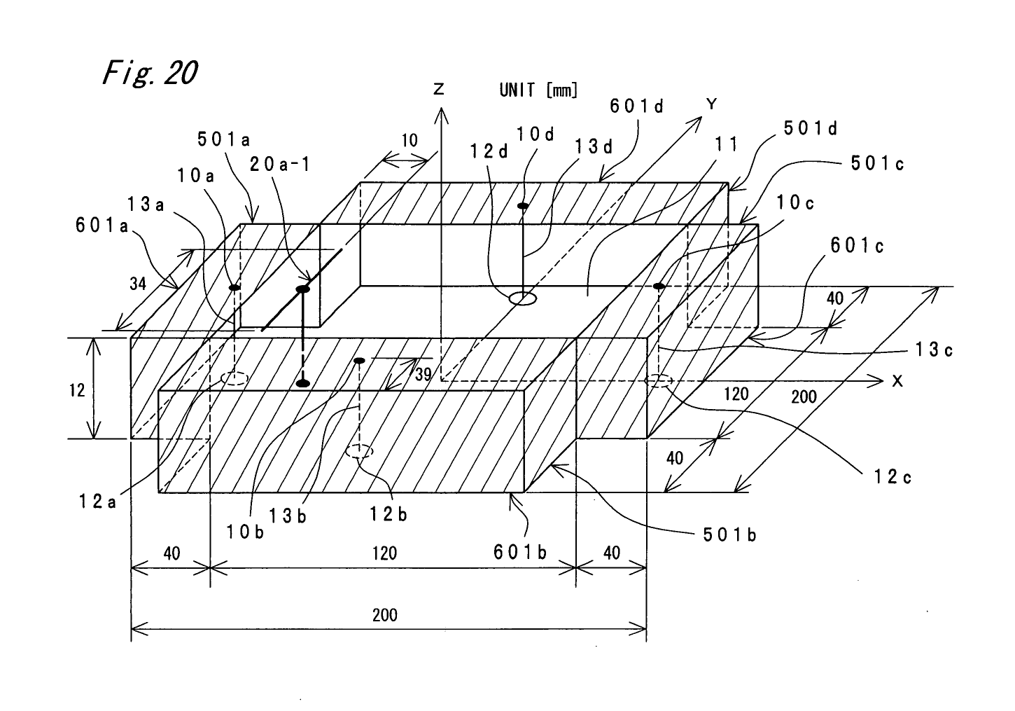

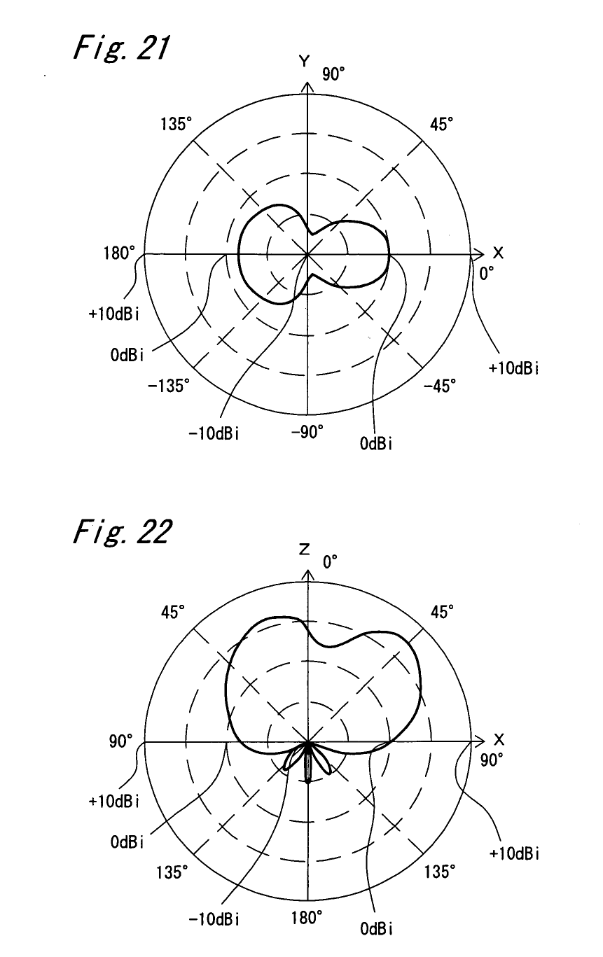

FIG. 20 is a perspective view showing a configuration of a waveguide array antenna apparatus according to an implemental example of the fifth modified example of the first embodiment of the present invention, showing a waveguide array antenna apparatus of prototype actually manufactured by the inventors of the present invention. FIG. 20 shows the case where a directivity characteristic controlling conductor 20a-1 having the operation frequency of 2.5 GHz is provided in the waveguide array antenna apparatus constituted as shown in FIG. 6. FIGS. 21 and 22 are characteristic charts of a radiation directivity characteristic at a frequency of 2.5 GHz of the waveguide array antenna apparatus shown in FIG. 20, where the radiation directivity characteristic on the X-Y plane is shown in FIG. 21, and the radiation directivity characteristic on the Z-X plane is shown in FIG. 22. Referring to the radiation directivity characteristics shown in FIGS. 21 and 22, it is understood that the provision of the directivity characteristic controlling conductor 20a-1 increases the radiation in the Y axis direction on the horizontal plane (on the X-Y plane) as compared with the radiation directivity characteristic of the waveguide array antenna apparatus of FIG. 6 shown in FIGS. 8 and 9. As a result, the directivity characteristic can be also remarkably changed on the horizontal plane. The method of adjusting the directivity characteristic of the antenna element 13a is described as an example. However, the same advantageous effect can be obtained in the case of the other antenna elements 13b to 13d.

The fifth modified example of the first embodiment and the implemental example thereof refer to the case where only one directivity characteristic controlling conductor 20a-1 is provided for the antenna element 13a. However, the present invention is not limited thereto. At least one or two directivity characteristic controlling conductors may be provided for the plurality of antenna elements 13a to 13d. This leads to that the degree of freedom in the structure of the waveguide array antenna apparatus is increased, which allows the radiation directivity characteristic to be more largely changed and controlled. The directivity characteristic controlling conductor 20a-1 may be provided together with the matching conductors 19a, 19a-1 and 19a-2 shown in FIGS. 15 to 17.

In the present embodiment, the antenna apparatus in which the ground conductor 11 is formed in a polygonal shape (that is square) is described as an example. However, the present invention is not limited thereto. For example, in order to obtain the desired radiation directivity characteristic or the desired input impedance characteristic, the ground conductor 11 may have a shape of a rectangle, any other polygon or a shape formed from a combination of semi-circles or any other shape.

In addition, there is such a demand that the shape of the waveguide array antenna apparatus be in harmony with a grid pattern on a ceiling surface or a shape of a room when the waveguide array antenna apparatus is arranged on the ceiling or the like so that the waveguide array antenna apparatus does not attract an attention. However, in the case of the rectangular or any other polygonal waveguide array antenna apparatus, a direction in which the waveguide array antenna apparatus is arranged is limited because the grid pattern on the ceiling surface or the shape of the room is unchangeable. In order to solve the problem, a waveguide array antenna apparatus according to the following modified example is proposed.

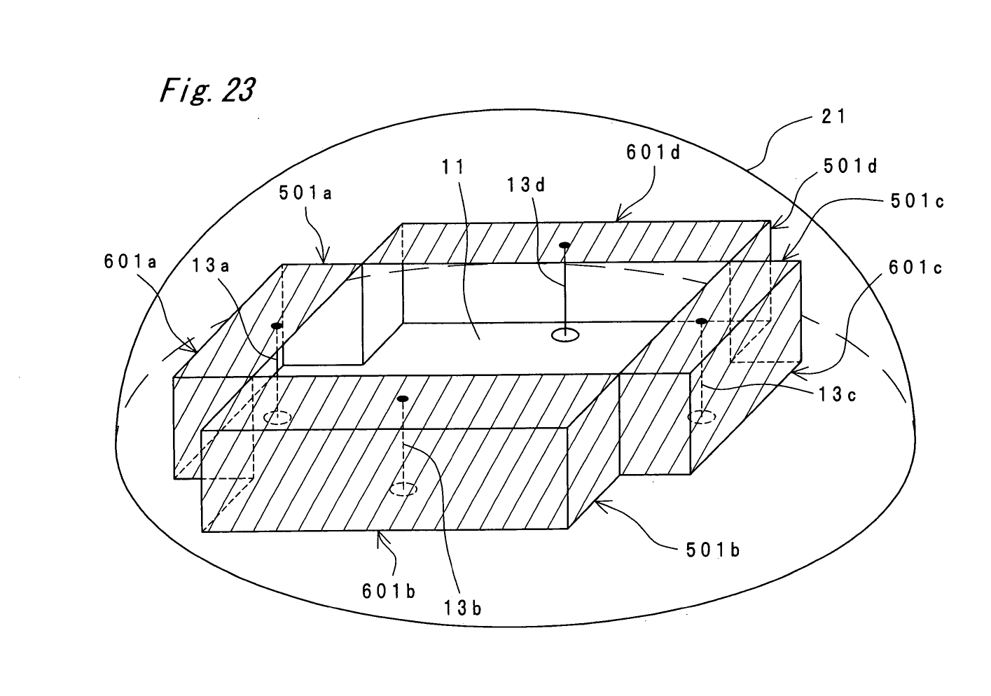

FIG. 23 is a perspective view showing a configuration of a waveguide array antenna apparatus according to a sixth modified example of the first embodiment of the present invention. The waveguide array antenna apparatus according to the sixth modified example shown in FIG. 23 is characterized in that the waveguide array antenna apparatus shown in FIG. 1 is covered with a radome 21. When the radome 21 whose bottom surface in contact with the ground conductor 11 has a substantially circular shape (may have the other shape such as an elliptical shape or the like) is used, invasion of moist, dust and the like, which deteriorates the antenna characteristic, can be prevented so as to stabilize the characteristic of the waveguide array antenna apparatus. Further, the waveguide array antenna apparatus, when being arranged on the ceiling, can be advantageously arranged regardless of the grid pattern on the ceiling surface or the shape of the room. Further, when the bottom surface of the waveguide array antenna apparatus has a circular shape, the waveguide array antenna apparatus can be rotated so that its mounted direction can be changed. According to such a configuration, the direction of the radiated radio wave can be adjusted, and the radiation directivity characteristic can be obtained that is the most suitable for the location where the waveguide array antenna apparatus is arranged.

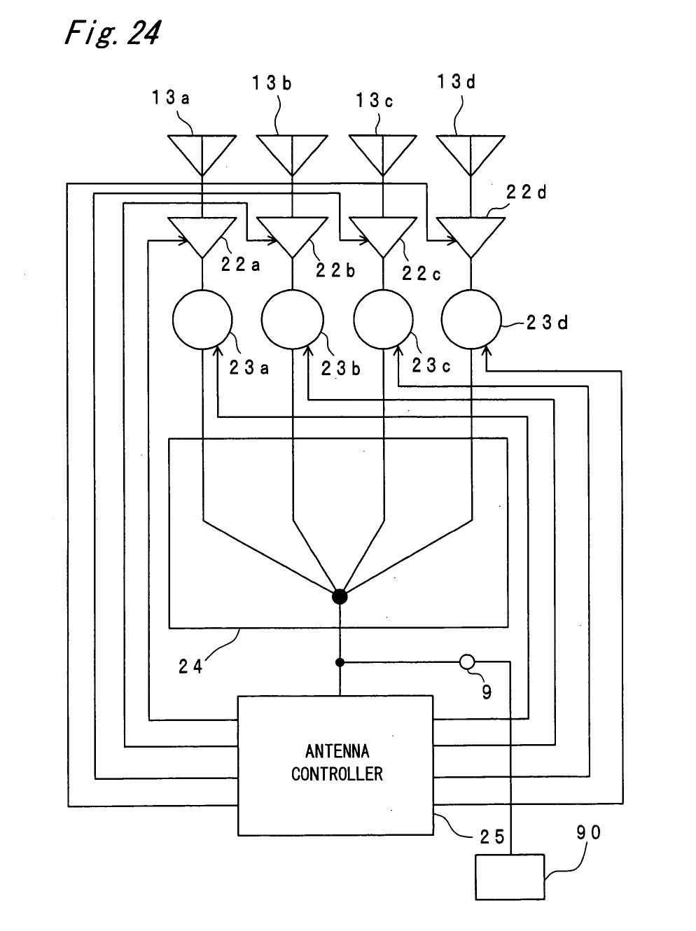

FIG. 24 is a block diagram showing an example of a combining circuit for changing the directivity characteristic of the waveguide array antenna apparatus shown in FIG. 1.

In the above-mentioned embodiment, the connection of the feeding cable to the antenna element having the larger received power via the switch 17 shown in FIG. 5 is described as an example. However, the present invention is not limited thereto. For example, as shown in FIG. 24, the combining circuit according to the present embodiment may be adapted to connect amplitude adjuster circuits 22a to 22d to the antenna elements 13a to 13d, connect phase shifters 23a to 23d to the amplitude adjuster circuits 22a to 22d, and connect the phase shifters 23a to 23d to a combiner 24. The amplitude adjuster circuits 22a to 22d respectively adjust amplitudes (or signal levels) of the radio signals received via the antenna elements 13a to 13d, the phase shifters 23a to 23d adjust phases (or phase amounts or phase shifting amounts) of the radio signals whose amplitudes are adjusted by the amplitude adjuster circuits 22a to 22d and outputted, and the combiner 24 combines the powers of the radio signals whose amplitudes and phases are adjusted by the phase shifters 23a to 23d and the amplitude adjuster circuits 22a to 22d to output a combined resulting signal to the radio communication apparatus circuit 90 via the feeding terminal 9 and the feeding cable.

Still further, an antenna controller 25 may be provided. In that case, the antenna controller 25 calculates such an amplitude adjusting amount in the respective amplitude adjuster circuits 22a to 22d and a phase adjust amount (phase amount or phase shifting amount) in the respective phase shifters 23a to 23d as maximizing the power (signal level) of the output signal from the combiner 24, and controls the amplitude adjuster circuits 22a to 22d and the phase shifters 23a to 23d based on the calculated amplitude and phase-adjusting amount. This leads to further increase in the received power.

In the above-mentioned embodiment and modified examples thereof, one waveguide array antenna apparatus is described. However, the present invention is not limited thereto. A plurality of waveguide array antenna apparatuses may be arranged in an array shape so as to constitute a phased array antenna and an adaptive antenna array. This leads to that the directivity characteristic of the radiated radio wave can be further controlled.

### Second Embodiment

FIG. 21 is a perspective view showing a configuration of a waveguide array antenna apparatus with slots according to a second embodiment of the present invention. The waveguide array antenna apparatus with the slots shown in FIG. 21 is different from the waveguide array antenna apparatus shown in FIG. 1 in that the ceiling conductors 15a to 15d constituting four rectangular waveguides 502a, 502b, 502c and 502d included in the waveguide array antenna apparatus with the slots respectively having slots 30a to 30d each having a longitudinal direction vertical to the direction, in which the radio signal is transmitted by the respective rectangular waveguides 502a to 502d (in other words, the same directions as the width directions of the respective rectangular waveguides 502a to 502d) and a width sufficiently smaller than the ¼ wavelengths of the guide wavelength. The slots 30a to 30d are provided between the connecting units 10a to 10d of the antenna elements 13a to 13d and the terminating conductors 14a to 14d of the respective ceiling conductors 15a to 15d. A rectangular waveguide 502a including the antenna element 13a constitutes a waveguide antenna unit 602a, a rectangular waveguide 502bhaving the antenna element 13b constitutes a waveguide antenna unit 602b, a rectangular waveguide 502c having the antenna element 13c constitutes a waveguide antenna unit 602c, and a rectangular waveguide 502d having the antenna element 13d constitutes a waveguide antenna unit 602d.

In the example of the configuration according to the present embodiment, the ground conductor 11 is arranged on the X-Y plane, the ground conductor 11, the terminating conductors 14a to 14d, the side conductors 16a1 and 16a2 to 16d1 and 16d2 and the ceiling conductors 15a to 15d are electrically connected, the feeding points 12a to 12d are arranged on the X axis or Y axis, the antenna elements 13a to 13d are each made of an electrical conductor wire or line vertical to the X-Y plane, and each of the slots 30a to 30d is provided on the respective ceiling conductors 15a to 15d.

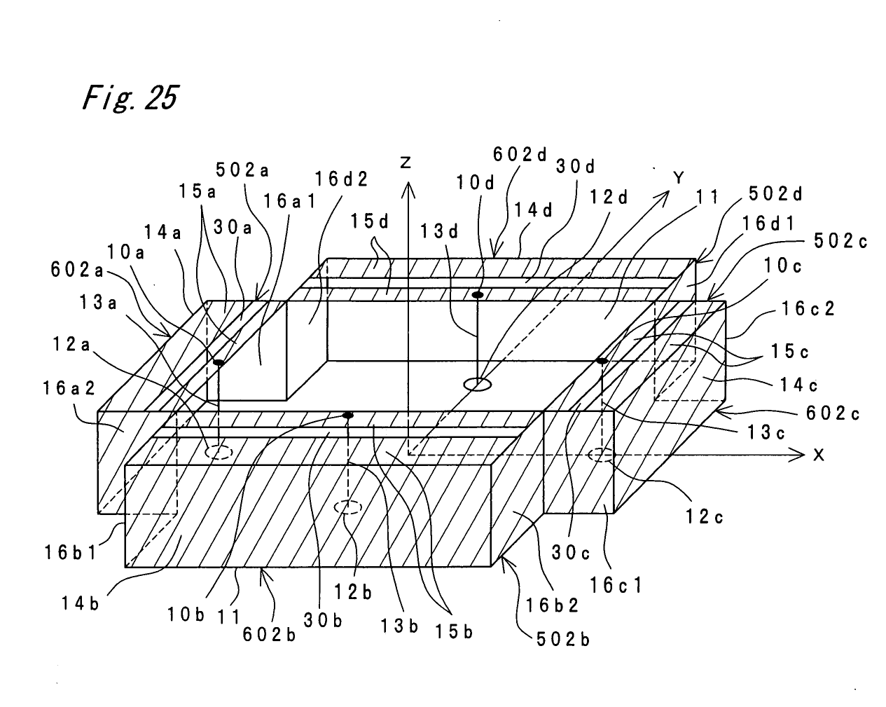

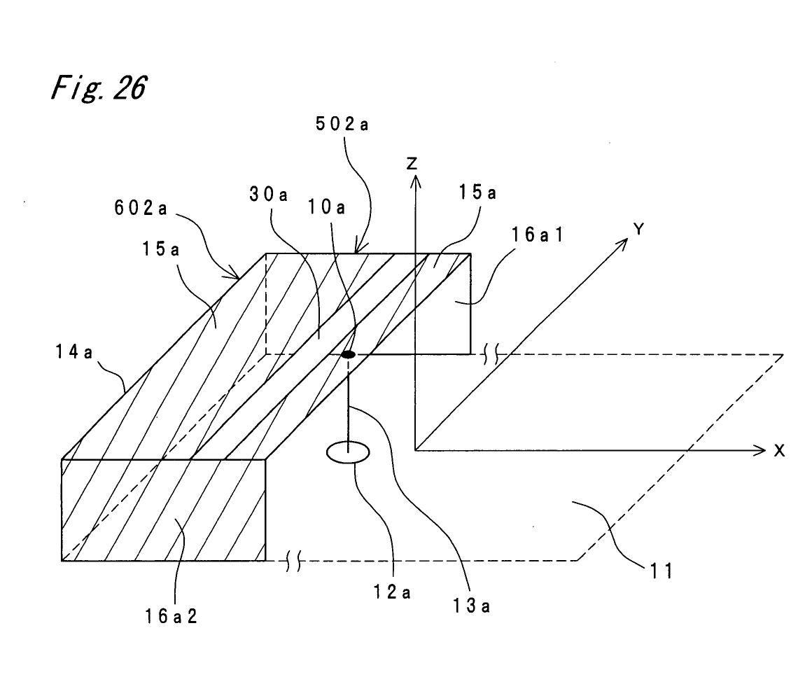

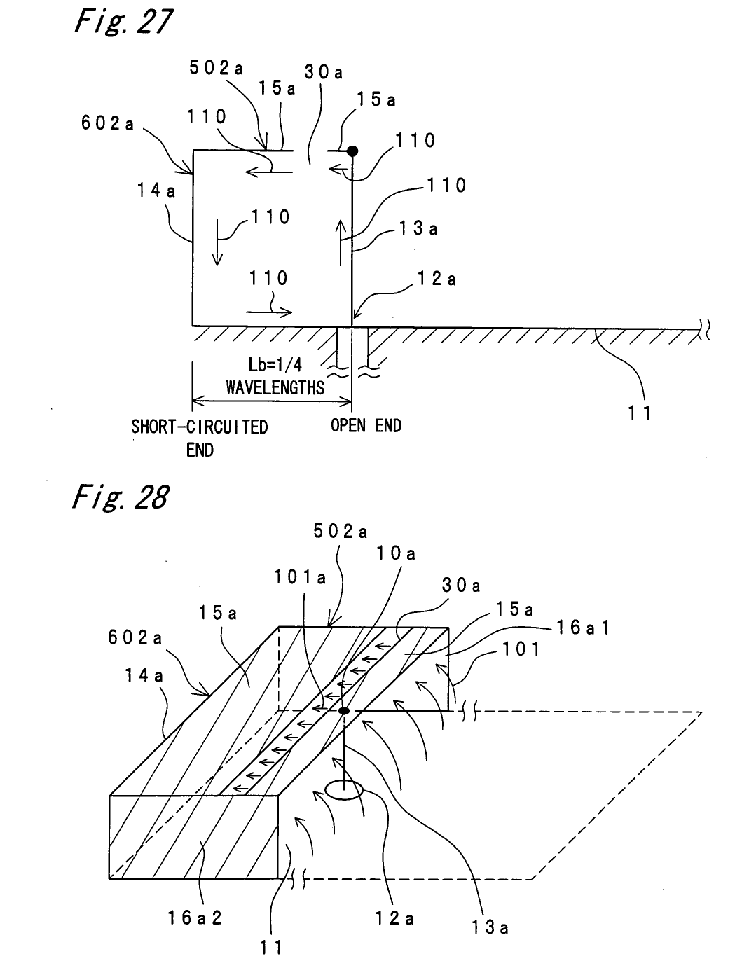

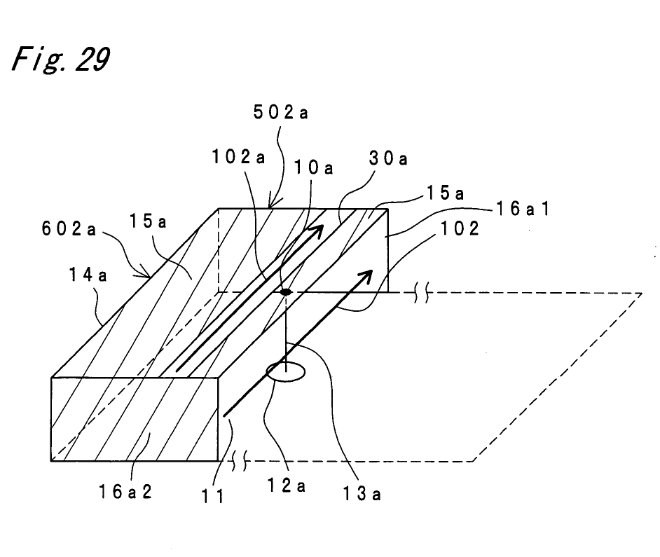

Next, an operation principle when radio signal is fed to only the antenna element 13a of the waveguide array antenna apparatus with the slots will be described with reference to FIGS. 26 to 29. FIG. 26 is a perspective view showing a detailed configuration of the waveguide antenna unit 602a with the slot including the antenna element 13a, which is one part of the waveguide array antenna apparatus with the slots shown in FIG. 25. FIG. 27 is a sectional view of the waveguide antenna unit 602a with the slot shown in FIG. 26 cutting along the X-Z surface. FIG. 28 is a perspective view showing an electric field distribution of the waveguide antenna unit 602a with the slot shown in FIG. 26. FIG. 29 is a perspective view showing a magnetic current distribution of the waveguide antenna unit 602a with the slot shown in FIG. 26.

In the present embodiment, the radiation of the radio wave results from the excitation of the antenna element 13a. The radio wave is radiated by the electric field generated between the ceiling conductor 15a and the ground conductor 11 and the electric field generated by the slot 30a through the excitation of the antenna element 13a. Therefore, as shown in FIG. 28, an electric field 101 generated between the ceiling conductor 15a and the ground conductor 11 by the antenna element 13a is the same as that in the case of the waveguide array antenna apparatus according to the first embodiment shown in FIG. 3. The amplitude of the electric field 101a generated by the slot 30a shows a distribution according substantially a sine function, showing zero at both ends in the longitudinal direction and showing the maximum value at the center in the longitudinal direction. More concretely, the slot 30a of the waveguide antenna unit 602a with the slot shows the dipole directivity of the linear magnetic current in parallel to the Y direction. The dipole allows a bi-directivity of the vertical polarization to be obtained on the X-Y plane and Y-Z plane, and an omni-directivity on the Z-X plane. FIG. 27 shows a distribution of the current flowing in the waveguide antenna unit 602a with the slot according to the present embodiment. A current 110 flows from the feeding point 12a along the antenna element 13a, then to the terminating conductor 14a via the slot 30a and the ceiling conductor 15a, and flows from the terminating conductor 14a further to the ground conductor 11, and then returns to the feeding point 12a. Therefore, the distribution of the electric field generated by the waveguide antenna unit 602a with the slot is as shown in FIG. 28. As a result, the direction of the electric field 101 generated between the ceiling conductor 15a and the ground conductor 11 becomes parallel to the direction of the electric field 101a generated by the slot 30a. In other words, the slot 30a has an advantageous effect of making coherent the phase of the radiated radio wave.

Replacing the electric fields 101 and 101a with the magnetic current for description, as shown in FIG. 29, the electric fields can be replaced with linear magnetic current sources 102 and 102a in parallel to the Y axis, and this can be understood that the radio wave is radiated by the magnetic current sources 102 and 102a. Therefore, the directivity characteristic of the waveguide array antenna apparatus with the slots is obtained in a form of array of in-phase excitation by two magnetic currents 102 and 102a. The directivity characteristic according to the electric field 101 generated between the ceiling conductor 15a and the ground conductor 11 shows the directivity intensified in the +Z direction and +X direction of the XYZ coordinate system in a manner similar to that of the waveguide array antenna apparatus according to the first embodiment. The directivity characteristic according to the electric field 101a generated by the slot 30a also shows the directivity strengthened in the +Z direction and +X direction of the XYZ coordinate system. Therefore, in the waveguide array antenna apparatus with the slots according to the present embodiment, the directivity strengthened in the +Z direction and +X direction of the XYZ coordinate system can obtained because of the in-phase array having the above-mentioned two directivity characteristics.

Therefore, when the radio signal is fed to the antenna element 13b of FIG. 25, the radio wave strengthened in the +Y direction is radiated, while the radio wave strengthened in the −X direction is radiated when the radio signal is fed to the antenna element 13c. Further, when the radio signal is fed to the antenna element 13d, the radio wave thereof strengthened in the −Y direction is radiated.

In addition, the above-mentioned embodiment described the case in which the radio wave is radiated from the waveguide array antenna apparatus with the slots, and the same configuration is applied to the reception of the radio wave. In the case of receiving the radio wave, the feeding cable (not shown) is connected to the antenna element having the directivity intensified in the direction of the arrived radio wave so that a larger received power can be obtained. When the radio wave arrives from the +X direction, for example, the antenna element 13a is connected to the feeding cable via the switch 17 shown in FIG. 5. In the waveguide array antenna apparatus according to the present embodiment, the magnitude of the power of the radio wave received via the antenna elements 13a to 13d is judged by the received power judging unit 18 shown in FIG. 5, and the switch 17 is controlled so that the antenna element having the largest power of the received radio wave is operated in a manner similar to that of the waveguide array antenna apparatus according to the first embodiment. As a result, the directivity changeover antenna apparatus can be realized capable of selectively changing the main beam direction in the direction of the arrived radio wave. This leads to coverage in a range of 360 degrees on the horizontal plane also at the time of the reception.

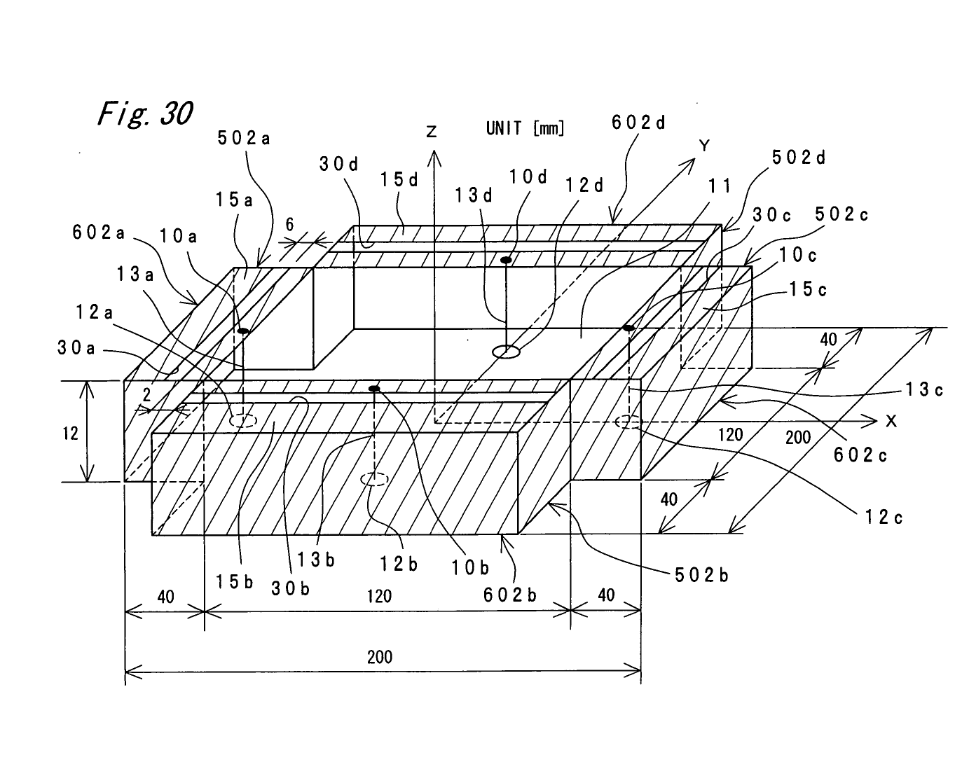

FIG. 30 is a perspective view showing a configuration of a waveguide array antenna apparatus with slots according to an implemental example of the second embodiment of the present invention, and in FIG. 30, a prototype waveguide array antenna apparatus with slots actually manufactured by the inventors of the present invention is shown. An example of the characteristic is described below. As shown in FIG. 30, the length of each of the terminating conductors 14a to 14d and the ceiling conductors 15a to 15d in the longitudinal direction in parallel to the X-Y plane is 120 mm, the height of each of the terminating conductors 14a to 14d and the side conductors 16a1 and 16a2 to 16d1 and 16d2 in the Z axis direction is 12 mm, and the length of each of the side conductors 16a1 and 16a2 to 16d1 and 16d2 in the direction in parallel to the X-Y plane, and the width of the ceiling conductors 15a to 15d is 40 mm. The length in the longitudinal direction and the width of the slots 30a to 30d are respectively 120 mm and 6 mm, and the center of the slots 30a to 30d in the width direction is arranged distant by 5 mm from the open ends of the rectangular waveguides 502a to 502d (hence, the width from the ends of the ceiling conductors 15a to 15d on the open-end sides of the rectangular waveguides 502a to 502d to the ends of the slots 30a to 30d is 2 mm). The respective feeding points 12a to 12d are arranged on the X axis or Y axis. Therefore, the configuration of the waveguide array antenna apparatus with the slots shown in FIG. 30 is not any different to the configuration of the waveguide array antenna apparatus shown in FIG. 6 except for the provision of the slots 30a to 30d.

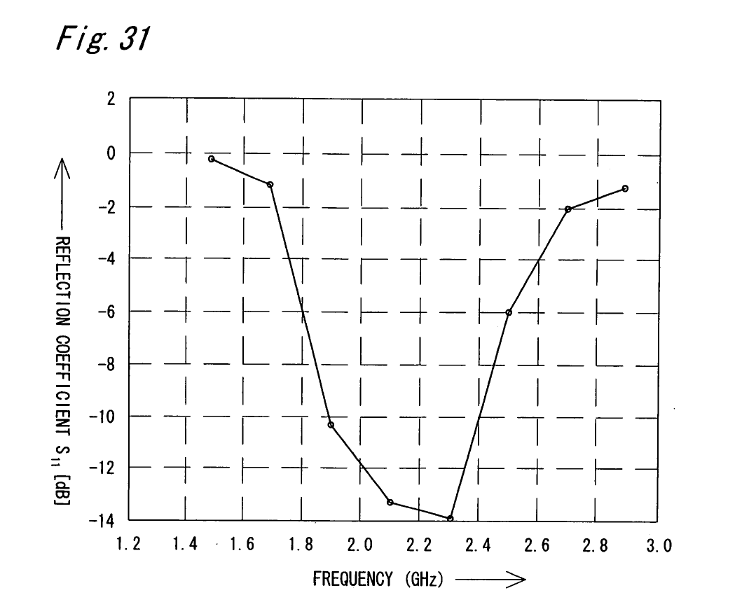

FIG. 31 is a characteristic chart showing a frequency characteristic of a reflection coefficient S₁₁ of the waveguide array antenna apparatus with the slots shown in FIG. 30. It is known from FIG. 31 that the waveguide array antenna apparatus with the slots according to the implemental example resonates at a frequency of 2.5 GHz showing a favorable reflection characteristic. Because the waveguide array antenna apparatus with the slots according to the present embodiment shows the symmetrical shape, the same frequency characteristic can be obtained when the radio signal fed to the antenna elements 13b to 13d.

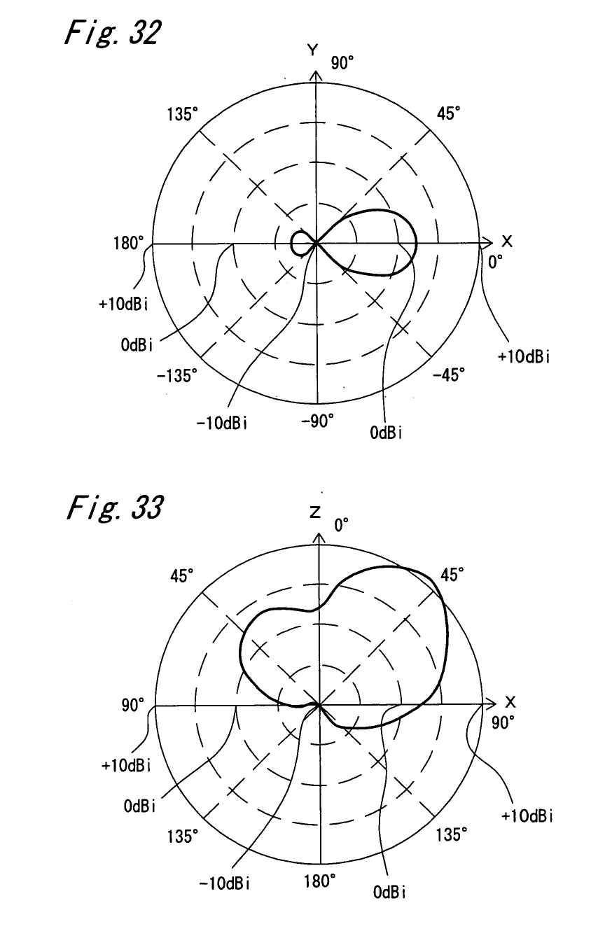

FIGS. 32 and 33 are characteristic charts of a radiation directivity characteristic when the radio signal having the frequency of 2.5 GHz is fed to the antenna element 13a of the waveguide array antenna apparatus with the slots shown in FIG. 26, where the radiation directivity characteristic on the X-Y plane (on the horizontal plane) is shown in FIG. 32, and the radiation directivity characteristic on the Z-X plane (on the vertical plane) is shown in FIG. 33. In the characteristic charts, scales in the radial direction representing a gain of the waveguide array antenna apparatus with the slots are spaced at intervals of 10 dB, and the unit is dBi of a relative gain based on a radiation power of an ideal point wave source. As is apparent from FIG. 33, the radiation of the radio wave shows the directivity intensified in the +Z direction and +X direction of the XYZ coordinate system, and the waveguide array antenna apparatus with the slots has a simplified structure and realizes the directivity intensified in one direction. In the direction of the maximum radiation (that is the beam direction), the relatively large gain of 10.6 dBi was obtained in the direction rotated through only 40 degrees from the Z axis toward the +X direction on the vertical plane, and the gain of 2.6 dBi was obtained in the positive direction on the X axis on the horizontal plane.

Even in the waveguide array antenna apparatus with the slots according to the present embodiment, the directivity changeover antenna apparatus can be realized capable of selectively changing the direction of the radiated radio wave so that the switch connected to the respective antenna elements 13a to 13d and serving to selectively switch over to the antenna element with a fed radio signal is used to select and operate the antenna element having the directivity intensified in the desired direction, in a manner similar to that of the waveguide array antenna apparatus according to the first embodiment. This leads to coverage in a range of 360 degrees on the horizontal plane.

According to the waveguide array antenna apparatus with the slots according to the present embodiment constituted as described above, the antenna apparatus can be realized capable of radiating the radio wave with concentration of the power of the radio wave in the direction of the desirably transmitted radio signal. Further, according to the waveguide array antenna apparatus with the slots, the antenna apparatus in which the height in the Z axis direction when the operation frequency is 2.5 GHz is 0.1 wavelengths can be realized, which is very thin in thickness in shape.

The above-mentioned embodiment and the implemental example showed that the waveguide array antenna apparatus with the slots is symmetrical relative to the Z-X plane and Z-Y plane. The symmetrical structure has such an advantageous effect that the directivity characteristic of the radio wave radiated from the waveguide array antenna apparatus with the slots is symmetrical relative to the Z-X plane and Z-Y plane.

The waveguide array antenna apparatus with the slots according to the present embodiment is effective in that the impedance characteristic in a broad band can be obtained as compared with the waveguide array antenna apparatus according to the first embodiment. Such an advantageous effect can be obtained because of the presence of the resonance frequency which may be caused by the slots 30a to 30d of the waveguide array antenna apparatus with the slots according to the present embodiment in addition to the resonance frequency specific in the structure of the waveguide array antenna apparatus according to the first embodiment. When a slight difference is given between two resonance frequencies, a broad-band characteristic can be obtained.

In addition, the waveguide array antenna apparatus with the slots according to the present embodiment has such a high-gain characteristic that the gain of 1.1 dB in the direction of the maximum radiation and the gain of 1.6 dB in the direction of the maximum radiation even on the horizontal plane were obtained as compared with the waveguide array antenna apparatus according to the first embodiment even though the respective waveguide array antenna apparatuses have the same size. Such a high-gain characteristic is obtained because the radiation from the open ends of the rectangular waveguides 502a to 502d and the radiation from the slots 30a to 30d are overlapped with each other.

As described above, according to waveguide array antenna apparatus with the slots of the present embodiment, the antenna apparatus can be realized having a reduced size and a reduced thickness in shape, having a simplified structure, having a directivity intensified as compared with the prior art and being capable of selectively changing the main beam direction.

In the above-mentioned embodiment, the waveguide array antenna apparatus with the slots is described as the antenna apparatus symmetrical relative to the Z-X plane and Z-Y plane and having the same sectional shape on the Z-X plane and the sectional shape on the Z-Y plane. However, the present invention is not limited thereto. For example, the antenna apparatus may be extended in the Y direction in the case of the radiation space being extended in the ±X direction. According to such an apparatus structure, the directivity is intensified in the ±X direction, and the antenna suitable for the radiation space extended in the ±X direction can be provided. When the lengths of the antenna apparatus are thus changed in the X and Y directions, the antenna apparatus can be realized having the radiation directivity characteristic that is the most suitable for the radiation space.

In the present embodiment, the waveguide array antenna apparatus with the slots is described as the antenna apparatus symmetrical relative to the Z-X plane and Z-Y plane. However, the present invention is not limited thereto. For example, the antenna apparatus may be formed in the structure symmetrical relative to only the Z-X plane or symmetrical relative to only the Z-Y plane in order to obtain the desired radiation directivity characteristic or input impedance characteristic. According to the device structure, the antenna apparatus can be realized having a radiation directivity characteristic that is the most suitable for the radiation space.

In addition, in the present embodiment, the antenna apparatus in which the antenna elements 13a to 13d are each made of an electrical conductor line or wire is described. However, the present invention is not limited thereto. For example, the antenna elements 13a to 13d may be made of an electrical conductor having the plate shape. Such formation of the antenna elements 13a to 13d leads to such an advantageous effect that the desired input impedance characteristic can be obtained so that the high-efficiency antenna apparatus can be realized with a reduced reflection loss.

Further, as a method of obtaining the desired input impedance characteristic, the matching conductor may be provided in a manner similar to that of the waveguide array antenna apparatus according to the first embodiment. For example, the matching conductor 19a as shown in FIG. 15 may be additionally provided in the configuration of the waveguide array antenna apparatus with the slots shown in FIG. 25. FIG. 15 shows the example in which the matching conductor 19a is made of a linear electrical conductor, and is connected to the ground conductor 11. Accordingly, the electric field in the vicinity of the antenna element 13a is changed and the current flowing in the antenna element 13a is changed so that the impedance of the antenna element 13a can be changed. As a result, the desired input impedance characteristic can be obtained, and the high-efficiency antenna apparatus whose reflection loss is reduced can be effectively realized. In order to obtain the desired impedance characteristics, the matching conductor 19a may be connected to the ground conductor 11 and the ceiling conductor 15a as shown in FIG. 16, or the matching conductor 19a may be connected to the ground conductor 11 and the antenna element 13a as shown in FIG. 17 in addition to the structure of the waveguide array antenna apparatus with the slots shown in FIG. 25. Accordingly, the impedance characteristic of the waveguide array antenna apparatus with the slots can effectively largely changed because the current flowing in the antenna element 13a can be directly changed. The method of adjusting the impedance of the antenna element 13a is described as an example. However, the method can be also applied to the other antenna elements 13b to 13d achieving the same advantageous effect.

As a method of changing the radiation characteristic of the waveguide array antenna apparatus with the slots according to the present embodiment, the directivity characteristic controlling conductor 20a as shown in FIG. 18 may be provided in a manner similar to that of the waveguide array antenna apparatus according to the first embodiment.

FIG. 18 shows the example in which the directivity characteristic controlling conductor 20a is connected to the ground conductor 11 at the positive position on the X axis. The radiated radio wave effectively shows the directivity sharpened in the +X direction as compared with the directivity when the directivity characteristic controlling conductor 201 is not provided because the directivity characteristic controlling conductor 20a operates as a wave director. Referring to FIG. 18, the directivity characteristic controlling conductor 201 is made of a linear electrical conductor. However, it may be made of an electrical conductor having a different shape. For example, the helical-type matching conductor made of a spiral electrical conductor wire or the electrical conductor wire bent in a shape of L-letter may constitute the directivity characteristic controlling conductor 20a. As a result, the antenna apparatus may be formed in a thinner shape without failing to have the advantageous effect which may be obtained by provision of the directivity characteristic controlling conductor 20a. The directivity characteristic controlling conductor 20a for adjusting the directivity characteristic of the antenna element 13a is described as an example. However, the same advantageous effect can be obtained when the directivity characteristic controlling conductor is provided for the other antenna elements 13b to 13d.

Further, in the waveguide array antenna apparatus with the slots, the directivity characteristic controlling conductor 20a-1 made of a linear electrical conductor 91 in parallel to the Z axis and the linear conductor 92 in parallel to the Y axis may be provided as shown in FIG. 19. Most desirably, the linear conductor 91 in parallel to the Z axis is connected at the center of the linear conductor 92 in parallel to the Y axis, and the sum of the length of the linear conductor 91 in parallel to the Z axis and half the length of the linear conductor 92 in parallel to the Y axis is approximately ¼ wavelengths. When the lengths are thus set, a larger effect can be obtained upon controlling the directivity characteristic because of the resonance generated by the directivity characteristic controlling conductor 20a-1 in a manner similar to that of the waveguide array antenna apparatus according to the first embodiment. The directivity characteristic controlling conductor 20a as shown in FIG. 18 is provided mainly because the directivity characteristic of the antenna apparatus on the vertical plane (on the Z-X plane) is to be improved. When the directivity characteristic controlling conductor 20a-1 as shown in FIG. 19 is provided, the directivity characteristic of the antenna apparatus on the X-Y plane can be also changed. The directivity characteristic controlling conductor 20a-1 for adjusting the directivity characteristic of the antenna element 13a is described as an example. However, the same advantageous effect can be obtained in the case of providing the directivity characteristic controlling conductor for the other antenna elements 13b to 13d.

The above-mentioned embodiment described the operation in the case of providing only one directivity characteristic controlling conductor for the respective antenna elements 13a to 13d. However, the present invention is not limited thereto. At least two directivity characteristic controlling conductors may be provided. This leads to that the degree of freedom in the structure of the waveguide array antenna apparatus with the slots is increased, and the radiation directivity characteristic can be more largely changed and controlled. The directivity characteristic controlling conductor 20a or 20a-1 may be provided together with the matching conductors 19a, 19a-1 and 19a-2 shown in FIGS. 15 to 17.

In the above-mentioned embodiment, the waveguide array antenna apparatus with the slots in which the ground conductor 11 has the polygonal shape (that is square) is described as an example. However, the present invention is not limited thereto. For example, in order to obtain the desired radiation directivity characteristic or desired input impedance characteristic, the ground conductor 11 may be formed in a shape of rectangular, any other polygonal shape, or a shape formed from a combination of the semi circles or any other shape. There is such a demand that the shape of the waveguide array antenna apparatus be in harmony with the grid pattern on the ceiling surface or the shape of the room when the waveguide array antenna apparatus with the slots is arranged on the ceiling or the like so that the waveguide array antenna apparatus can be inconspicuous. However, in the case of the rectangular or any other polygonal waveguide array antenna apparatus with the slots, the direction in which the waveguide array antenna apparatus with the slots is arranged is limited because the grid pattern on the ceiling surface or the shape of the room is unchangeable. In order to solve the problem, the radome 21 whose bottom surface in contact with the ground conductor 11 has the substantially circular shape (may have other shape such as an elliptical shape) is used in a manner similar to that of the sixth modified example of the first embodiment shown in FIG. 23 so that the invasion of moist, dust and the like, which deteriorates the antenna characteristic, can be prevented so as to stabilize the characteristic of the waveguide array antenna apparatus. As another advantage of the above-mentioned arrangement, the waveguide array antenna apparatus with the slots, when arranged on the ceiling, can be advantageously arranged regardless of the grid pattern on the ceiling surface or the shape of the room. Further, when the shape of the bottom surface of the waveguide array antenna apparatus with the slots is circular, the waveguide array antenna apparatus with the slots can be rotated so that its mounted direction can be changed. According to such a configuration, the direction of the radiated radio wave can be adjusted, and the radiation directivity characteristic that is the most suitable for the position, at which the waveguide array antenna apparatus is arranged, can be obtained.

In addition, in the present embodiment, the switch as shown in FIG. 5 is used for the selective changeover so that the feeding cable (not shown) is connected to the antenna element whose received power is larger than that of the radio signal arriving from a predetermined azimuth as an example of the configuration. However, the present invention is not limited thereto. For example, the combining circuit as shown in FIG. 24 may be provided so that four radio signals received via the antenna elements 13a to 13d can be controlled to be combined.

Further, a plurality of waveguide array antenna apparatuses with the slots may be arranged in a shape of array so as to constitute the phased array antenna and the adaptive antenna array. Accordingly, the directivity characteristic of the radiated radio wave can be further controlled.

Still further, in the present embodiment, each of the slots 30a to 30d is provided for each of the ceiling conductors 15a to 15d as an example of the configuration. However, the present invention is not limited thereto. At least two slots may be provided for one of the ceiling conductors 15a to 15d. As a result, the phases of the radio wave transmitted and received by the respective slots can be made coherent so as to realize the even more intensified directivity. As another possible configuration, different numbers of slots may be provided in the respective ceiling conductors 15a to 15d.

### Third Embodiment

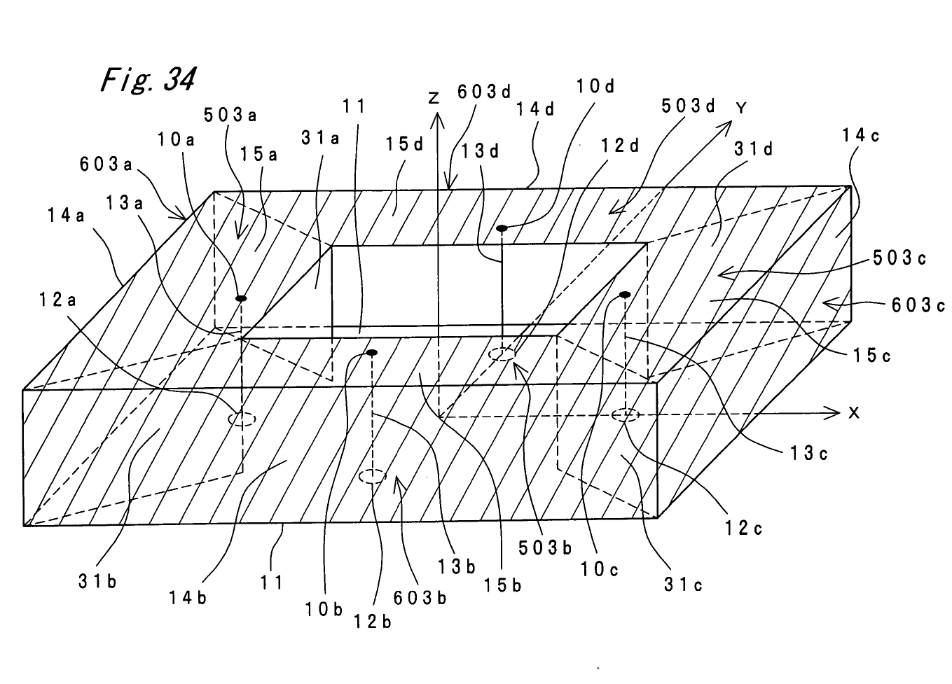

FIG. 34 is a perspective view showing a configuration of a waveguide array antenna apparatus integrally incorporated in a housing according to a third embodiment of the present invention. The waveguide array antenna apparatus of type integrally incorporated in the housing is characterized in that the side conductors 16d2 and 16a1, 16a2 and 16b1, 16b2 and 16c1, and 16c2 and 16d1 of FIG. 1 are respectively integrated into single partitioning-wall conductors 31a to 31d of the present embodiment as compared with the waveguide array antenna apparatus shown in FIG. 1, which simplifies the structure of the housing of the antenna apparatus including four rectangular waveguides 503a, 503b, 503c and 503d.

Referring to FIG. 34, the waveguide array antenna apparatus of type integrally incorporated in the housing includes a plurality of waveguide antenna units 603a, 603b, 603c and 603d provided on the ground conductor 11 provided on the ground conductor 11 having the square shape and arranged on the X-Y plane, and each of waveguide antenna units 603a, 603b, 603c and 603d includes the rectangular waveguides 503a, 503b, 503c and 503d and the antenna elements 13a to 13d. The rectangular waveguides 503a to 503d includes the ground conductor 11, the ceiling conductors 15a to 15d facing the ground conductor 11 and the partitioning-wall conductors 31a to 31d that connect the ground conductor 11 with the ceiling conductors 15a to 15d, and the rectangular waveguides 503a to 503d are arranged adjacent to each other so that the partitioning-wall conductors 31a to 31d are shared between the respective two rectangular waveguides adjacent to each other (503a and 503b), (503b and 503c), (503c and 503d) and (503d and 503a) (for example, the partitioning-wall conductor 31a is shared between the rectangular waveguide 503a including the ceiling conductor 15a and the rectangular waveguide 503d including the ceiling conductor 15d).

The respective rectangular waveguides 503a to 503d have one ends short-circuited by the terminating conductors 14a to 14d and open ends. The ends short-circuited by the terminating conductors 14a to 14d are provided to be arranged on the sides of the square ground conductor 11, while the open ends are provided to be arranged on sides of a smaller square (not shown) on diagonal lines of the square ground conductor 11. The respective rectangular waveguides 503a to 503d extend outward from the sides of the smaller square on the ground conductor 11. One ends of the antenna elements 13a to 13d are electrically connected to the ceiling conductors 15a to 15d in the vicinity of the open ends of the rectangular waveguides 503a to 503d, while another ends thereof are electrically connected to the feeding points 12a to 12d arranged on the ground conductor 11. The respective waveguide antenna units 603a to 603d transmit and receive a radio signal in a predetermined radiation directivity characteristic at the open ends of the respective rectangular waveguides 503a to 503d constituting the waveguide antenna units 603a to 603d. Because the respective rectangular waveguides 503a to 503d are provided on the ground conductor 11 in directions different from each other, the main beams of the radiation directivity characteristics of four waveguide antenna units 603a to 603d respectively have directions different from each other. Therefore, when the antenna element for transmitting and receiving the radio signal is selectively changed, the directivity characteristic of the waveguide array antenna apparatus of type integrally incorporated in the housing can be changed.

Referring to FIG. 34, the rectangular terminating conductors 14a to 14d having the sides of the same length as that of the ground conductor 11 and the sides of a predetermined length (height) in the vertical direction are provided on four sides of the square ground conductor 11 vertically relative to the X-Y plane, and the rectangular partitioning-wall conductors 31a to 31d having the sides of the same length as the height of the terminating conductors 14a to 14d and the sides of a predetermined length are provided on the diagonal lines of the ground conductor 11 vertically relative to the X-Y plane with their peaks corresponding to the peaks of the ground conductor 11. Further, the ceiling conductors 15a to 15d having a trapezoidal shape are provided on the terminating conductors 14a to 14d and the partitioning-wall conductors 31a to 31d facing the ground conductor 11. Therefore, the top end of the partitioning-wall conductor 31a is connected to the slant sides of the ceiling conductors 15a to 15d having the trapezoidal shape, the bottom end thereof is connected to the ground conductor 11, and the right and left ends thereof are connected to the terminating conductors 14a to 14d.

In this case, the ceiling conductor 15a is provided on the terminating conductor 14a and the partitioning-wall conductors 31a and 31b. More concretely, the bottom surface of the ground conductor 11, the ceiling conductor 15a having the trapezoidal shape and arranged on the top surface of the waveguide array antenna apparatus facing the ground conductor 11 and the partitioning-wall conductors 31a and 31b that connect the ground conductor 11 with the ceiling conductor 15a on two slant slides of the trapezoid of the ceiling conductor 15a form the rectangular waveguide 503a having such a tapered shape that its rectangular sectional surface is reduced toward one end. One end of the rectangular waveguide 503a on the wider-section side is sealed by the rectangular terminating conductor 14a so as to be short-circuited, while another end thereof on the narrower-section side is left open (hereinafter, referred to as an open end). The ground conductor 11, the partitioning-wall conductors 31a and 31b, the ceiling conductor 15a and the terminating conductor 14a are mechanically and electrically connected to each other, and then, those constitute the rectangular waveguide 503a that transmits the radio signal in the direction in parallel to the X axis direction and has its end in the −X direction closed.

Next, the end of the antenna elements 13a made of an electrical conductor wire is mechanically and electrically connected by means of soldering to the connecting point 10a on the bottom surface of the ceiling conductor 15a near the end in the +X direction and at the center in the Y direction. The antenna element 13a vertically extends downward from the connecting point 10a, and the another end of the antenna element 13a is connected to the feeding point 12a electrically insulated from the ground conductor 11, in a circular hole formed on the X axis on the ground conductor 11. The feeding point 12a is further electrically connected to, for example, the central conductor of the coaxial cable, and the ground conductor of the coaxial cable is electrically connected to the ground conductor 11. This leads to that the radio signal is fed from the radio communication apparatus circuit 90 to the feeding point 12a via the coaxial cable. The aforementioned rectangular waveguide 503a and the antenna element 13a constitute the waveguide antenna unit 603a operated in a manner similar to that of the first embodiment shown in FIG. 2.

In addition, the ceiling conductor 15b is provided on the terminating conductor 14b and the partitioning-wall conductors 31b and 31c, the ceiling conductor 15c is provided on the terminating conductor 14c and the partitioning-wall conductors 31c and 31d, and the ceiling conductor 15d is provided on the terminating conductor 14d and the partitioning-wall conductors 31d and 31a. The waveguide antenna units 603b to 603d including the antenna elements 13b, 13c and 13d are constituted in a manner similar to that of above.

In the present embodiment in which the components corresponding to the side conductors 16a1 and 16a2 to 16d1 and 16d2 according to the first embodiment are integrated as the partitioning-wall conductors 31a to 31d, the antenna apparatus simplified in the structure as compared with the first embodiment can be provided. In order to further simplify the structure of the antenna apparatus, the ceiling conductors 15a to 15d may be made of an integrated electrical conductor plate.

In this case, the space surrounded by the housing formed by the ceiling conductors 15a to 15d, the terminating conductors 14a to 14d and the ground conductor 11 is called an antenna internal part. A space on the opposite side of the antenna internal part relative to the ceiling conductors 15a to 15d, the terminating conductors 14a to 14d or the ground conductor 11 is called an antenna external part.

In the present embodiment, as an example of the configuration, the ground conductor 11, the terminating conductors 14a to 14d and the ceiling conductors 15a to 15d are electrically connected, the feeding points 12a to 12d are arranged on the X axis or Y axis, and the antenna elements 12a to 12d are each made of an electrical conductor line or wire vertical to the X-Y plane.

The waveguide array antenna apparatus of type integrally incorporated in the housing according to the present embodiment operates in a manner similar to that of the waveguide array antenna apparatus according to the first embodiment. More concretely, when radio signal is fed to the antenna element 13a of the waveguide array antenna apparatus of type integrally incorporated in the housing according to the present embodiment, the directivity intensified in the +Z direction and +X direction can be obtained. Therefore, in FIG. 34, when the radio signal is fed to the antenna element 13b, the intensified radio wave is radiated in the +Y direction. When the radio signal is fed to the antenna element 13c, the intensified radio wave is radiated in the −X direction. When the radio signal is fed to the antenna element 13d, the intensified radio wave is radiated in the −Y direction.

In the waveguide array antenna apparatus with the slots according to the present embodiment, the switch for selectively changing the antenna element with a fed radio signal and connected to the respective antenna elements 13a to 13d is used in a manner similar to that of the waveguide array antenna apparatus according to the first embodiment, so that the antenna element having the directivity intensified in the desired direction is selectively operated. As a result, the directivity changeover antenna apparatus can be realized capable of selectively changing the direction of the radiated radio wave. This leads to coverage in a range of 360 degrees on the horizontal plane.

The waveguide array antenna apparatus of type integrally incorporated in the housing is described with reference to the radiation of the radio wave therefrom. However, the same configuration can be applied to the reception of the radio wave. In that case, a larger received power can be obtained when the antenna element having the directivity intensified in the direction of the arrived radio wave is connected to the feeding cable (not shown). For example, when the radio wave arrives from the +X direction, the antenna element 13a is connected to the feeding cable via the switch 17 as shown in FIG. 5. Thus, according to waveguide array antenna apparatus of type integrally incorporated in the housing of the present embodiment, the directivity changeover antenna apparatus can be realized so that the strength of the power of the radio wave received by the respective antenna elements 13a to 13d is judged by the received power judging unit 18 as shown in FIG. 5, and the switch 17 is controlled so that the antenna element having a larger power of the received radio wave is operated in a manner similar to that of the waveguide array antenna apparatus according to the first embodiment. This leads to coverage in a range of 360 degrees on the horizontal plane can be covered at the time of the reception.

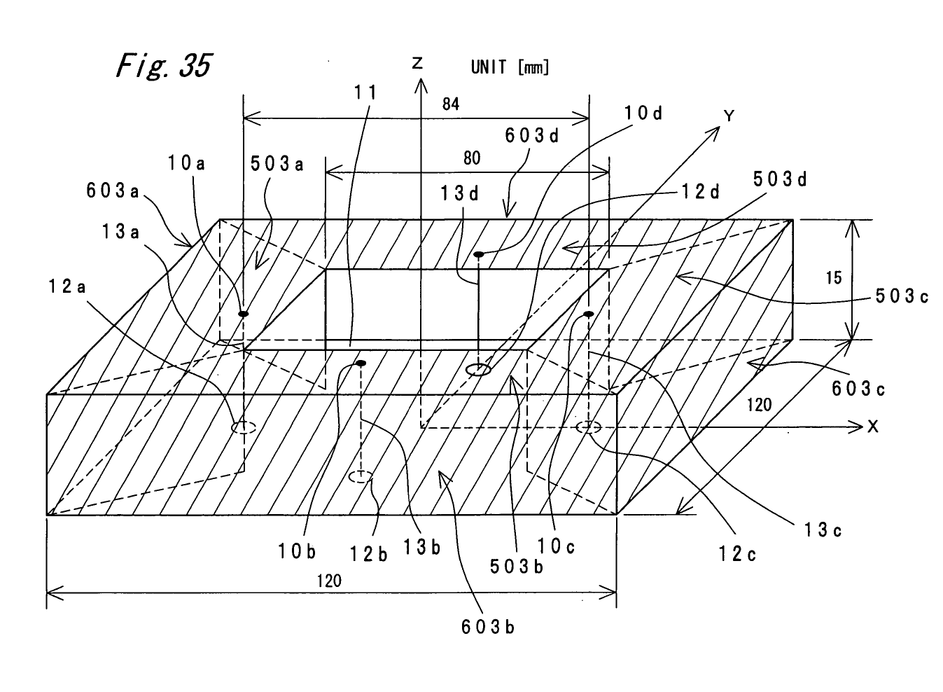

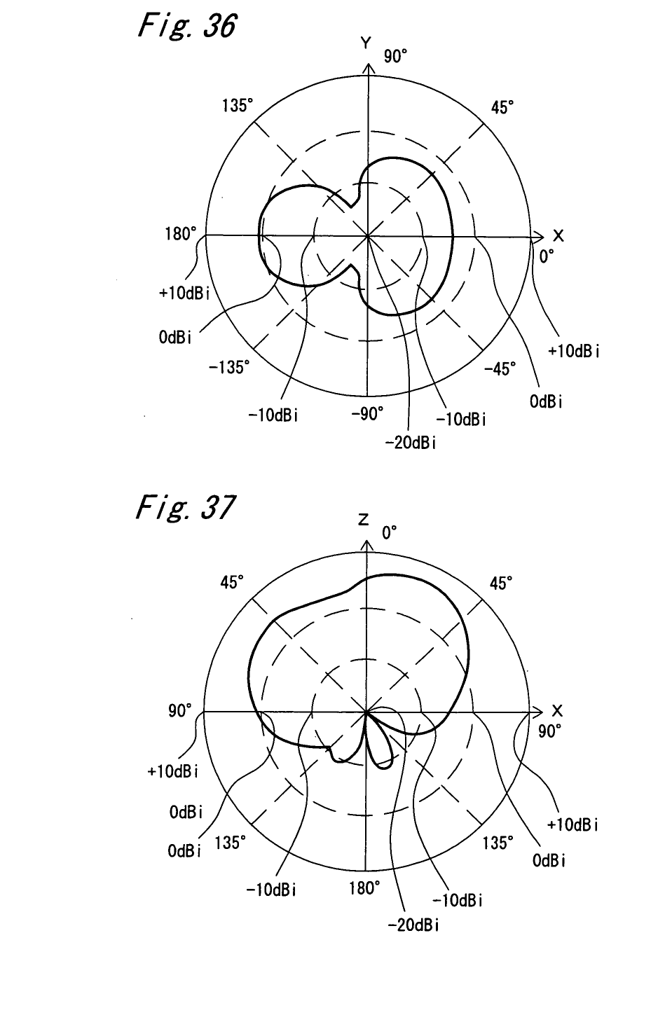

FIG. 35 is a perspective view showing a configuration of a waveguide array antenna apparatus integrally incorporated in a housing according to an implemental example of the third embodiment of the present invention, and in FIG. 35, a prototype waveguide array antenna apparatus integrally incorporated in a housing actually manufactured by the inventors of the present invention is shown. As an example, the length of the ground conductor 11 in the X direction is 120 mm, the width thereof in the Y direction is 120 mm, and the length of the terminating conductors 14a to 14d in the direction in parallel to the X-Y plane is 120 mm. The height of the terminating conductors 14a to 14d and the partitioning-wall conductors 31a to 31d in the Z direction is 12 mm, and the distance from the upper base to the lower base of the ceiling conductors 15a to 15d having a trapezoidal shape is 20 mm. The connecting points 10a to 10d on the top ends of the antenna elements 13a to 13d are provided at a position by 2 mm distant from the open ends of the rectangular waveguides 503a to 503d including the antenna elements 13a to 13d. The antenna elements 13a to 13d extend downward from the connecting points 10a to 10d and connected to the feeding points 12a to 12d respectively arranged on the X axis or the Y axis. FIG. 36 shows a characteristic when the waveguide array antenna apparatus of type integrally incorporated in the housing is constituted as described above.

FIGS. 36 and 37 are characteristic charts of radiation directivity characteristics when the antenna element 13a of the waveguide array antenna apparatus of type integrally incorporated in the housing shown in FIG. 35 is fed with the radio signal of the 2.6 GHz, where the radiation directivity characteristic on the X-Y plane (on the horizontal plane) is shown in FIG. 36, and the radiation directivity characteristic on the Z-X plane (on the vertical plane) is shown in FIG. 37. Each interval of the scales in the radiation directivity characteristic is 10 dB, and the unit is dBi based on an ideal radiation power of a point wave source. It is understood from FIG. 37 that the radiation of the radio wave shows the directivity intensified in the +Z direction and +X direction, and the waveguide array antenna apparatus of type integrally incorporated in the housing according to the present embodiment is simplified in its structure and shows the directivity intensified in one direction. The gain of 1.0 dBi was obtained in the negative direction on the X axis on the horizontal plane.

According to the waveguide array antenna apparatus of type integrally incorporated in the housing of the present embodiment constituted as described above, the antenna apparatus can be realized capable of radiating the radio wave with concentrating the power of the radio wave in the direction of the desirably transmitted radio signal. Further, the waveguide array antenna apparatus of type integrally incorporated in the housing according to the present embodiment realizes the antenna apparatus in which the height in the Z direction is 0.1 wavelengths when the operation frequency is 2.6 GHz, which is a very thin antenna. As shown in the implemental example of FIG. 26, the waveguide array antenna apparatus of type integrally incorporated in the housing according to the present embodiment can realize the antenna apparatus further downsized as compared with the waveguide array antenna apparatus according to the first embodiment.

In the above-mentioned embodiment and implemental example, the waveguide array antenna apparatus of type integrally incorporated in the housing has the symmetrical structure relative to the Z-X plane and Z-Y plane, in which case the directivity characteristic of the radio wave radiated from the waveguide array antenna apparatus of type integrally incorporated in the housing is effectively symmetrical relative to the Z-X plane and Z-Y plane.

As described earlier, according to the waveguide array antenna apparatus of type integrally incorporated in the housing of the present embodiment, the antenna apparatus can be realized having a reduced size, having a reduced thickness in shape, having a simplified structure, and having the intensified directivity as compared with the prior art, and capable of selectively changing the main beam direction.

The waveguide array antenna apparatus of type integrally incorporated in the housing exemplified in the present embodiment is symmetrical relative to the Z-X plane and Z-Y plane and has the same sectional shapes on the Z-X plane and Z-Y plane. However, the present invention is not limited thereto. For example, when the radiation space is extended in the ±X direction, the antenna apparatus extended in the Y direction may be provided. In that case, the operation principle is not any different to that of the waveguide array antenna apparatus according to the first embodiment. According to the structure, the directivity is intensified in ±X direction, and the antenna apparatus suitable for the radiation space extended in the ±X direction is obtained. Thus, when the lengths of the waveguide array antenna apparatus of type integrally incorporated in the housing in the X and Y directions are changed, the antenna apparatus can be realized having a radiation directivity characteristic that is the most suitable for the radiation space.

The waveguide array antenna apparatus of type integrally incorporated in the housing according to the present embodiment described above is symmetrical relative to the Z-X plane and Z-Y plane as an example of the configuration. However, the present invention is not limited thereto. For example, the antenna apparatus may be symmetrical relative to only the Z-X plane or Z-Y plane in order to obtain the desired radiation directivity characteristic or the desired input impedance characteristic. Accordingly, the antenna apparatus can be realized having a radiation directivity characteristic that is the most suitable for the radiation space.

Further, in the waveguide array antenna apparatus of type integrally incorporated in the housing according to the present embodiment, the antenna elements 13a to 13d are each made of an electrical conductor line or wire. However, the present invention is not limited thereto. For example, the antenna elements 13a to 13d may be made of an electrical conductor having the plate shape. As a result, the desired input impedance characteristic is obtained, and then, the antenna apparatus can effectively have a high efficiency with a reduced reflection loss.

Still further, as a method of obtaining the desired input impedance characteristic, the matching conductor may be provided in a manner similar to that of the waveguide array antenna apparatus according to the first embodiment. For example, the matching conductor 19a as shown in FIG. 15 may be additionally provided in the configuration of the waveguide array antenna apparatus of type integrally incorporated in the housing shown in FIG. 34. In the example shown in FIG. 15, the matching conductor 19a is made of a linear electrical conductor, and is connected to the ground conductor 11. This leads to that the impedance of the antenna element 13a can be changed when the electric field in the vicinity of the antenna element 13a is changed and then the current flowing in the antenna element 13a is changed. As an advantageous effect obtained by that, the desired input impedance characteristic can be obtained, and the high-efficiency antenna apparatus can be realized with a reduced reflection loss. In order to obtain the desired input impedance characteristic, the matching conductor 19a may be connected to the ground conductor 11 and the ceiling conductor 15a as shown in FIG. 16, or the matching conductor 19a may be connected to the ground conductor 11 and the antenna element 13a as shown in FIG. 17 in addition to the configuration of the waveguide array antenna apparatus with the slots shown in FIG. 25. This leads to that the current flowing in the antenna element 13a can be directly changed, and further leads to such an effect that the impedance characteristic of the waveguide array antenna apparatus of type integrally incorporated in the housing can be largely changed. The method of adjusting the impedance of the antenna element 13a is described as an example. However, the same advantageous effect can be obtained from the other antenna elements 13b to 13d.

As a method of changing the radiation characteristic of the waveguide array antenna apparatus of type integrally incorporated in the housing according to the present embodiment, the directivity characteristic controlling conductor 20a as shown in FIG. 18 may be provided in a manner similar to that of the waveguide array antenna apparatus according to the first embodiment. In the example shown in FIG. 18, the directivity characteristic controlling conductor 20a is connected to the ground conductor 11 at the positive position on the X axis. The example shows such an advantageous effect that the directivity of the radiation radio wave is intensified in the +X direction as compared with the case of not providing the directivity characteristic controlling conductor 20a because the directivity characteristic controlling conductor 20a operates as a wave director. Referring to FIG. 18, the directivity characteristic controlling conductor 20a is made of a linear electrical conductor wire or line. However, it may be made of an electrical conductor having a different shape. For example, the helical-type matching conductor made of a spiral electrical conductor wire or an electrical conductor wire bent in a shape of L-letter may constitute the directivity characteristic controlling conductor 20a. This leads to that the antenna apparatus can be made thinner without failing to have the effect obtained by providing the directivity characteristic controlling conductor 20a. The directivity characteristic controlling conductor 20a is described as an example of adjusting the directivity characteristic of the antenna element 13a. However, the same advantageous effect can be obtained when the directivity characteristic controlling conductor is provided for the other antenna elements 13b to 13d.

In the waveguide array antenna apparatus of type integrally incorporated in the housing, the directivity characteristic controlling conductor 20a-1 constituted by the linear conductor 19 in parallel to the Z axis and the linear conductor 92 in parallel to the Y axis may be provided as shown in FIG. 19. In this case, most desirably, the linear conductor 91 in parallel to the Z axis is connected at the center of the linear conductor 92 in parallel to the Y axis, and the sum of the length of the linear conductor 91 in parallel to the Z axis and half the length of the linear conductor 92 in parallel to the Y axis is approximately equal to ¼ wavelengths. When the lengths are thus set, in a manner similar to that of the case of the waveguide array antenna apparatus according to the first embodiment, a resonance is caused by the directivity characteristic controlling conductor 20a-1, and this achieves a larger effect in controlling the directivity characteristic. The provision of the directivity characteristic controlling conductor 20a as shown in FIG. 18 is designed to mainly improve the directivity characteristic of the antenna apparatus on the vertical plane (on the Z-X plane). However, when the directivity characteristic controlling conductor 20a-1 as shown in FIG. 19 is provided, the directivity characteristic of the antenna apparatus on the X-Y plane can be also changed. The description is made to the directivity characteristic controlling conductor 20a-1 for adjusting the directivity characteristic of the antenna element 13a as an example. However, the same advantageous effect can be obtained when the directivity characteristic controlling conductor is provided for the other antenna elements 13b to 13d.

In the above description, one directivity characteristic controlling conductor is provided for the antenna elements 13a to 13d. However, at least two directivity characteristic controlling conductors may be provided. As a result, the degree of freedom in the structure of the waveguide array antenna apparatus of type integrally incorporated in the housing is increased, which enables larger control of the radiation directivity characteristic. The directivity characteristic controlling conductor 20a or 20a-1 may be provided together with the matching conductors 19a, 19a-1 and 19a-2 shown in FIGS. 15 to 17.

In the above description of the present embodiment, the waveguide array antenna apparatus of type integrally incorporated in the housing includes the ground conductor 11 having the polygonal (that is square) shape. However, the present invention is not limited thereto. For example, the ground conductor 11 may have the rectangular or any other polygonal shape, or the shape formed from a combination of semi circles or any other shape in order to obtain the desired radiation directivity characteristic or the desired input impedance characteristic. There is such a demand that the shape of the waveguide array antenna apparatus of type integrally incorporated in the housing be in harmony with the grid pattern on the ceiling surface or the shape of the room when the waveguide array antenna apparatus is arranged on the ceiling or the like so that the waveguide array antenna apparatus can be inconspicuous. However, in the case of the rectangular or any other polygonal waveguide array antenna apparatus of type integrally incorporated in the housing, the direction in which the waveguide array antenna apparatus is arranged is limited because the grid pattern on the ceiling surface or the shape of the room is unchangeable. In order to solve the problem, in a manner similar to that of the sixth modified example of the first embodiment shown in FIG. 23, when the radome 21 having the bottom surface of the substantially circular shape (or any other shape such as an elliptical shape) in contact with the ground conductor 11 is used so as to prevent the invasion of moist, dust and the like that possibly deteriorate the antenna characteristic so as to stabilize the characteristic of the antenna apparatus. The use of the radome 21 further advantageously allows the waveguide array antenna apparatus of type integrally incorporated in the housing to be arranged irrespective of the grid pattern on the ceiling surface or the shape of the room when it is arranged on the ceiling. When the bottom surface of the waveguide array antenna apparatus of type integrally incorporated in the housing is circular, the waveguide array antenna apparatus of type integrally incorporated in the housing may be rotated so as to change its mounted direction. This leads to that the direction of the radiated radio wave can be adjusted, and the radiation characteristic that is the most suitable for the position where the waveguide array antenna apparatus of type integrally incorporated in the housing is arranged can be obtained.

In addition, in the configuration described in the present embodiment, the switch as shown in FIG. 5 is used and selectively switched over so that the feeding cable (not shown) is connected to the antenna element having the increased received power relative to the radio signal incoming from a certain azimuth. However, the present invention is not limited thereto. As an alternative configuration, the combining circuit as shown in FIG. 24 is provided, the amplitude adjuster circuits 22a to 22d are respectively connected to the antenna elements 13a to 13d of the waveguide array antenna apparatus of type integrally incorporated in the housing, and the phase shifters 23a to 23d are respectively connected to the amplitude adjuster circuits 22a to 22d so that the amplitude and phase of the radio wave received by the respective antenna elements 13a to 13d is changed, and the powers of the radio signals are combined by the combiner 24. The antenna controller 25 may be additionally provided. The antenna controller 25 calculates the amplitude adjusting amounts by the amplitude adjuster circuits 22a to 22d and the phase-shifting amounts by the phase shifters 23a to 23d so that the power of the output signal from the combining circuit is maximized, and controls the amplitude adjuster circuits 22a to 22d and the phase shifters 23a to 23d based on the calculation result. According to the above-mentioned configuration, the received power can be further increased.

Further, a plurality of waveguide array antenna apparatuses integrally incorporated in the housings according to the present invention may be arranged in a shape of array so as to constitute the phased array antenna and adaptive antenna array. This leads to that the directivity characteristic of the radiated radio wave can be further controlled.

### Fourth Embodiment

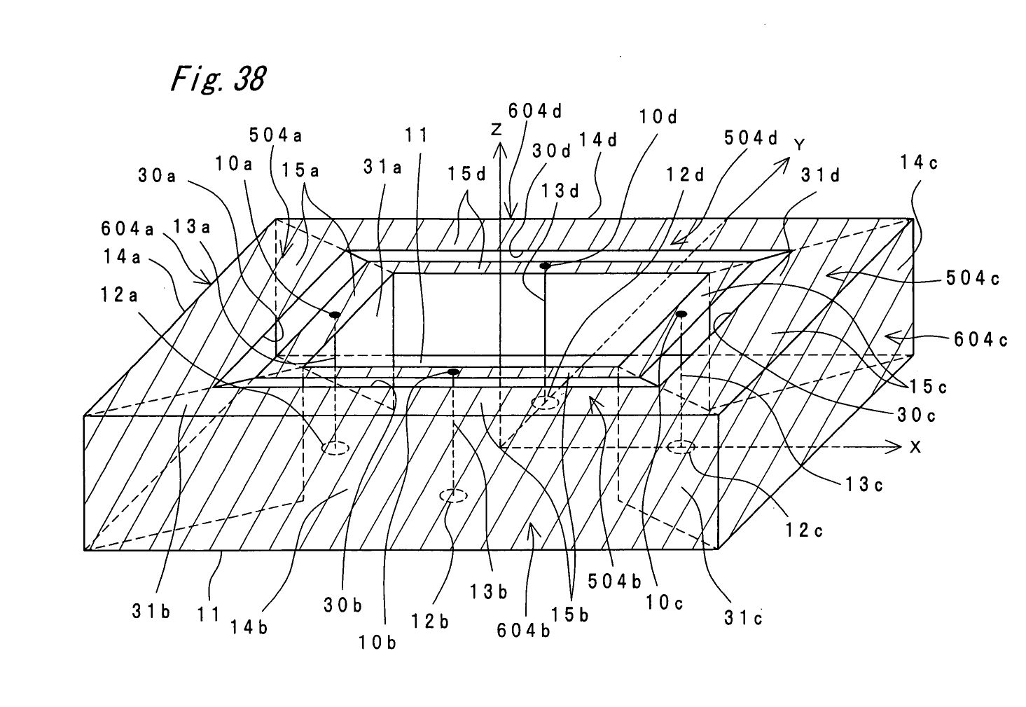

FIG. 38 is a perspective view showing a configuration of a waveguide array antenna apparatus with slots and of type integrally incorporated in a housing according to a fourth embodiment of the present invention. Referring to FIG. 38, the waveguide array antenna apparatus with the slots and of type integrally incorporated in the housing according to the present embodiment is different to the waveguide array antenna apparatus of type integrally incorporated in the housing shown in FIG. 34 in that slots 30a to 30d each having a longitudinal direction vertical to the direction of the radio signal transmitted by the rectangular waveguides 504a to 504d (that is the same direction as the width direction of the rectangular waveguides 504a to 504d) and a width sufficiently small relative to the ¼ wavelengths of the guide wavelength are provided in the ceiling conductors 15a to 15d constituting four rectangular waveguides 504a, 504b, 504c and 504d included in the waveguide array antenna apparatus with the slots and of type integrally incorporated in the housing according to the present embodiment. The slots 30a to 30d are provided between the connecting units 10a to 10d of the antenna elements 13a to 13d and the terminating conductors 14a to 14d of the ceiling conductors 15a to 15d. The rectangular waveguide 504a including the antenna element 13a constitutes a waveguide antenna unit 604a, the rectangular waveguide 504b including the antenna element 13b constitutes a waveguide antenna unit 604b, the rectangular waveguide 504c including the antenna element 13c constitutes a waveguide antenna unit 604c, and the rectangular waveguide 504d including the antenna element 13d constitutes a waveguide antenna unit 604d.

In the present embodiment, as an example of the configuration, the ground conductor 11 is located on the X-Y plane, the ground conductor 11, the terminating conductors 14a to 14d, the partitioning-wall conductors 31a to 31d and the ceiling conductors 15a to 15d are electrically connected. Further, the feeding points 12a to 12d are arranged on the X axis or Y axis, the antenna elements 13a to 13d are each made of an electrical conductor line or wire vertical to the X-Y plane, and each of the slots 30a to 30d is provided for each of the ceiling conductors 15a to 15d.

The waveguide array antenna apparatus with the slots and of type integrally incorporated in the housing according to the present embodiment operates in a manner similar to that of the waveguide array antenna apparatus with the slots according to the second embodiment. More concretely, in the waveguide array antenna apparatus with the slots and of type integrally incorporated in the housing according to the present embodiment, when the radio signal is fed to the antenna element 13a, the radio wave is radiated by the electric field generated between the ceiling conductor 15a and the ground conductor 11 and the electric field generated by the slot 30a, and this leads to that the directivity intensified in the +Z direction and +X direction can be obtained. In a manner similar to that of above, in FIG. 38, when the radio signal is fed to the antenna element 13b, the intensified radio wave is radiated in the +Y direction. When the radio signal is fed to the antenna element 13c, the intensified radio wave is radiated in the −X direction. Further, when the radio signal is fed to the antenna element 13d, the intensified radio wave is radiated in the −Y direction.

In the waveguide array antenna apparatus with the slots and of type integrally incorporated in the housing according to the present embodiment, the switch connected to the antenna elements 13a to 13d and serving to selectively change the antenna element with a fed radio signal is used so that the antenna element having the directivity intensified in the desired direction is selectively operated in a manner similar to that of the waveguide array antenna apparatus according to the first embodiment. As a result, the directivity changeover antenna apparatus can be realized capable of selectively changing the direction of the radiated radio wave. Accordingly, the 360-degree range on the horizontal plane can be covered.

In addition, in the above-mentioned description of the present embodiment, the radio wave is radiated from the waveguide array antenna apparatus with the slots and of type integrally incorporated in the housing. However, the above-mentioned configuration can be applied to the reception of the radio wave in a manner similar to that of above. Upon receiving the radio wave, the feeding cable (not shown) is connected to the antenna element having the directivity intensified in the direction of the arrived radio wave so that a larger received power can be obtained. For example, when the radio wave arrives from the +X direction, the antenna element 13a is connected to the feeding cable via the switch 17 as shown in FIG. 5. In the waveguide array antenna apparatus with the slots and of type integrally incorporated in the housing according to the present embodiment, the strengths of the powers of the radio waves received by the antenna elements 13a to 13d are judged by the received power judging unit 18 as shown in FIG. 5, and the switch 17 is controlled so that the antenna element having a larger power of the received radio wave of radio signal is operated in a manner similar to that of the waveguide array antenna apparatus according to the first embodiment. As a result, the directivity changeover antenna apparatus can be realized. This leads to coverage in a range of 360 degrees on the horizontal plane at the time of the reception as well.

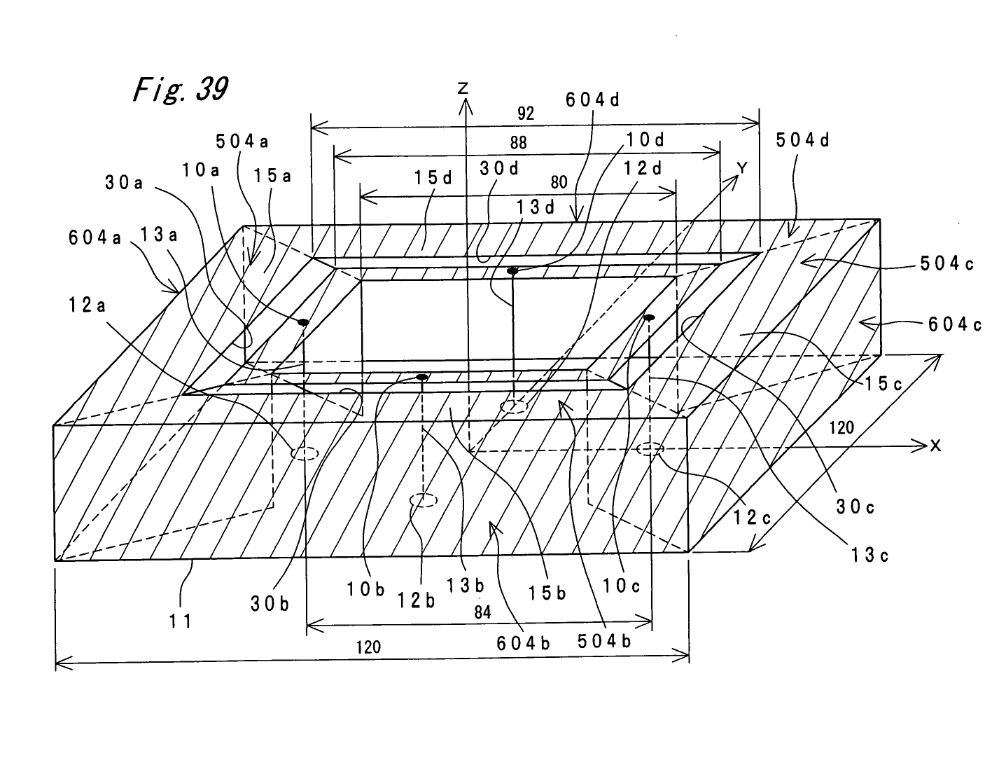

FIG. 39 is a perspective view showing a configuration of a waveguide array antenna apparatus with slots and of type integrally incorporated in a housing according to a first implemental example of the fourth embodiment of the present invention, and in FIG. 39, a prototype waveguide array antenna apparatus with slots and of type integrally incorporated in a housing actually manufactured by the inventors of the present invention is shown. The dimensions of the housing unit including the ground conductor 11, the terminating conductors 14a to 14d, the partitioning-wall conductors 31a to 31d and the ceiling conductors 15a to 15d and the positions of the antenna elements 13a to 13d are the same as those of the waveguide array antenna apparatus of type integrally incorporated in the housing shown in FIG. 38. In the present implemental example, the slots 30a to 30d are respectively provided on the ceiling conductors 15a to 15d. The slots 30a to 30d have a width of 2 mm and extend in the directions vertical to the directions where the radio signal is transmitted in the rectangular waveguides 504a and 504b, and the centers of the width directions of the slots 30a to 30d are positioned distant from the open ends of the rectangular waveguides 504a to 504d by 5 mm. A characteristic of the waveguide array antenna apparatus with the slots and of type integrally incorporated in the housing constituted as above will be described below.

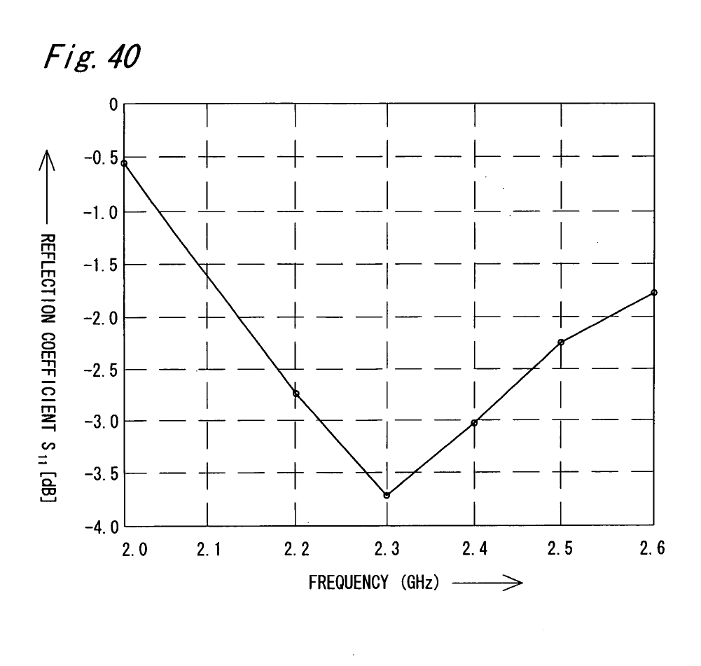

FIG. 40 is a characteristic chart showing a frequency characteristic of a reflection coefficient S₁₁ of the antenna element 13a of the waveguide array antenna apparatus with the slots and of type integrally incorporated in the housing shown in FIG. 39. As shown in FIG. 40, the resonance is generated at 2.3 GHz of the waveguide array antenna apparatus with the slots and of type integrally incorporated in the housing according to the present implemental example. Because the waveguide array antenna apparatus with the slots and of type integrally incorporated in the housing according to the present implemental example has the symmetrical shape, the same characteristic can be obtained in the case of feeding to antenna elements 13b to 13d.

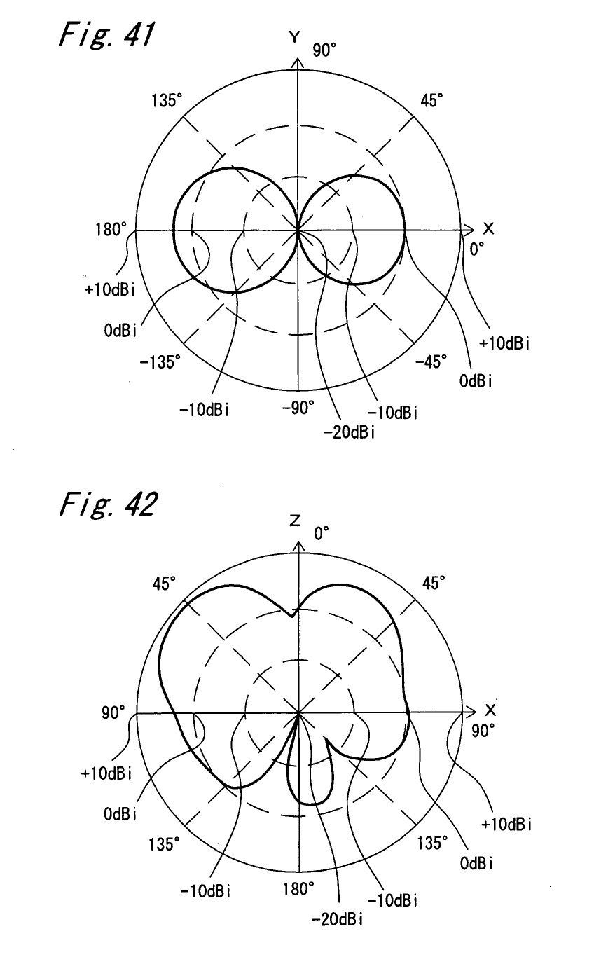

FIGS. 41 and 42 are characteristic charts of radiation directivity characteristics when the radio signal of the frequency 2.3 GHz is fed to the antenna element 13a of the waveguide array antenna apparatus with the slots and of type integrally incorporated in the housing shown in FIG. 39, where the radiation directivity characteristic on the X-Y plane (on the horizontal plane) is shown in FIG. 41, and the radiation directivity characteristic on the Z-X plane (on the vertical plane) is shown in FIG. 42. Each of scales in the radiation directivity characteristic has the interval of 10 dB, and the unit is dBi based on the radiated power of the ideal point wave source. As is apparent from FIG. 42, the radiation of the radio wave shows the directivity intensified in the +Z direction and +X direction, the structure is simplified, and the directivity intensified in one direction is realized. With reference to the direction of the maximum radiation, the relatively large gain of 8.7 dBi was obtained on the vertical surface in the direction rotated from the Z axis through 45 degrees in the −X direction, and the gain of 3.4 dBi was obtained on the horizontal plane in the negative direction on the X axis.

As described above, according to the waveguide array antenna apparatus of the present embodiment, the antenna apparatus can be realized capable of radiating the radio wave with concentration of the power of the radio wave in the direction of the transmitted radio signal. Further, the waveguide array antenna apparatus with the slots and of type integrally incorporated in the housing according to the present embodiment realizes the antenna apparatus in which the height in the Z axis direction is 0.1 wavelengths at the operation frequency of 2.3 GHz, which is significantly reduced in thickness in shape.

In addition, in the present embodiment and implemental example, the waveguide array antenna apparatus with the slots and of type integrally incorporated in the housing having the symmetrical structure relative to the Z-X plane and Z-Y plane is described. Such a structure has such an advantageous effect that the directivity characteristic of the radio wave radiated from the waveguide array antenna apparatus with the slots and of type integrally incorporated in the housing is symmetrical relative to the Z-X plane and Z-Y plane.

Further, according to the waveguide array antenna apparatus with the slots and of type integrally incorporated in the housing according to the present embodiment, the antenna apparatus can be realized having a reduced size, having a reduced thickness in shape, having a simplified structure, and having the directivity intensified as compared with the prior art, and capable of selectively changing the main beam direction.

In the above-mentioned embodiment, the waveguide array antenna apparatus with the slots and of type integrally incorporated in the housing is described as the antenna apparatus symmetrical relative to the Z-X plane and Z-Y plane and having the same sectional shapes on the Z-X plane and Z-Y plane. However, the present invention is not limited thereto. For example, when the radiation space is extended in the ±X direction, the antenna apparatus may be extended in the Y direction. Such an antenna apparatus operates in a manner similar to that of the waveguide array antenna apparatus according to the first embodiment. Because of the structure, the antenna apparatus whose directivity is intensified in the ±X direction suitable for the radiation space extended in the ±X direction can be obtained. When the lengths of the antenna apparatus in the X and Y directions are thus changed, the antenna apparatus can be realized having a radiation directivity characteristic that is the most suitable for the radiation space.

The present embodiment described that the waveguide array antenna apparatus with the slots and of type integrally incorporated in the housing had the structure of symmetry relative to the Z-X plane and Z-Y plane. However, the present invention is not limited thereto. For example, the antenna apparatus may be symmetrical relative to only the Z-X plane or only the Z-Y plane in order to obtain the desired radiation directivity characteristic or the desired input impedance characteristic. Thus, the antenna apparatus can be realized having a radiation directivity characteristic that is the most suitable for the radiation space.

In addition, in the present embodiment, the antenna apparatus in which the antenna elements 13a to 13d are each made of an electrical conductor line or wire is described. However, the present invention is not limited thereto. For example, the antenna elements 13a to 13d may be made of an electrical conductor having the plate shape. As a result, the desired input impedance characteristic can be obtained, and the antenna apparatus in which the reflection loss is reduced and the high-efficiency performance is expected can be effectively obtained.

Further, as a method of obtaining the desired input impedance characteristic, the matching conductor may be provided in a manner similar to that of the waveguide array antenna apparatus according to the first embodiment. For example, the matching conductor 19a as shown in FIG. 15 may be additionally provided in the configuration of the waveguide array antenna apparatus with the slots and of type integrally incorporated in the housing shown in FIG. 38. In the example shown in FIG. 15, the matching conductor 19a is made of a linear electrical conductor, and is connected to the ground conductor 11. Accordingly, the electric field in the vicinity of the antenna element 13a is changed so that the current flowing in the antenna element 13a is changed. As a result, the impedance of the antenna element 13a can be changed, and the desired input impedance characteristic can be obtained, which effectively realizes the high-efficiency antenna apparatus whose reflection loss is reduced. In order to obtain the desired input impedance characteristic, the matching conductor 19a may be connected to the ground conductor 11 and the ceiling conductor 15a as shown in FIG. 16, or the matching conductor 19a may be connected to the ground conductor 11 and the antenna element 13a as shown in FIG. 17 in addition to the configuration of the waveguide array antenna apparatus with the slots and of type integrally incorporated in the housing shown in FIG. 38. This leads to that the current flowing in the antenna element 13a can be directly changed, and then, this leads to that the impedance characteristic of the waveguide array antenna apparatus with the slots and of type integrally incorporated in the housing can be effectively largely changed. The method of adjusting the impedance of the antenna element 13a is described. However, the same advantageous effect can be obtained from the antenna elements 13b to 13d.

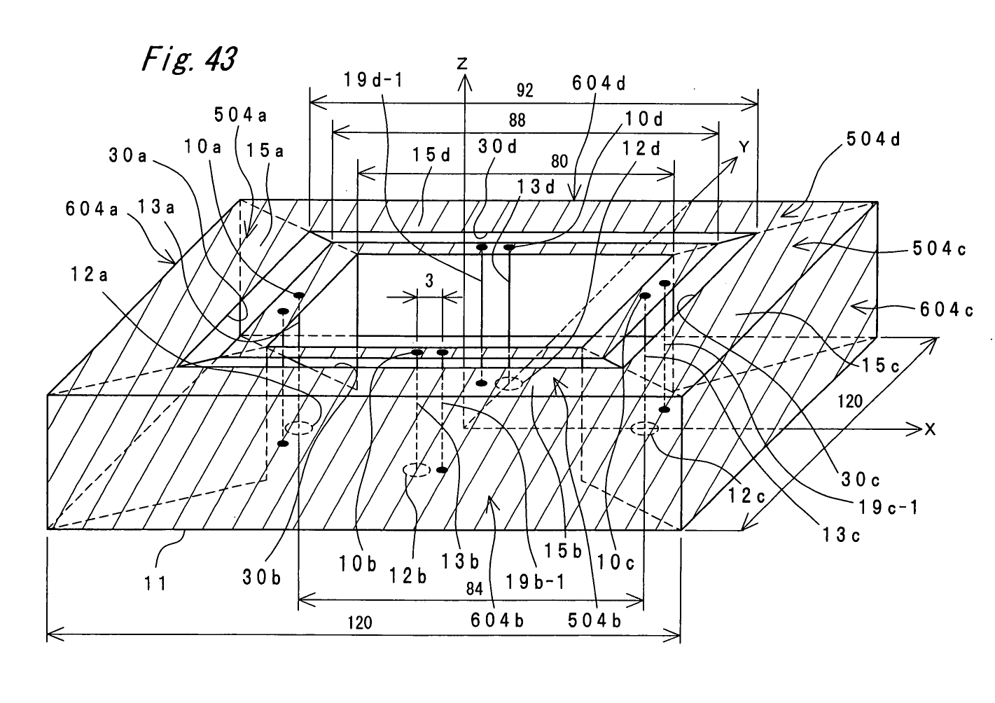

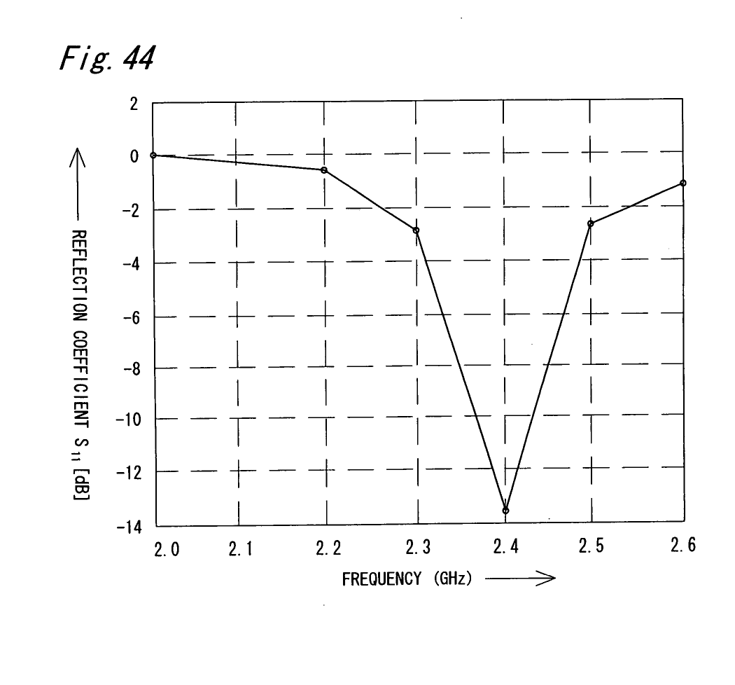

FIG. 43 is a perspective view showing a configuration of a waveguide array antenna apparatus with slots and of type integrally incorporated in a housing according to a second implemental example of the fourth embodiment of the present invention, and in FIG. 43, a prototype waveguide array antenna apparatus with slots and of type integrally incorporated in a housing manufactured by the inventors of the present invention is shown. The waveguide array antenna apparatus with the slots and of type integrally incorporated in the housing is further provided with the matching conductors 19a-1 to 19d-1 as shown in FIG. 16 in the configuration of the antenna apparatus of FIG. 39. The matching conductors 19a-1 to 19d-1 are inserted into the rectangular waveguides 504a to 504d by 2 mm from the open ends of the rectangular waveguides 504a to 504d, and they are arranged at positions distant from the antenna elements 13a to 13d by 3 mm in parallel to the antenna element 13a to 13d. In the waveguide array antenna apparatus with the slots and of type integrally incorporated in the housing according to the first implemental example shown in FIG. 39, the reflection loss is approximately −3.7 dB as shown in FIG. 40, and this does not allow the power of the radio signal to be efficiently fed to the antenna apparatus. Therefore, the matching conductors 19a-1 to 19d-1 are provided as shown in FIG. 43 so that the impedance matching with the feeding cable (not shown) is done so as to realize the high-efficiency antenna apparatus. FIG. 44 is a characteristic chart showing a frequency characteristic of a reflection coefficient S₁₁ of the waveguide array antenna apparatus with the slots and of type integrally incorporated in the housing shown in FIG. 43. As is apparent from FIG. 44, at 2.4 GHz, which is the resonance frequency of the waveguide array antenna apparatus with the slots and of type integrally incorporated in the housing, the reflection loss is −13.5 dB, showing that a favorable characteristic with a reduced reflection loss can be obtained.

As a method of changing the radiation characteristic of the waveguide array antenna apparatus with the slots according to the present embodiment, the directivity characteristic controlling conductor 20a as shown in FIG. 18 may be provided in a manner similar to that of the waveguide array antenna apparatus according to the first embodiment. In the example shown in FIG. 18, the directivity characteristic controlling conductor 20a is connected to the ground conductor 11 at the positive position on the X axis. Because the directivity characteristic controlling conductor 20a operates as a wave director, the radiated radio wave shows the directivity sharpened in the +X direction as compared with the case of not providing any directivity characteristic controlling conductor 20a. Referring to FIG. 18, the directivity characteristic controlling conductor 20a is made of a linear electrical conductor. However, it may be made of an electrical conductor having a different shape. For example, the helical-type matching conductor made of a spiral electrical conductor wire or the electrical conductor wire bent in a shape of L-letter may constitute the directivity characteristic controlling conductor 20a. This leads to that the antenna apparatus can be made thinner without failing to have the effect obtained by providing the directivity characteristic controlling conductor 20a. The example of providing the directivity characteristic controlling conductor 20a for adjusting the directivity characteristic of the antenna element 13a is described. However, the same advantageous effect can be obtained when the directivity characteristic controlling conductor is provided for any one of the other antenna elements 13b to 13d.

Further, the directivity characteristic control directivity 20a-1 constituted by the linear conductor 91 in parallel to the Z axis and the linear conductor 92 in parallel to the Y axis may be provided in the waveguide array antenna apparatus with the slots and of type integrally incorporated in the housing as shown in FIG. 19. Most desirably, the linear conductor 91 in parallel to the Z axis is connected at the center of the linear conductor 92 in parallel to the Y axis, and the sum of the length of the linear conductor 91 in parallel to the Z axis and half the length of the linear conductor 92 in parallel to the Y axis is equal to approximately ¼ wavelengths. When the lengths are thus set, the resonance is generated by the directivity characteristic controlling conductor 20a-1 in a manner similar to that of the waveguide array antenna apparatus according to the first embodiment, and a larger effect can be obtained upon controlling the directivity characteristic. The provision of the directivity characteristic controlling conductor 20a as shown in FIG. 18 serves as a technology mainly for improving the directivity characteristic of the antenna apparatus on the vertical plane (on the Z-X plane). When the directivity characteristic controlling conductor 20a-1 as shown in FIG. 19 is provided, the directivity characteristic of the antenna apparatus on the X-Y plane can be also changed. The example of the directivity characteristic controlling conductor 20a-1 for adjusting the directivity characteristic of the antenna element 13a is described. However, the same advantageous effect can be obtained when the directivity characteristic controlling conductor is provided for any one of the other antenna elements 13b to 13d.

In the above-mentioned description, one directivity characteristic controlling conductor is provided for the antenna elements 13a to 13d. However, at least two directivity characteristic controlling conductors may be provided. This leads to that the degree of freedom in the structure of the waveguide array antenna apparatus with the slots and of type integrally incorporated in the housing is increased, and this leads to that the radiation directivity characteristic can be more largely changed and controlled. The directivity characteristic controlling conductor 20a or 20a-1 may be provided together with the matching conductors 19a, 19a-1 and 19a-2 shown in FIGS. 15 to 17.

Further, in the present embodiment, the waveguide array antenna apparatus with the slots and of type integrally incorporated in the housing in which the ground conductor 11 has the polygonal shape (that is square) is described as an example. However, the present invention is not limited thereto. For example, in order to obtain the desired radiation directivity characteristic or desired input impedance characteristic, the ground conductor 11 may have the rectangular shape, any other polygonal shape, the shape formed from a combination of the semi circles, or any other shape. There is such a demand that the shape of the waveguide array antenna apparatus with the slots and of type integrally incorporated in the housing be in harmony with the grid pattern on the ceiling surface or the shape of the room when the waveguide array antenna apparatus is arranged on the ceiling or the like so that the waveguide array antenna apparatus can be inconspicuous. However, in the case of the rectangular or any other polygonal waveguide array antenna apparatus with the slots and of type integrally incorporated in the housing, the direction in which the waveguide array antenna apparatus is arranged is limited because the grid pattern on the ceiling surface or the shape of the room is unchangeable.

By the way, in order to solve the problems, the radome 21 whose bottom surface in contact with the ground conductor 11 is substantially circular (may have such a shape as an elliptical shape) is used in a manner similar to that of the sixth modified example of the first embodiment shown in FIG. 23 so that the invasion of moist, dust and the like, which deteriorates the antenna characteristic, can be prevented and the characteristic of the waveguide array antenna apparatus can be stabilized. Further, the waveguide array antenna apparatus with the slots and of type integrally incorporated in the housing, when arranged on the ceiling, can be advantageously arranged irrespective of the grid pattern on the ceiling surface or the shape of the room. Further, when the shape of the bottom surface of the waveguide array antenna apparatus with the slots and of type integrally incorporated in the housing is circular, the waveguide array antenna apparatus with the slots and of type integrally incorporated in the housing can be rotated so that its mounted direction can be changed. According to such a configuration, the direction of the radiated radio wave can be adjusted, and the radiation directivity characteristic that is the most suitable for the position at which the waveguide array antenna apparatus with the slots and of type integrally incorporated in the housing is arranged can be obtained.

In the present embodiment, the switch as shown in FIG. 5 is used for the selective changeover so that the feeding cable (not shown) is connected to the antenna element whose received power of radio signal is larger than that of the radio signal arriving from a predetermined azimuth as an example of the configuration. However, the present invention is not limited thereto. For example, the combining circuit as shown in FIG. 24 may be provided so that four radio signals received via the antenna elements 13a to 13d can be controlled and combined as described earlier.

In addition, a plurality of waveguide array antenna apparatuses with the slots and of type integrally incorporated in the housings may be arranged in a shape of array so as to constitute the phased array antenna and adaptive antenna array. Accordingly, the directivity characteristic of the radiated radio wave can be further controlled.

In the present embodiment, each of the slots 30a to 30d is provided for each of the ceiling conductors 15a to 15d as an example of the configuration. However, the present invention is not limited thereto. At least two slots may be provided for one of the ceiling conductors 15a to 15d. As a result, the phases of the radio waves transmitted and received by the respective slots can be made coherent so as to realize the even more intensified directivity. As another possible configuration, different numbers of slots may be provided in the respective ceiling conductors 15a to 15d.

In a manner similar to that of the waveguide array antenna apparatus with the slots according to the second embodiment, the waveguide array antenna apparatus with the slots and of type integrally incorporated in the housing according to the present embodiment has such an advantageous effect that the impedance characteristic of a broader band than that of the waveguide array antenna apparatus of type integrally incorporated in the housing according to the third embodiment can be obtained by giving a slight difference between the resonance frequency specific in the structure of the waveguide array antenna apparatus of type integrally incorporated in the housing according to the third embodiment and the resonance frequency which may be caused by the slots 30a to 30d.

### Fifth Embodiment

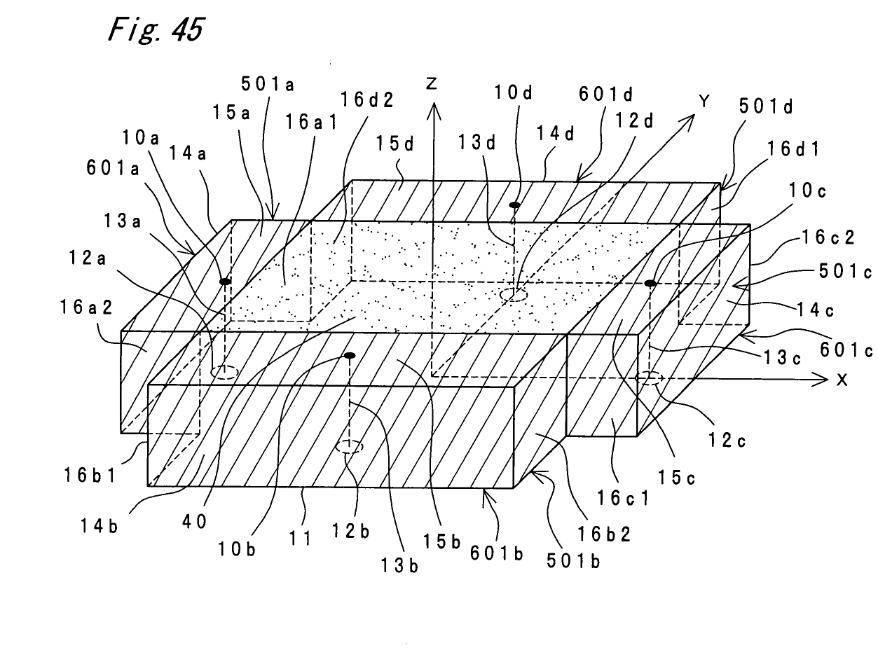

FIG. 45 is a perspective view showing a configuration of a waveguide array antenna apparatus according to a fifth embodiment of the present invention formed by filling the antenna internal part according to the first embodiment with a dielectric material. Referring to FIG. 45, the waveguide array antenna apparatus according to the present embodiment is characterized in that the antenna internal part is filled with a dielectric material 40 in the waveguide array antenna apparatus according to the first embodiment shown in FIG. 1. According to the above-mentioned configuration, an effective wavelength of an electromagnetic wave transmitted in the dielectric material 40 can be shortened in addition to the effect obtained in the first embodiment. As a result, the waveguide array antenna apparatus can be reduced in size and weight, and further, the waveguide array antenna apparatus can be manufactured on a dielectric substrate with a high precision by means of a publicly known conductor pattern forming method using a metal conductor. The present embodiment is further advantageous in that the antenna internal part filled with the dielectric material 40 prevents the invasion of dust, which eliminates a cleaning work.

As an example is shown that the ground conductor 11, the terminating conductors 14a to 14d, the side conductors 16a1 and 16a2 to 16d1 and 16d2, and the ceiling conductors 15a to 15d are electrically connected, the feeding points 12a to 12d are arranged on the X axis or Y axis, the antenna elements 13a to 13d are each made of an electrical conductor line or wire vertical to the X-Y plane, and the dielectric material 40 fills the entire antenna internal part.

The waveguide array antenna apparatus according to the present embodiment operates in a manner similar to that of the waveguide array antenna apparatus according to the first embodiment.

In the waveguide array antenna apparatus according to the present embodiment, the dielectric material 40 is inserted into the antenna internal part. Provided that a relative dielectric constant which is a ratio of a dielectric constant of the dielectric material 40 relative to a dielectric constant εₒ in vacuum is εᵣ, a wavelength in the dielectric material 40 is multiplied by 1/\sqrt{εᵣ} as compared with the wavelength in the vacuum. Since εᵣ is equal to or larger than one, then the wavelength is shortened by the dielectric material 40. Therefore, when the dielectric material 40 is inserted into the antenna internal part, the waveguide array antenna apparatus can be reduced in size and thickness in shape.

### Sixth Embodiment

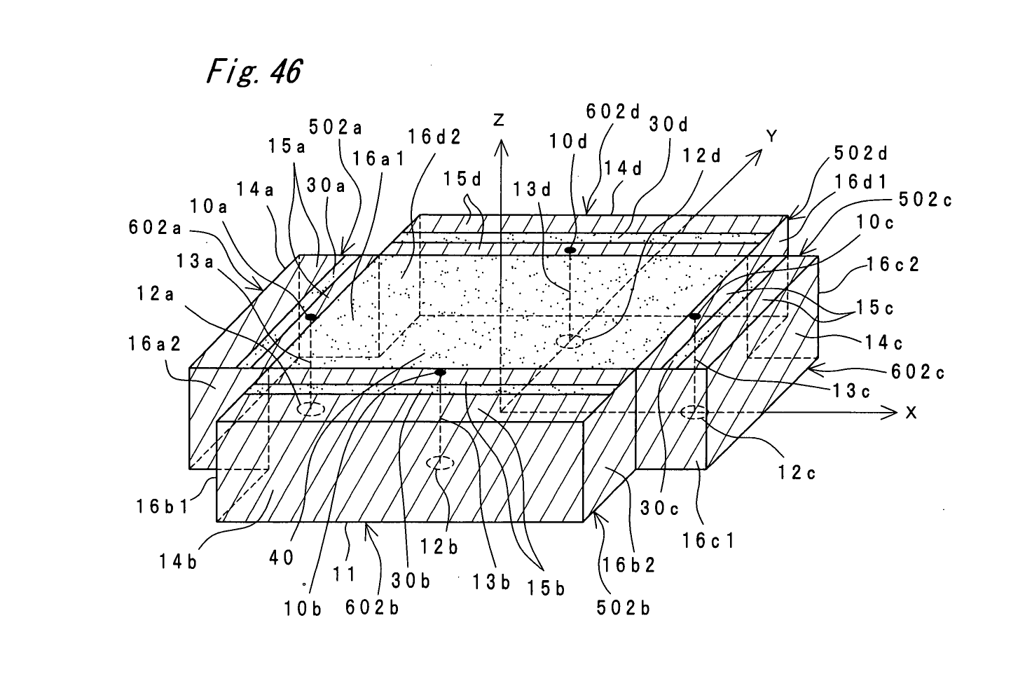

FIG. 46 is a perspective view showing a configuration of a waveguide array antenna apparatus with slots according to a sixth embodiment of the present invention formed by filling the antenna internal part according to the second embodiment with the dielectric material. In the waveguide array antenna apparatus shown in FIG. 46, the slots 30a to 30d are provided in the ceiling conductors 15a to 15d as compared with the waveguide array antenna apparatus shown in FIG. 45.

Referring to FIG. 46, the waveguide array antenna apparatus according to the present embodiment is characterized in that the antenna internal part of the waveguide array antenna apparatus with the slots according to the second embodiment shown in FIG. 25 is filled with the dielectric material 40. According to the configuration, in addition to the effect obtained in the second embodiment, the waveguide array antenna apparatus with the slots can be reduced in size and weight, and further, the waveguide array antenna apparatus with the slots can be more precisely manufactured on the dielectric substrate by means of the publicly known conductor pattern forming method using the metal conductor. The present embodiment is further advantageous in that the antenna internal part filled with the dielectric material 40 prevents the invasion of dust, which eliminates the cleaning work. The waveguide array antenna apparatus with the slots according to the present embodiment operates in a manner similar to that of the waveguide array antenna apparatus with the slots according to the second embodiment.

### Seventh Embodiment

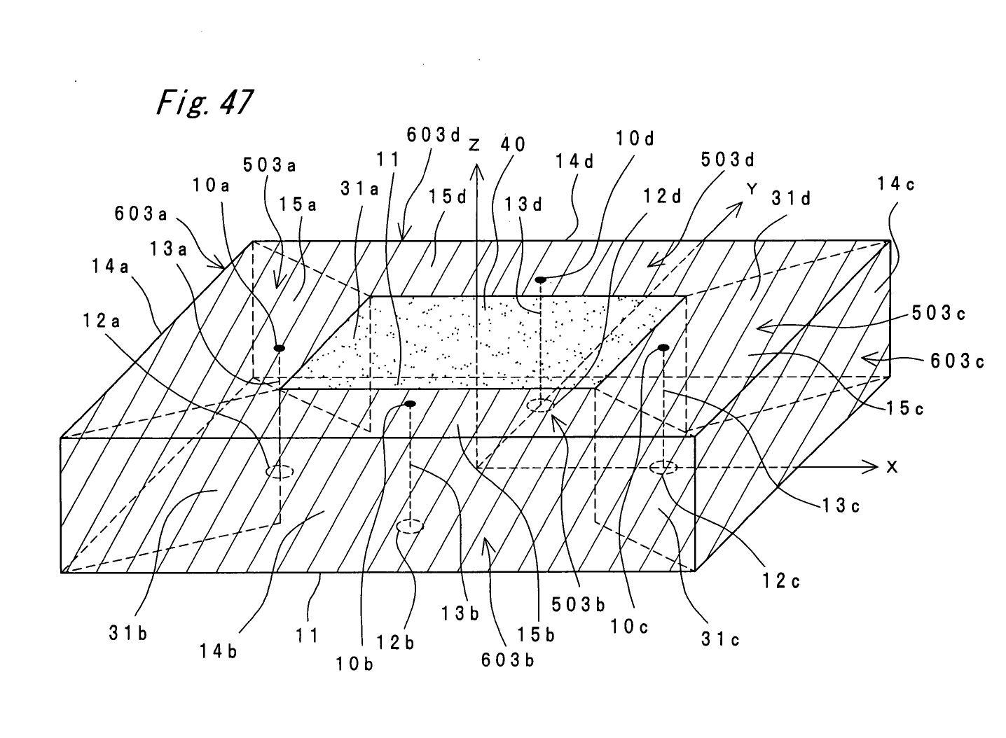

FIG. 47 is a perspective view showing a configuration of a waveguide array antenna apparatus integrally incorporated in a housing according to a seventh embodiment of the present invention formed by filling the antenna internal part according to the third embodiment with the dielectric material. Referring to FIG. 47, the waveguide array antenna apparatus of type integrally incorporated in the housing according to the present embodiment is characterized in that the antenna internal part of the waveguide array antenna apparatus of type integrally incorporated in the housing according to the third embodiment shown in FIG. 34 is filled with the dielectric material 40. According to the configuration, in addition to the effect obtained in the third embodiment, the waveguide array antenna apparatus of type integrally incorporated in the housing can be reduced in size and weight. The present embodiment is further advantageous in that the antenna internal part filled with the dielectric material 40 prevents the invasion of dust, which eliminates the cleaning work. The waveguide array antenna apparatus of type integrally incorporated in the housing according to the present embodiment operates in a manner similar to that of the waveguide array antenna apparatus of type integrally incorporated in the housing according to the third embodiment.

### Eighth Embodiment

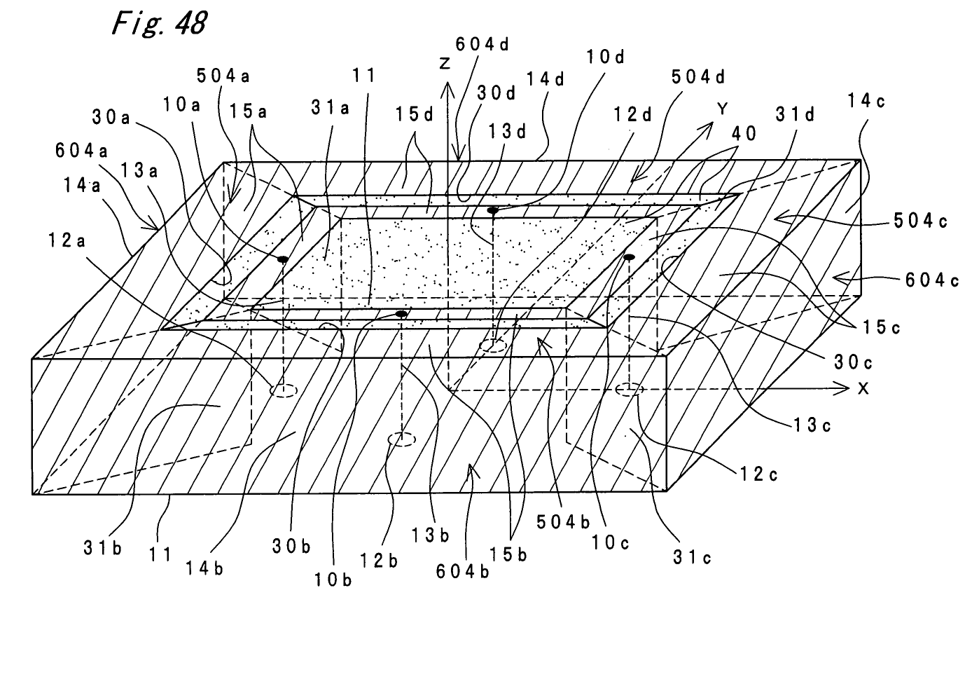

FIG. 48 is a perspective view showing a configuration of a waveguide array antenna apparatus with slots and of type integrally incorporated in a housing according to an eighth embodiment of the present invention formed by filling the antenna internal part according to the fourth embodiment with the dielectric material. Referring to FIG. 48, the waveguide array antenna apparatus with the slots and of type integrally incorporated in the housing according to the present embodiment is characterized in that the antenna internal part is filled with the dielectric material 40 in the waveguide array antenna apparatus with the slots and of type integrally incorporated in the housing according to the fourth embodiment shown in FIG. 38. According to the above-mentioned configuration, in addition to the effect obtained by the fourth embodiment, the waveguide array antenna apparatus with the slots and of type integrally incorporated in the housing can be reduced in size and weight, and advantageously eliminates any cleaning work because the dielectric material 40 filling the antenna internal part can prevent the invasion of dust. The waveguide array antenna apparatus with the slots and of type integrally incorporated in the housing according to the present embodiment operates in a manner similar to that of the waveguide array antenna apparatus with the slots and of type integrally incorporated in the housing according to the fourth embodiment.

In the fifth to eighth embodiments described so far, the antenna internal parts in the respective configurations according to the first to fourth embodiments are filled with the dielectric material 40. However, the antenna internal part may be filled with the dielectric material 40 in the respective modified examples and implemental examples of the first to fourth embodiments.

### Ninth Embodiment

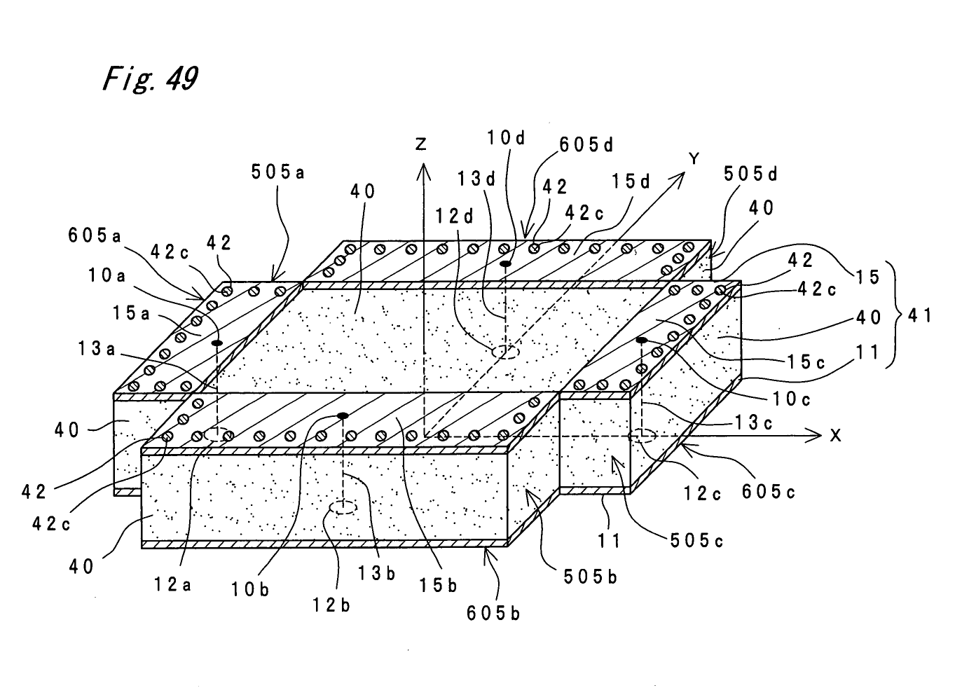

FIG. 49 is a perspective view showing a configuration of a waveguide array antenna apparatus according to a ninth embodiment of the present invention. Because the dielectric material 40 is inserted into the antenna internal part of the waveguide array antenna apparatuses according to the fifth to eighth embodiments, a dielectric substrate 41 as provided with the ground conductor 11 and the ceiling conductor 15 (made of a conductive foil) as pattern conductors formed on both surfaces thereof may be formed. The embodiment shown in FIG. 49 is characterized in that a plurality of through-hole conductors 42c spaced at predetermined intervals and formed in parallel to each other (in the vertical direction and thickness direction) are provided in place of the side conductors 16a1 and 16a2 to 16d1 and 16d2 and the terminating conductors 14a to 14d shown in FIG. 45, and has the same advantageous effect as that of the waveguide array antenna apparatus shown in FIG. 45. The antenna elements 13a to 13d are also formed by the through-hole conductors. The through-hole conductors 42c are made by forming through holes 42 penetrating through a dielectric substrate as provided with the ground conductor 11 formed on the bottom surface thereof and the ceiling conductors 15a to 15d on the top surface thereof in the thickness direction thereof, and filling the through holes 42 with metal conductors. The manufacturing method employed in the present embodiment can use a publicly known conductor pattern forming method such as etching work. Therefore, the ceiling conductors 15a to 15d and the through-hole conductors 42c can be precisely formed, and then, the waveguide array antenna apparatus with the filled dielectric material 40 can be manufactured with an improved precision. This leads to a mass production and further to a resulting cost reduction.

Next, an example of a manufacturing procedure of the waveguide array antenna apparatus shown in FIG. 49 is described. The dielectric substrate as provided with the layers of the conductor patterns formed on the top and bottom surfaces thereof is cut so as to have the same size as that of the ground conductor 11. Then, the conductor pattern on the top surface is scraped by means of, for example, the etching or mechanical work so that the ceiling conductors 15a to 15d of the conductor patterns are formed. Next, the through holes are formed in the dielectric substrate so as to penetrate therethrough in the thickness direction, and the formed through holes are filled with the metal conductors. As a result, the side conductors 16a1 and 16a2 to 16d1 and 16d2, the terminating conductors 14a to 14d and the antenna elements 13 including a plurality of through-hole conductors 32 are formed. The surface on which the ceiling conductors 15a to 15d are formed is referred to as a top surface of the dielectric substrate hereinafter. The conductor pattern on the other surface of the dielectric substrate constitutes the ground conductor 11. In the ground conductor 11, appropriate circular holes are formed at the positions of the through holes constituting the antenna elements 13a to 13d so as to form the feeding points 12a to 12d. Then, the waveguide array antenna apparatus according to the present embodiment can be manufactured. In the case of the waveguide array antenna apparatus of type integrally incorporated in the housing shown in FIG. 47, the components such as the partitioning-wall conductors 31a to 31d can be formed in a manner similar to that of above. In the case of the configurations shown in FIGS. 46 and 48, the slots 30a to 30d can be formed in the similar manner on the dielectric substrate as provided with the conductor patterns formed on the surfaces thereof by scraping the conductor pattern by means of the etching or mechanical work.

According to the waveguide array antenna apparatuses of the fifth to ninth embodiments, the antenna apparatus can be realized having a simplified structure, having reduced size and thickness, and having a higher formation precision, having an antenna characteristic with less deterioration, and having a stronger directivity in one direction.

In addition, in the examples shown in the fifth to ninth embodiments and implemental examples thereof, each waveguide array antenna apparatus described therein is symmetrical relative to the Z-X plane. As an effective result obtained therefrom, the directivity characteristic of the radio wave radiated from the waveguide array antenna apparatus is symmetrical to the Z-X plane.

In the fifth to ninth embodiments, each waveguide array antenna apparatus described therein is symmetrical relative to the Z-X plane. However, the present invention is not limited thereto. For example, the antenna apparatus may be symmetrical relative to only the Z-Y plane or asymmetrical relative to the Z-Y plane, Z-X plane in order to obtain the desired radiation directivity characteristic or the desired input impedance characteristic. Accordingly, the antenna apparatus can be realized having the radiation directivity characteristic that is the most suitable for the radiation space.

In the fifth to ninth embodiments, the waveguide array antenna apparatus in which the antenna internal part surround by the conductors is entirely filled with the dielectric material 40 is described. However, the present invention is not limited thereto. It is possible that at least one part of the antenna internal part is filled with the dielectric material 40. For example, only a space surrounded by the ceiling conductors 15a to 15d, the terminating conductors 14a to 14d and the ground conductors 11 may be formed using the dielectric substrate.

### Tenth Embodiment

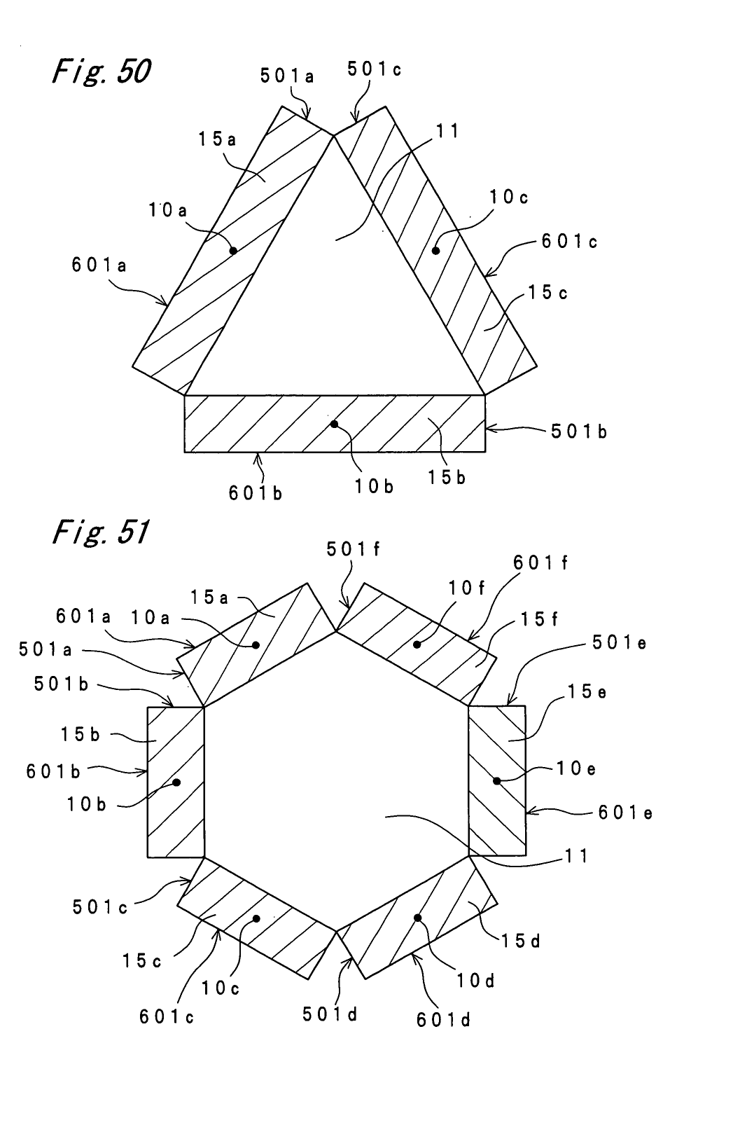

FIG. 50 is a top view showing a configuration of a waveguide array antenna apparatus according to a tenth embodiment of the present invention. The waveguide array antenna apparatus according to the present embodiment is not limited to the antenna apparatuses in which the ground conductor 11 has the bottom surface of the rectangular or square shape or the shape formed from a combination of those shapes similar to those of the above-mentioned embodiments. For example, in order to obtain the desired radiation directivity characteristic or the desired input impedance characteristic, the ground conductor 11 may have any other polygonal shape, or the shape formed from a combination of the semi circles, or any other shape. As an example of the modification, the waveguide array antenna apparatus in which the open ends of three rectangular waveguides 501a to 501c respectively including the antenna elements 13a to 13c have an equilateral triangular shape when seen from upward is provided in the present embodiment. The rectangular waveguide 501a including the antenna element 13a constitutes the waveguide antenna unit 601a, the rectangular waveguide 501b including the antenna element 13b constitutes the waveguide antenna unit 601b, and the rectangular waveguide 501c including the antenna element 13c constitutes the waveguide antenna unit 601c.

Referring to FIG. 50, the antenna elements 13a to 13c (not shown) vertically extend downward from the connecting points 10a to 10c. Three rectangular waveguides 501a to 501c respectively including the antenna elements 13a to 13c are constituted in a manner similar to those of the waveguide antenna units 501a to 501d shown in FIG. 2. The ends of two side conductors adjacent to each other of the side conductors constituting the rectangular waveguides 501a and 501b are connected to each other at the open ends of the rectangular waveguides 501a and 501b including the antenna elements 13a and 13b. The ends of two side conductors adjacent to each other of the side conductors constituting the rectangular waveguides 501b and 501c are connected to each other at the open ends of the rectangular waveguides 501b and 501c including the antenna elements 13b and 13c. The ends of two side conductors adjacent to each other of the side conductors constituting the rectangular waveguides 501c and 501a are connected to each other at the open ends of the rectangular waveguides 501c and 501a including the antenna elements 13c and 13a. Therefore, three rectangular waveguides 501a to 501c are provided in such manner that the open ends thereof are directed inward and the terminating conductors are directed outward so that the respective open ends are arranged on the corresponding sides of the equilateral triangle. When the waveguide array antenna apparatus is thus manufactured, the antenna apparatus can be realized having a desired radiation directivity characteristic and having a structure simplified as compared with the waveguide array antenna apparatus according to the first embodiment.

### Eleventh Embodiment

FIG. 51 is a top view showing a configuration of a waveguide array antenna apparatus according to an eleventh embodiment of the present invention. In the present embodiment, in a manner similar to that of the modified example of the tenth embodiment, the waveguide array antenna apparatus is provided in which open ends of six waveguide antenna units 601a, 601b, 601c, 601d, 601e and 601f respectively including antenna elements 13a, 13b, 13c 13d, 13e and 13f are arranged in an equilateral hexagonal shape when seen from upward. When the waveguide array antenna apparatus is thus manufactured, the antenna apparatus can be realized having a desired radiation directivity characteristic.

In the waveguide array antenna apparatuses according to the tenth and eleventh embodiments, the dielectric material 40 may be embedded in the antenna internal part in a manner similar to those of the fifth to ninth embodiments.

In the fifth to eleventh embodiments, the matching conductors 19a, 19a-1 and 19a-2 shown in FIGS. 15 to 17 may be provided in a manner similar to those of the first to fourth embodiments. Further, the directivity characteristic controlling conductors 20a and 20a-1 shown in FIGS. 18 and 19 may be provided in a manner similar to those of the first to fourth embodiments. In that case, the matching conductors 19a, 19a-1 and 19a-2 or the directivity characteristic controlling conductors 20a and 20a-1 may be formed by the through-hole conductors of the dielectric substrate or the patterns of the conductor patterns.

The modified examples described in the first to fourth embodiments can be applied to any one of the waveguide array antenna apparatuses according to the fifth to eleventh embodiments.

A plurality of waveguide array antenna apparatuses according to the fifth to eleventh embodiments may be arranged in a shape of array so as to constitute the phased array antenna and the adaptive antenna array. Accordingly, the directivity characteristic of the radiated radio wave can be further controlled.

In the respective embodiments and modified examples thereof, one each of the matching conductors 19a, 19a-1 and 19a-2 is provided. However, the respective embodiments of the present invention are not limited thereto. A plurality of matching conductors 19a, 19a-1 and 19a-2 may be provided. Further, in the respective embodiments and modified examples thereof, one each of the directivity characteristic controlling conductors 20a and 20a-1 is provided. However, the present invention is not limited thereto. A plurality of directivity characteristic controlling conductors 20a and 20a-1 may be provided.

As described above, according to the waveguide array antenna apparatus of the present embodiment, the antenna apparatus can be realized having a reduced thickness and having a directivity intensified in the desired direction through the selective operation of the plurality of waveguide antenna units 601a to 601f having the directivity intensified in one direction. Alternatively, the antenna apparatus can be realized having a directivity intensified in the desired direction through control and combination of a plurality of radio signals in place of the selective changeover.

### Twelfth Embodiment

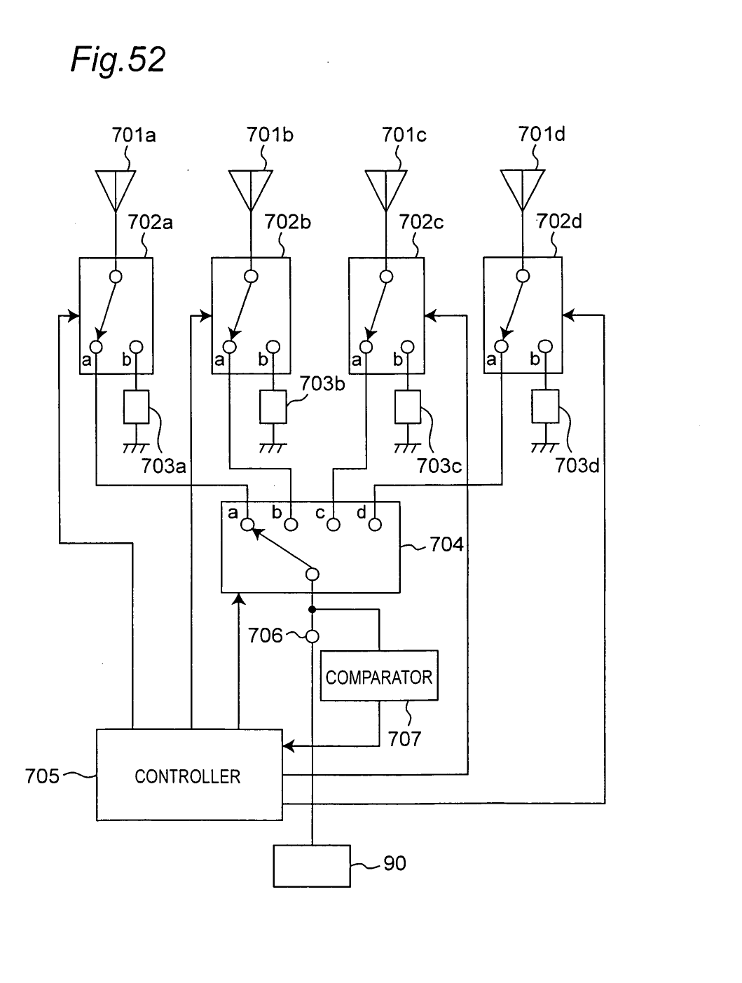

FIG. 52 is a block diagram showing a configuration of a sector pattern antenna apparatus according to a twelfth embodiment of the present invention.

Referring to FIG. 52, the sector pattern antenna apparatus includes four antenna units 701a, 701b, 701c and 701d (in the present embodiment, one antenna unit constitutes an antenna element apparatus) respectively having main beam direction sector patterns different to each other (or preferably orthogonal to each other) and arranged adjacent to each other. The antenna unit 701a is connected to the radio communication apparatus circuit 90 including the radio receiver circuit and the radio transmitter circuit via a contact “a” of a switch 702a, a contact “a” of a switch 704 and an output terminal 706 and also connected to a comparator 707. A contact “b” of the switch 702a is grounded via a load impedance element 703a. The antenna unit 701b is connected to the radio communication apparatus circuit 90 via a contact “a” of a switch 702b, a contact “b” of the switch 704 and the output terminal 706 and also connected to the comparator 707. A contact “b” of the switch 702b is grounded via a load impedance element 703b. The antenna unit 701c is connected to the radio communication apparatus circuit 90 via a contact “a” of a switch 702c, a contact “c” of the switch 704 and the output terminal 706 and also connected to the comparator 707. A contact “b” of the switch 702c is grounded via a load impedance element 703c. The antenna unit 701d is connected to the radio communication apparatus circuit 90 via a contact “a” of a switch 702d, a contact “d” of the switch 704 and the output terminal 706 and also connected to the comparator 707. A contact “b” of the switch 702d is grounded via a load impedance element 703d.

A controller 705 sequentially switches over the switch 704 in an order of the contact “a”, contact “b”, contact “c”, and contact “d”. In this case, the controller 705 controls the switches 702a, 702b, 702c and 702d so that they are switched over as follows.

(1) When the switch 704 is switched over to the contact “a” side thereof, the switch 702a is switched over to the contact “a” side thereof, while the other switches 702b, 702c and 702d are switched over to the contact “b” side thereof. This leads to that a radio signal received by the antenna unit 701a is outputted to the radio communication apparatus circuit 90 via the contact “a” of the switch 702a, the contact “a” of the switch 704 and the output terminal 706, and also outputted to the comparator 707. The other antenna units 701b, 701c and 701d are respectively grounded via the load impedance elements 703b, 703c and 703d.

(2) When the switch 704 is switched over to the contact “b” side thereof, the switch 702b is switched over to the contact “a” side thereof, while the other switches 702a, 702c and 702d are switched over to the contact “b” side thereof. This leads to that a radio signal received by the antenna unit 701b is outputted to the radio communication apparatus circuit 90 via the contact “a” of the switch 702b, and the contact “b” of the switch 704 and the output terminal 706, and also outputted to the comparator 707. The other antenna units 701a, 701c and 701d are respectively grounded via the load impedance elements 703a, 703c and 703d.

(3) When the switch 704 is switched over to the contact “c” side thereof, the switch 702c is switched over to the contact “a” side thereof, while the other switches 702a, 702b and 702d are switched over to the contact “b” side thereof. This leads to that a radio signal received by the antenna unit 701c is outputted to the radio communication apparatus circuit 90 via the contact “a” of the switch 702c, the contact “c” of the switch 704 and the output terminal 706, and also outputted to the comparator 707. The other antenna units 701a, 701b and 701d are respectively grounded via the load impedance elements 703a, 703b and 703d.

(4) When the switch 704 is switched over to the contact “d” side thereof, the switch 702d is switched over to the contact “a” side thereof, while the other switches 702a, 702b and 702c are switched over to the contact “b” side thereof. This leads to that a radio signal received by the antenna unit 701d is outputted to the radio communication apparatus circuit 90 via the contact “a” of the switch 702d, the contact “d” of the switch 704 and the output terminal 706, and also outputted to the comparator 707. The other antenna units 701a, 701b and 701c are respectively grounded via the load impedance elements 703a, 703b and 703c.

When the switch 704 is sequentially switched over as described above, the comparator 707 temporarily stores signal levels (or power levels) of the radio signals respectively received by the antenna units 701a, 701b, 701c and 701d in a memory of the comparator 707, compares the respective signals levels of the radio signals with each other, and outputs information relating to the antenna unit that receives a radio signal having the largest signal level to the controller 705. In response to this, the controller 705 controls the switches 702a, 702b, 702c, 702d and 704 so that the antenna unit which receives a radio signal having the largest signal level is connected to the output terminal 706. As described above, when one of the switches 702a, 702b, 702c and 702d is connected to the contact “a” side thereof as described above, the other switches are connected to the contact “b” side thereof. The processing of the controller 705 may be executed prior to the intended communication or executed during the communication process.

In the sector pattern antenna apparatus according to the present embodiment, a space is divided on the horizontal or vertical plane, and combinations of antenna units covering the respective divided spaces are provided. The division of the space enables the direction of the radiated radio wave to be narrowed down, which realizes a further intensified directivity and a higher sensitivity. Therefore, in the sector pattern antenna apparatus, it is preferable that the antenna units of the same number as that of the sector patterns are necessarily provided and only the antenna unit that receives the radio signal of the largest signal level be connected to the output terminal 706 to be operated. The load impedance elements are connected to the other antenna units that are not connected to the output terminal 706. As a result, the sensitivity or the radiation gain of the antenna apparatus can be improved because the radiation characteristic is prevented from deteriorating due to the isolation among the antenna units and elements values of the load impedance elements are appropriately selected.

The sector pattern antenna apparatus according to the present embodiment shown in FIG. 52 is provided with four antenna units 701a, 701b, 701c and 701d. However, the present invention is not limited thereto. The sector pattern antenna apparatus may be provided with two or more antenna units. The plurality of antenna units preferably has the main beam direction sector patterns different to each other, and more preferably, has the main beam direction sector patterns orthogonal to each other.

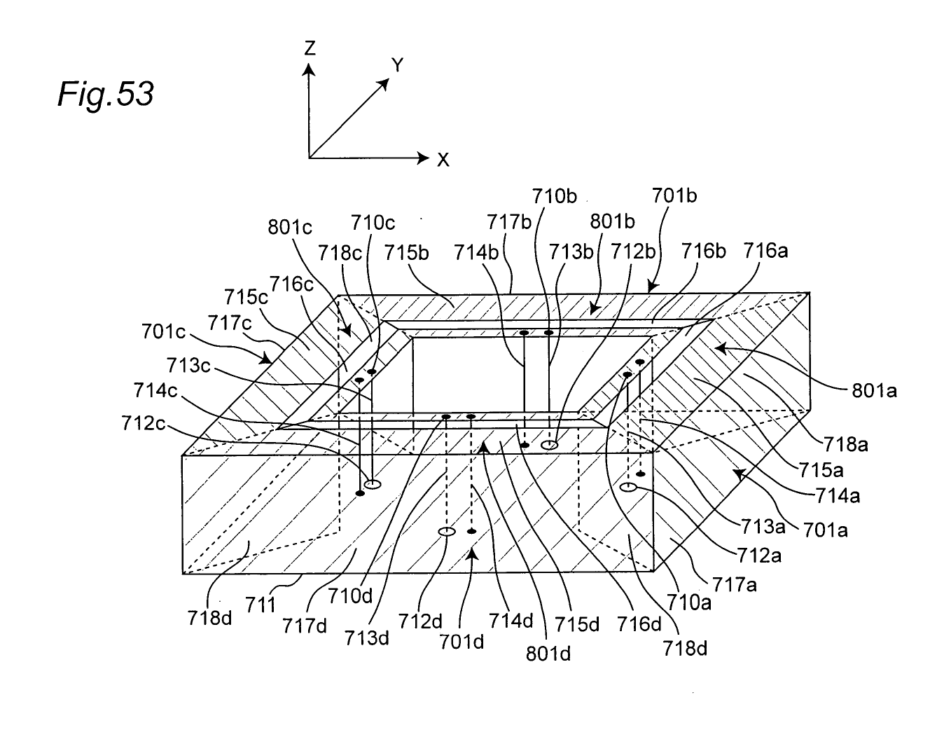

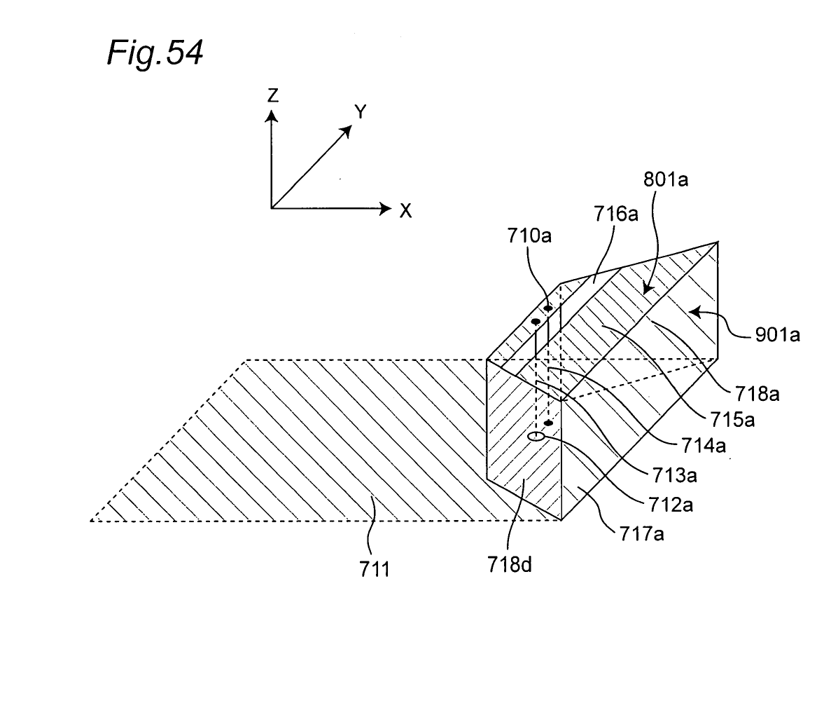

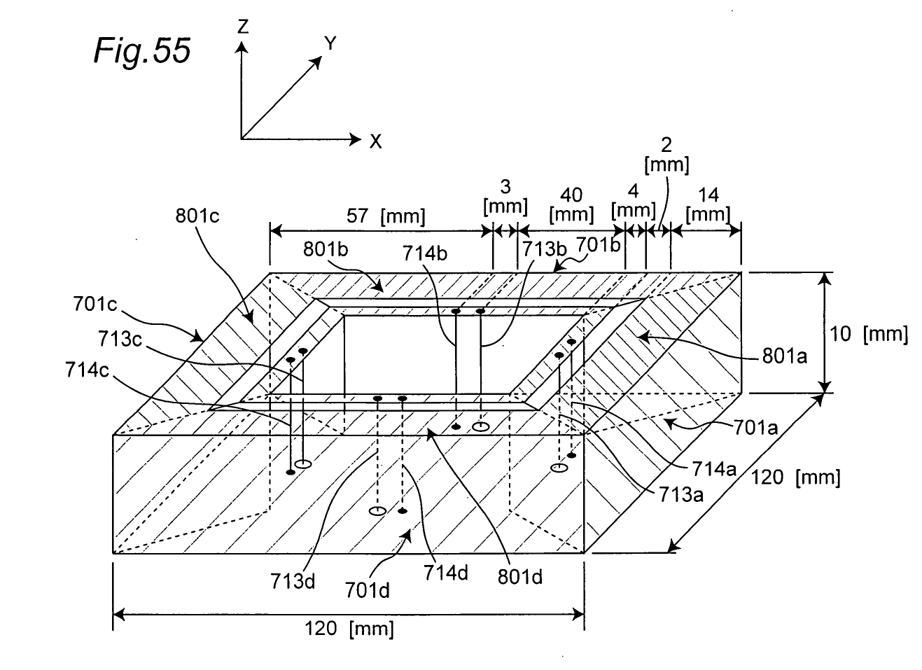

FIG. 53 is a perspective view showing an external appearance of a specific example of a configuration of the sector pattern antenna apparatus shown in FIG. 52. FIG. 54 is a perspective view showing an external appearance of one part of the sector pattern antenna apparatus shown in FIG. 53. FIG. 55 is a perspective view showing a design example of a test model of the sector pattern antenna apparatus shown in FIG. 53.

In the examples of the configurations shown in FIGS. 53 to 55, the sector pattern antenna apparatus is shown capable of transmission and reception in which the horizontal plane is divided into four sector patterns by four antenna units 701a, 701b, 701c and 701d is shown. In the sector pattern antenna apparatus, one antenna unit covers a 90-degree area on the horizontal plane. More concretely, the antenna unit 701a has the sector pattern having the main beam direction in the −X axis direction, the antenna unit 701b has the sector pattern having the main beam direction in the −Y axis direction, the antenna unit 701c has the sector pattern having the main beam direction in the X axis direction, and the antenna unit 701d has the sector pattern having the main beam direction in the Y axis direction. Therefore, four antenna units 701a, 701b, 701c and 701d respectively have the sector patterns having the main beam directions orthogonal to each other.

The sector pattern antenna apparatus shown in FIG. 53 constitutes a so-called “waveguide array antenna apparatus of type integrally incorporated in the housing” described below. Referring to FIG. 53, four antenna units 701a, 701b, 701c and 701d are respectively provided on a square (although most desirably square, it may be also rectangular) ground conductor 711 arranged on the X-Y plane, and includes rectangular waveguides 803a, 803b, 803c and 803d, and antenna elements 713a to 713d, and then, those constitute so-called “waveguide antenna units”. The rectangular waveguides 803a to 803d include the ground conductor 711, ceiling conductors 715a to 715d facing the ground conductor 711, and partitioning-wall conductors 718a to 718d for connecting the ground conductor 711 with the ceiling conductors 715a to 715d, and are arranged adjacent to each other so that the partitioning-wall conductors are shared between two rectangular waveguides (803a and 803b), (803b and 803c), (803c and 803d) and (803d and 803a) respectively adjacent to each other (for example, the partitioning-wall conductor 718a is shared between the rectangular waveguide 803a including the ceiling conductor 715a and the rectangular waveguide 803d including the ceiling conductor 715d).

The respective rectangular waveguides 803a to 803d have one ends short-circuited by terminating conductors 717a to 717d and open ends. The ends of the respective rectangular waveguides 803a to 803d short-circuited by the terminating conductors 717a to 717d are provided so as to position on sides of the square ground conductor 711, while the open ends thereof are provided so as to position on sides of a smaller square (not shown) on diagonal lines of the square ground conductor 711. The respective rectangular waveguides 803a to 803d extend outward from the sides of the smaller square on the ground conductor 711. One ends of the antenna elements 713a to 713d are electrically connected to the ceiling conductors 715a to 715d in vicinity of the open ends of the respective rectangular waveguides 803a to 803d, while another ends thereof are electrically connected to feeding points 712a to 712d arranged on the ground conductor 711. The respective antenna units 701a to 701d transmit and receive the radio signal via a predetermined radiation directivity characteristic at the open ends of the respective rectangular waveguides 803a to 803d constituting the antenna units 701a to 701d. The respective rectangular waveguides 803a to 803d are provided on the ground conductor 711 in directions different from each other. Therefore, the main beams of the radiation directivity characteristics of four antenna units 701a to 701d are differently directed, and the directivity characteristic of the antenna apparatus can be changed by selectively changing the antenna element that transmits and receives the radio signal.

In addition, referring to FIG. 53, the rectangular terminating conductors 717a to 717d having sides of the same length as that of the ground conductor 717 and vertical sides of a predetermined length (height) are provided vertically to the X-Y plane on four sides of the square ground conductor 717. The rectangular partitioning-wall conductors 718a to 718d having sides of the same length as the height of the terminating conductors 717a to 717d and sides of a predetermined length are provided on the diagonal lines of the ground conductor 11 in the vertical direction relative to the X-Y plane with their peaks corresponding to peaks of the ground conductor 711. The trapezoidal ceiling conductors 715a to 715d are provided on the terminating conductors 717a to 717d and the partitioning-wall conductors 718a to 718d facing the ground conductor 711. The top end of the partitioning-wall conductor 718a is connected to the slant sides of the trapezoidal ceiling conductors 715a and 715d, the bottom end thereof is connected to the ground conductor 711, and the right and left ends thereof are connected to the terminating conductors 717a and 717d.

In this case, the ceiling conductor 715a is provided on the terminating conductor 717a and the partitioning-wall conductors 718a and 718b. More concretely, the ground conductor 711 as the bottom surface, the trapezoidal ceiling conductor 715a arranged on the top surface of the waveguide array antenna apparatus facing the ground conductor 711, and the partitioning-wall conductors 718a and 718b that combine the ground conductor 711 and the ceiling conductor 715a on two slant sides of the trapezoid of the ceiling conductor 715a form the rectangular waveguide 803a having the tapered shape in which the rectangular sectional surface is reduced toward one end. The end of the rectangular waveguide 803a on the wider-section side is sealed by the rectangular terminating conductor 717a so as to be short-circuited, while the end the rectangular waveguide 803a on the narrower-section side is left open (the end is hereinafter referred to as an open end). The ground conductor 711, the partitioning-wall conductors 718a and 718b, the ceiling conductor 715a and the terminating conductor 717a are mechanically and electrically connected to each other, and then, those constitute the rectangular waveguide 803a that transmits a radio signal in the direction in parallel to the X axis direction and has its end in the −X axis direction closed. A slot 716c having a longitudinal direction vertical to the direction of the radio signal transmitted by the rectangular waveguide 803a is formed by the ceiling conductor 715a in the vicinity of the open end of the rectangular 803a and the antenna element 713c.

Next, one end of the antenna element 713a made of an electrical conductor wire or line is mechanically and electrically connected to a connecting point 710a in the vicinity of the end part in the +X direction and at the center in the Y axis direction on the bottom surface of the ceiling conductor 715a by means of the soldering. The antenna element 713a vertically extends downward from the connecting point 710a, while another end of the antenna element 713a is connected to the feeding point 712a electrically insulated from the ground conductor 711, in a circular hole formed on the X axis on the ground conductor 711. The feeding point 712a is further electrically connected to, for example, a central conductor of a coaxial cable, and a ground conductor of the coaxial cable is electrically connected to the ground conductor 711. This leads to that the radio signal is fed to the feeding point 712a from the radio communication apparatus circuit 90 via the coaxial cable. The rectangular waveguide 803a and the antenna element 813a constitute a waveguide antenna unit 903a.

In addition, the ceiling conductor 715b includes a slot 716b and is provided on the terminating conductor 717b and the partitioning-wall conductors 718b and 718c. The ceiling conductor 715c includes the slot 716c and is provided on the terminating conductor 717c and the partitioning-wall conductors 718c and 718d. The ceiling conductor 715d includes the slot 716c and is provided on the terminating conductor 717d and the partitioning-wall conductors 718d and 718a. The waveguide antenna units 903b to 903d including the antenna elements antenna elements 713b, 713c and 713d are constituted in a manner similar to that of above.

A matching conductor 714a for adjusting an input impedance of the antenna element 713a is connected to between the ceiling conductor 715c and the ground conductor 711 in the vicinity of and in parallel to the antenna element 713a. A matching conductor 714b for adjusting an input impedance of the antenna element 713b is connected to between the ceiling conductor 715b and the ground conductor 711 in the vicinity of and in parallel to the antenna element 713b. A matching conductor 714c for adjusting an input impedance of the antenna element 713c is connected to between the ceiling conductor 715c and the ground conductor 711 in the vicinity of and in parallel to the antenna element 713c. A matching conductor 714d for adjusting an input impedance of the antenna element 713d is connected to between the ceiling conductor 715d and the ground conductor 711 in the vicinity of and in parallel to the antenna element 713d. In the above-mentioned configuration, one matching conductor is provided for each antenna unit. However, a plurality of matching conductors may be respectively provided.

According to the example of the configuration shown in FIG. 53, the side conductors of the respective two rectangular waveguides adjacent to each other are integrated as the partitioning-wall conductors 731a to 731d, and this leads to simplification of the structure of the antenna apparatus. In order to further simplify the structure of the antenna apparatus, the ceiling conductors 715a to 715d may be made of a singular integrated conductor plate.

According to the example of the configuration show in FIG. 53, the slots 716a to 716d are formed in order to make coherent the phases of the radio waves radiated from the respective antenna units 701a to 701d. However, the present invention is not limited thereto. The formation of the slots 716a to 716d may be omitted.

The space surrounded by the housing formed by the ceiling conductors 715a to 715d, the terminating conductors 717a to 717d and the ground conductor 711 is called an antenna internal part. A space on the opposite side of the antenna internal part relative to the ceiling conductors 715a to 715d, the terminating conductors 717a to 717d or the ground conductor 711 is called an antenna external part. At least one part of the antenna internal part may be filled with a predetermined dielectric material, in which case the antenna apparatus can be downsized.

In the example of the configuration shown in FIG. 53, the ground conductor 711, the terminating conductors 717a to 717d and the ceiling conductors 715a to 715d are electrically connected, the respective feeding points 712a to 712d are arranged on the X axis or Y axis, and the antenna elements 712a to 712d are each made of an electrical conductor line or wire vertical relative to the X-Y plane as an example.

In the antenna apparatus constituted as above, when the radio signal is fed to the antenna element 713a as shown in FIG. 54, for example, the directivity intensified in the +Z axis direction and +X axis direction is obtained. Therefore, referring to FIG. 53, when the radio signal is fed to the antenna element 713b, the intensified radio wave is radiated in the +Y axis direction, when the radio signal is fed to the antenna element 713c, the intensified radio wave is radiated in the −X axis direction. When the radio signal is fed to the antenna element 713d, the intensified radio wave is radiated in the −Y axis direction. The short-circuit conductors 717a to 717d perform impedance-matching with the antenna elements 713a to 713d and the feeding points 712a to 712d so as to efficiently transmit the energy of radio signal, and thus, may not be necessarily provided depending on the dimension and shape of the antenna apparatus.

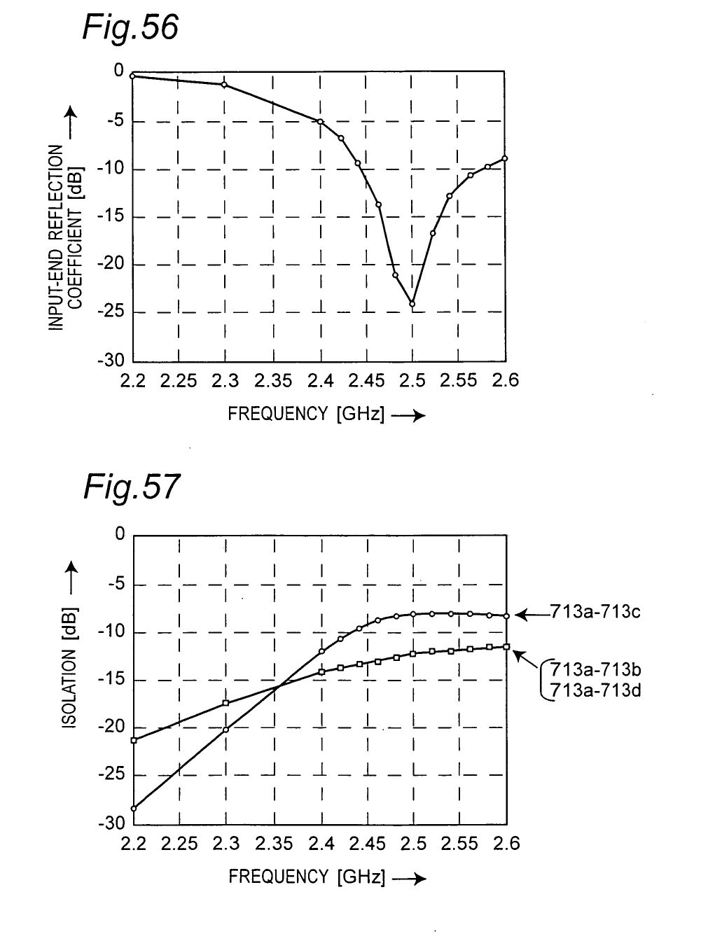

FIGS. 56 and 57 are graphs of measurement results of the sector pattern antenna apparatus shown in FIG. 55 as the test example at a frequency of 2.5 GHz, where a frequency characteristic of an input-end reflection coefficient of the sector pattern antenna apparatus of FIG. 55 is shown in FIG. 56, and a frequency characteristic of the isolation of the sector pattern antenna apparatus of FIG. 55 is shown in FIG. 57. FIG. 56 shows an example of examination results of the antenna element 713a. The respective impedances at the feeding points 712b to 712d of the other antenna elements 713b to 713d are adjusted by the load impedance elements 703b to 703d. As is apparent from FIG. 56, the very small input-end reflection coefficient of −24 dB is obtained at a frequency of 2.5 GHz of the antenna apparatus as the test example, showing that the radio wave is efficiently radiated.

In addition, FIG. 57 shows a frequency characteristic of isolations between the antenna element 713a and the other antenna elements 713b to 713d. As is apparent from FIG. 57, the isolation between the antenna element 713a and the antenna element 713b and the isolation between the antenna element 713a and the antenna element 713d are equal to each other because of the symmetry of the sector pattern antenna apparatus. Further, at a frequency of 2.5 GHz, the isolation between the antenna element 713a and the antenna element 713c is 8 dB, and the isolation between the antenna element 713a and the antenna element 713b and the isolation between the antenna element 713a and the antenna element 713d are equally 12 dB. It is understood therefrom that the isolation of a pair of antenna elements 713a and 713c facing each other shows the worst result. In other words, when the antenna element 713a is operated, it is most affected by the antenna element 713c.

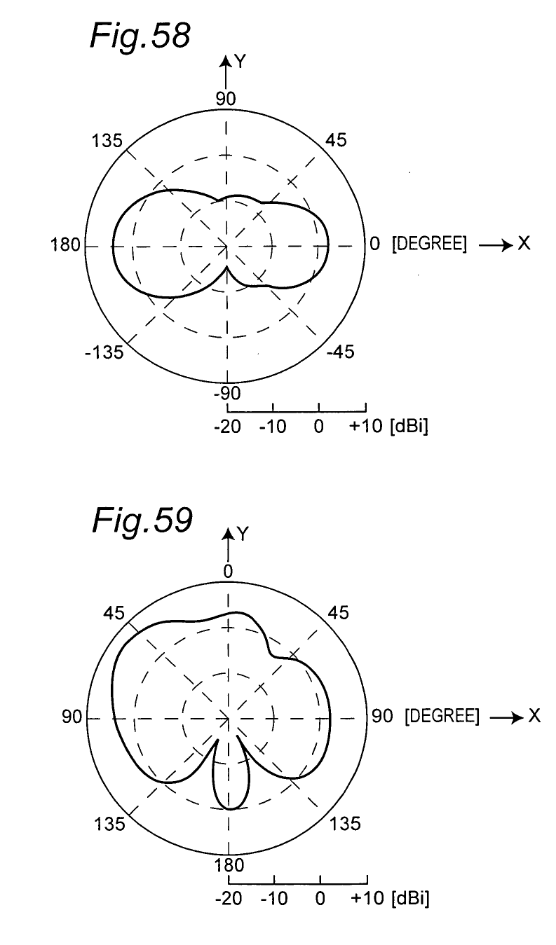

FIGS. 58 and 59 are graphs of measurement results of the sector pattern antenna apparatus shown in FIG. 55 at a frequency of 2.5 GHz, where a radiation characteristic on the horizontal plane of the sector pattern antenna apparatus of FIG. 55 is shown in FIG. 58, and a radiation characteristic on the vertical plane of the sector pattern antenna apparatus of FIG. 55 is shown in FIG. 59. FIGS. 58 and 59 show examples of measurement results of the antenna element 713a. The respective impedances of the feeding points 712b to 712d of the other antenna elements 713b to 713d are adjusted by the load impedance elements 703b to 703d.

As shown in FIG. 58, the directivity intensified in the −X axis direction is confirmed. The maximum radiation gain is 7.1 dBi, and 4.1 dBi in the −X axis direction and 2.7 dBi in the +X axis direction are obtained as the gains on the horizontal plane. Between radio communication apparatuses during the communication, a distance between the radio communication apparatuses is generally larger than a difference between heights at which the radio communication apparatuses are respectively arranged. Therefore, an area to be covered can be increased when the antenna unit having a large gain in the direction of the horizontal plane and low elevation angle is used. The present antenna apparatus obtains the relatively large gain of 4.1 dBi in the −X axis direction, and obtains the radiation intensified by 1.9 dB as compared with the gain 2.2 dBi of a dipole antenna as one of basic antennas that strongly radiate the radio wave onto the horizontal plane. However, the relatively large gain of 2.7 dBi is obtained in the reverse direction. Therefore, an unnecessary interference wave is possibly received from behind in the case of the reception, and a unnecessary radiation toward behind is a possible problem caused in the case of the transmission. In order to deal with the disadvantage, it is important not only to improve the gain on the horizontal plane but also to obtain a large difference relative to a gain in any direction other than the direction to be covered by the antenna. The gain difference on the horizontal plane is 1.4 dB in the case of the present antenna apparatus.

In the case of constituting the sector pattern antenna apparatus shown in FIG. 52 using the antenna apparatus shown in FIG. 53, a variation of the radiation characteristic of the antenna apparatus constituting the sector patterns when the load impedance elements 703a to 703d shown in FIG. 52 are changed is examined. In this case, the radiation gain when the radio signal is fed to the antenna element 713a of FIG. 53 is examined. The load impedance elements 703b to 703d are connected to the antenna elements 713b to 713d of FIG. 53. The impedance values of the load impedance elements 703a to 703d are represented using Za to Zd by the following equation:
Zi=Ri+j Xi [Ω](i=a, b, c, d),
where j is an imaginary unit.

### First Implemental Example of Twelfth Embodiment

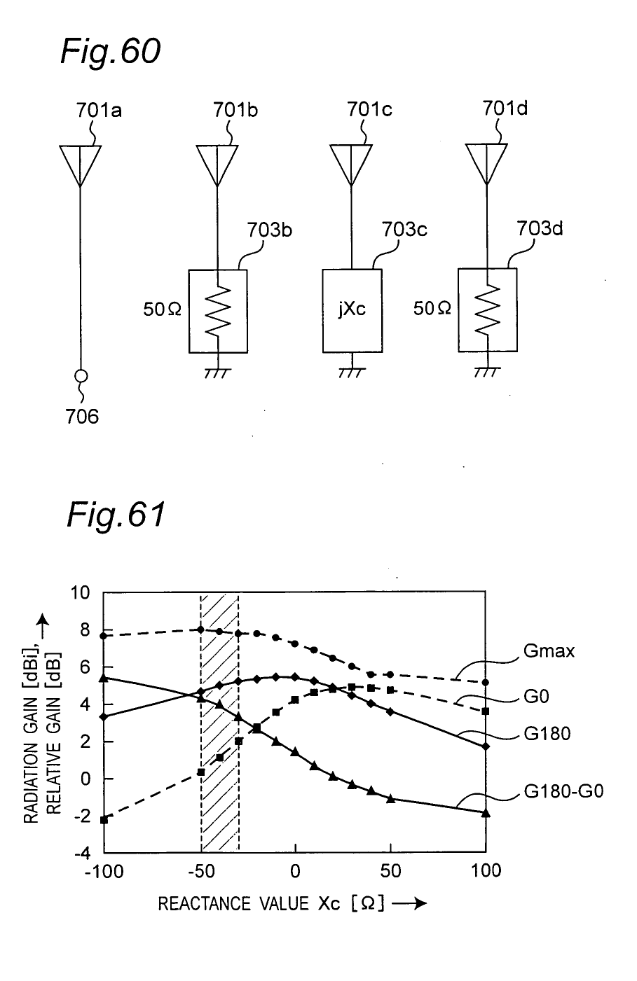

FIG. 60 is a block diagram showing a configuration of a sector pattern antenna apparatus according to a first implemental example of the twelfth embodiment of the present invention.

As shown in FIG. 60, an examination is carried out in the case of changing only the load impedance element 703c (having the impedance value Zc) of the antenna element 713c affecting the antenna element 713a most. A resistance component Rc of the load impedance element 703c is “O” in order to avoid any loss, and only a reactance component Xc is provided for the load impedance element 703c. More concretely, the antenna units 701b and 701d are matched and terminated using the load impedance elements 703b and 703d having resistance values equal to the input impedances thereof (for example, 50 Ω).

FIG. 61 is a graph of measurement results of the sector pattern antenna apparatus shown in FIG. 60, showing a radiation gain and a relative gain with respect to the reactance value Xc of the load impedance element 703c. The impedance values Zb and Zd of the other load impedance elements 703b and 703d are 50 Ω so that no reflection is generated. A variation of the radiation gain when the radio signal is fed to the antenna element 713a is shown in FIG. 61. Referring to FIG. 61, G180 is a radiation gain [dBi] in the −X axis direction (180-degree direction) (radiation gain shown by dBi is an absolute gain based on an isotropic antenna), which is a gain in the desired direction. G0 is a gain [dBi] in the +X axis direction (0-degree direction), which is the maximum radiation gain beyond the sector pattern in the main beam direction. Gmax is the maximum radiation gain [dBi], and (G180-G0) [dB] is a relative gain which is a gain difference between the gain in the desired direction and a gain in an undesired direction.

As is apparent from FIG. 61, the radiation gain (G180-G0) and Gmax both change when the reactance value Xc of the load impedance element 703c is changed. In particular, the presence of the reactance value Xc that gives the maximum value to the radiation gain G180 and G0 is confirmed. Referring to the radiation gain G180 having the main beam of the maximum gain in the desired wave direction (0-degree direction), the maximum value of 5.4 dBi is obtained when the reactance value Xc is −20≦Xc≦0 [Ω]. Further, a high-gain directivity characteristic having a gain equal to or larger than 4.5 dBi can be obtained when the reactance value Xc is −50≦Xc≦30 [Ω]. On the contrary, the radiation gain GO is desirably smaller. For example, the range of the reactance value Xc when the gain is equal to or smaller than 2 dBi is Xc≦−30 [Ω]. The relative gain (G180-G0) representing the gain difference between the desired direction and the undesired direction is desirably large. However, it is understood that the relative gain is reduced as the reactance value Xc becomes larger. The maximum radiation gain Gmax obtains the high-gain characteristic of 7 dBi when the reactance value is Xc≧0. Although it is not shown in FIG. 61, the maximum radiation gain in the above-mentioned range is in the sector pattern of the main beam of the antenna unit 701a.

In the sector pattern antenna apparatus according to the present embodiment, the relatively large gain in the desired direction and the low-gain radiation characteristic in the undesired direction are required. Therefore, the radiation gain G180, the maximum radiation gain Gmax and the radiation gain G0 desirable in the present embodiment are set respectively to a gain equal to or larger than 4 dBi, a gain equal to or larger than 7 dBi, and a gain equal to or larger than 2 dBi. The mentioned range can be obtained when the reactance value is −50≦Xc≦−30 [Ω]. At that time, the radiation gain G180 is 4.6 to 5.2 dBi, the radiation gain G0 is 0.3 to 1.9 dBi, and the maximum radiation gain Gmax is 7.8 to 7.9 dBi.

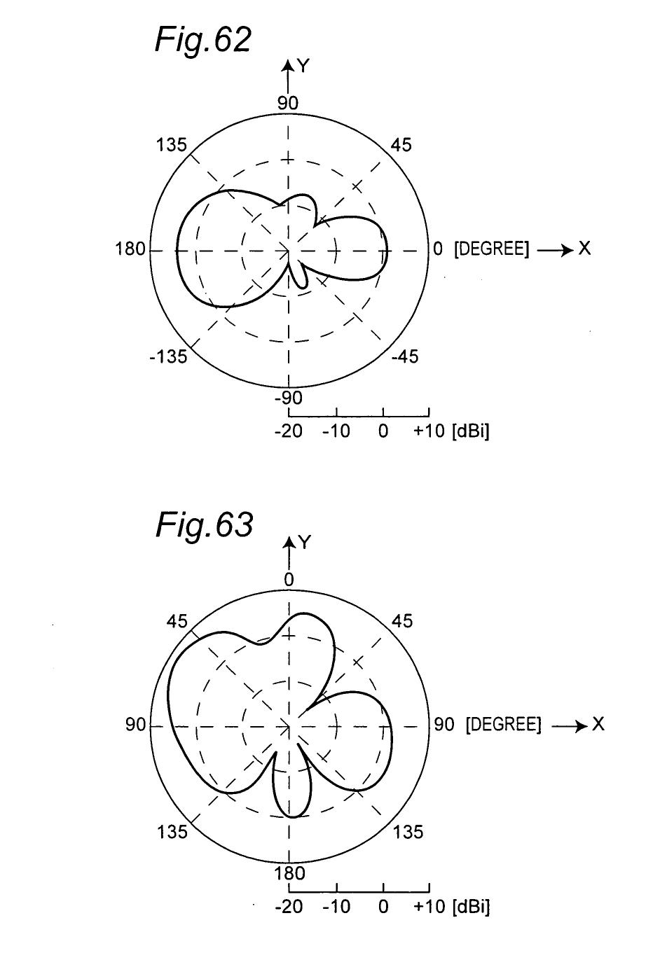

FIGS. 62 and 63 are graphs of measurement results of the sector pattern antenna apparatus shown in FIG. 60, where a radiation characteristic on the horizontal plane of the sector pattern antenna apparatus of FIG. 60 is shown in FIG. 62, and a radiation characteristic on the vertical plane of the sector pattern antenna apparatus of FIG. 60 is shown in FIG. 63. As an optimum value in the first implemental example of the twelfth embodiment of the present invention, the reactance value Xc=−40 [Ω]. FIGS. 62 and 63 show radiation patterns at that time, where the radiation gain G180 is 4.9 dBi, the radiation gain G0 is 1.1 dBi, the relative gain (G180-G0) is 3.8 dB, and the maximum radiation gain Gmax is 7.9 dBi.

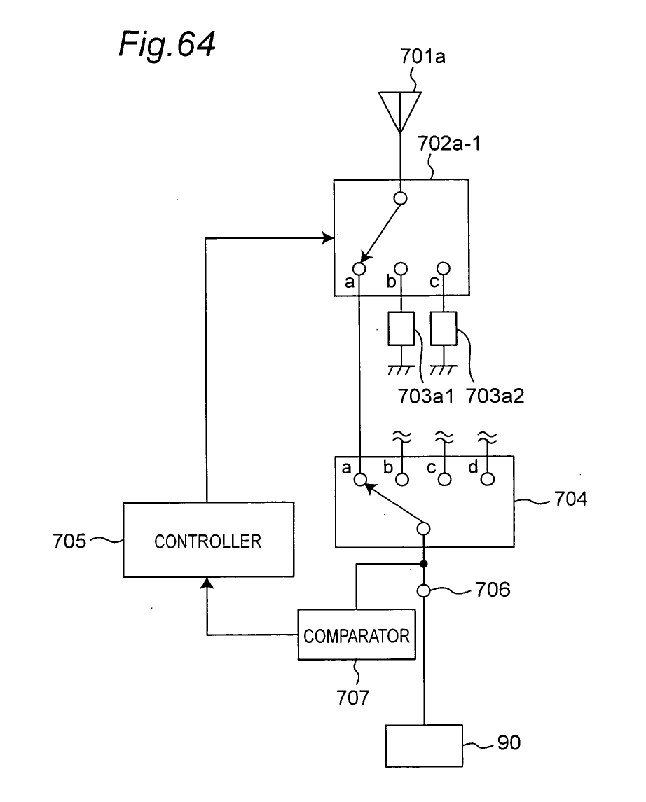

FIG. 64 is a block diagram showing an example of the configuration of a sector pattern antenna apparatus according to the first implemental example of the twelfth embodiment of the present invention. In the device configuration shown in FIG. 60, it is necessary to provide, for example, two load impedance elements to be connected to the antenna element 701a as shown in FIG. 64 in order to selectively change and set two load impedance element values for one antenna unit. In the example of the configuration shown in FIG. 64, it is necessary to provide a switch 702a-1 of 1:3 in place of the switch 702a shown in FIG. 52. A contact “a” of the switch 702a-1 is connected to the output terminal 706 via the contact “a” of the switch 704, a contact “b” of the switch 702a-1 is grounded via the load impedance element 703a1, and a contact “c” of the switch 702a-1 is grounded via the load impedance element 703a2. For example, provided that the impedance value of the load impedance element 703a1 is −j40 Ω and the impedance value of the load impedance element 703a2 is 50 Ω, the apparatus configuration shown in FIG. 60 can be realized. In the apparatus configuration shown in FIG. 64, the description is made for such a case that the radio signal is fed to the antenna element 703a, or a case of the antenna unit 701a operated. However, the device configuration of FIG. 64 is employed in the case of the other antenna units 701b to 701d.

In the case of the antenna apparatus of FIG. 53 in which the impedance value Zc of the load impedance element 703b is 50 [Ω], the maximum radiation gain Gmax is 7.1 dBi, the radiation gain G180 is 4.1 dBi, the radiation gain G0 is 2.7 dBi, and relative gain (G180-G0) is 1.4 dB as shown in FIGS. 58 and 59. Therefore, according to the device shown in FIG. 64, the maximum radiation gain Gmax is improved by 0.8 dB, the radiation gain G180 is improved by 0.7 dB, the radiation gain G0 is reduced by −1.6 dB and the relative gain (G180-G0) is improved by 2.4 dB, showing favorable results in the respective characteristics. As described above, the radiation characteristic of the sector pattern antenna apparatus can be improved in the case of providing the load impedance elements suitable for the pairs of antenna units facing each other.

### Second Implemental Example of Twelfth Embodiment

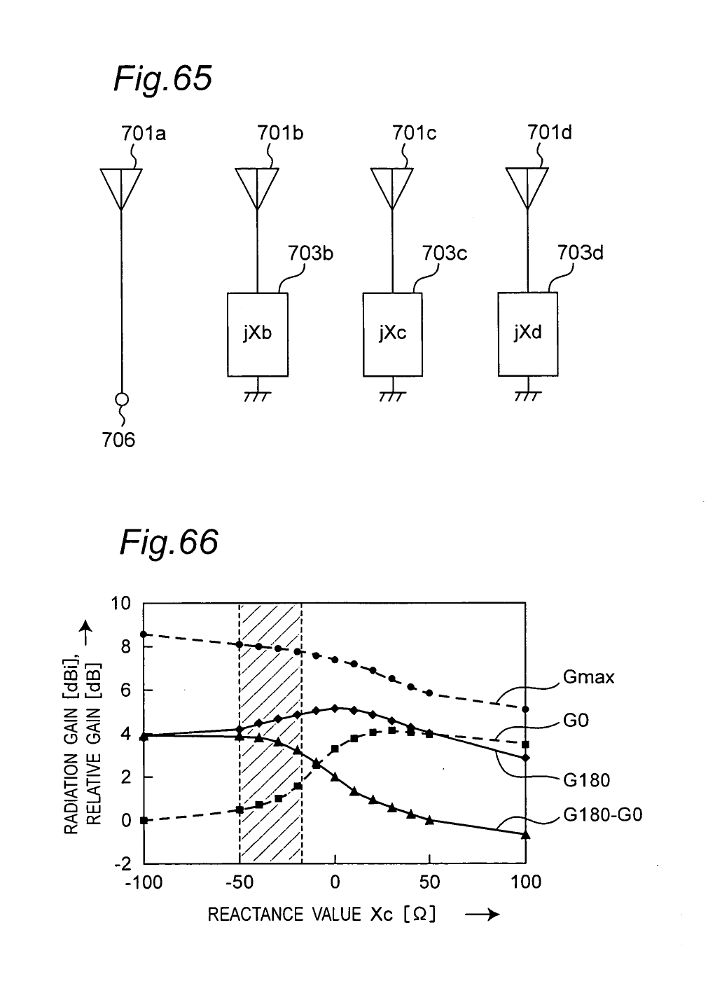

FIG. 65 is a block diagram showing an example of a configuration of a sector pattern antenna apparatus according to a second implemental example of the twelfth embodiment of the present invention.

In the second implemental example of the twelfth embodiment, a characteristic when the reactance values Xc=Xb=Xd≡X is examined as shown in FIG. 65. At that time, all of the load impedance elements 703a to 703d are equal to each other, it is unnecessary to respectively provide two load impedance elements as shown in FIG. 64, and one load impedance element is provided as shown in FIG. 52.

FIG. 66 is a graph of measurement results of the sector pattern antenna apparatus shown in FIG. 65, showing a radiation gain and a relative gain with respect to the reactance values Xb=Xc=Xd. It is clearly understood from FIG. 66 that the substantially same advantageous effect as that of the example of FIG. 61 is obtained though slightly different from that of FIG. 61 when the reactance values Xb=Xc=Xd of the load impedance elements 703b to 703d are changed. The radiation gain G180 and the radiation gain G0 are slightly reduced as compared with the example shown in FIG. 61. However, the radiation gain G0 is more largely reduced than the reduction of the radiation gain G180, and the relative gain (180-G0) is increased as compared with the example shown in FIG. 61 on the whole. The maximum radiation gain Gmax is also increased as compared with the example shown in FIG. 61.

In a manner similar to that of the example shown in FIG. 61, when the desirable values of the radiation gain G 180, maximum radiation gain Gmax and radiation gain G0 are set respectively to a gain equal to or larger than 4 dBi, a gain equal to or larger than 7 dBi, and a gain equal to or larger than 2 dBi, the above-mentioned range is obtained when the reactance value X is −50≦X≦−20 [Ω]. At that time, the radiation gain G180 is 4.2 to 4.8 dBi, the radiation gain G0 is 0.4 to 1.6 dBi, and the maximum radiation gain Gmax is 7.8 to 8.1 dBi. Therefore, an optimum value in this case is X=−40 [Ω].

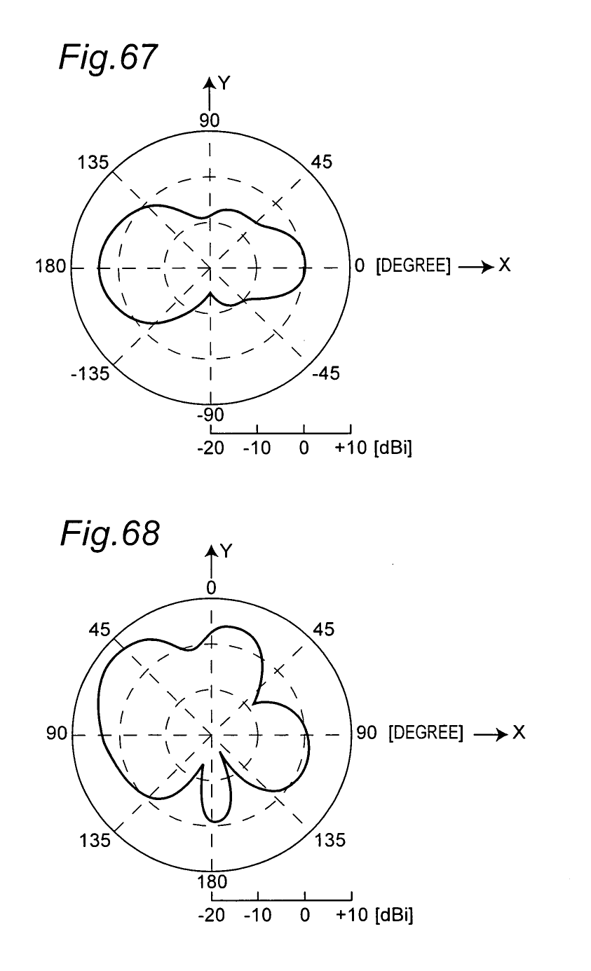

FIGS. 67 and 68 are graphs of a measurement results of the sector pattern antenna apparatus shown in FIG. 65, where a radiation characteristic on the horizontal plane of the sector pattern antenna apparatus of FIG. 65 is shown in FIG. 67, and a radiation characteristic on the vertical plane of the sector pattern antenna apparatus of FIG. 65 is shown in FIG. 68.

As is apparent from FIGS. 67 and 68, the radiation gain G180 was 4.4 dBi, the radiation gain G0 was 0.6 dBi. Therefore, the relative gain (G180-G0) was 3.8 dBi, and the maximum radiation gain Gmax was 8.0 dBi. Thus, the results similar to those of the configuration shown in FIG. 60 were obtained. The radiation gain G180 was slightly smaller than that of the first implemental example of the twelfth embodiment. However, the second implemental example of the twelfth embodiment is advantageous in that the switches 702a to 702d of one to two connection type can be used because the number of the provided load impedance elements can be reduced to one. The second implemental example is also advantageous in that there is little influence from the variability of the elements because the fluctuations of the gains relative to the impedance value X of the load impedance element are reduced as compared with the first implemental example of the twelfth embodiment.

In the examples described above, the radio signal is fed to the antenna element 713a, namely, then the antenna unit 701a is operated. The same advantageous effect can be obtained in the case of constituting the other antenna units 701b to 701d in a manner similar to that of above.

### Third Implemental Example of Twelfth Embodiment

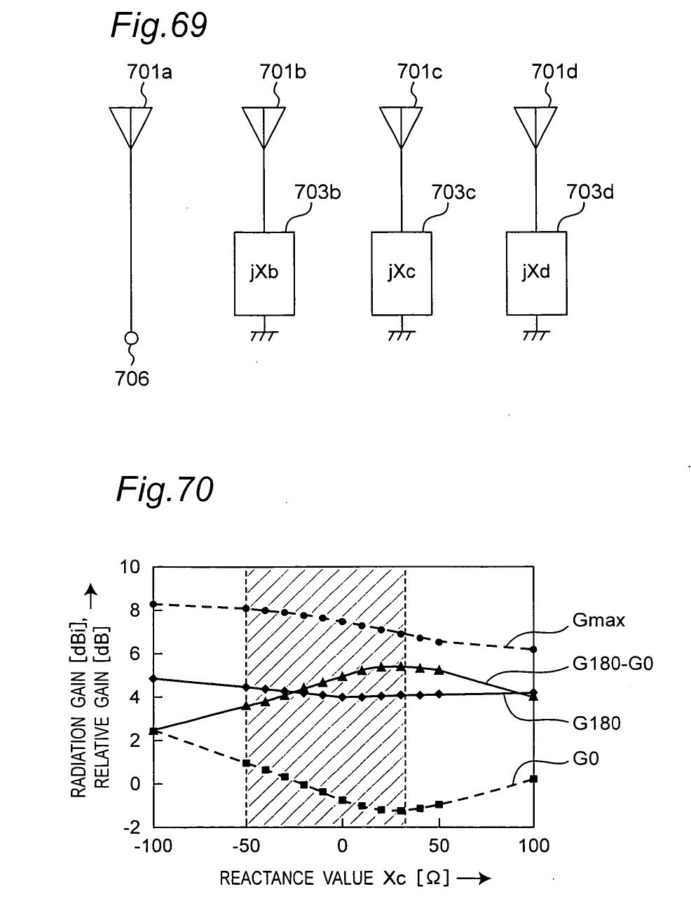

FIG. 69 is a block diagram showing an example of a configuration of a sector pattern antenna apparatus according to a third implemental example of the twelfth embodiment of the present invention.

In the third implemental example of the twelfth embodiment, as shown in FIG. 69, a characteristic in the case of changing the reactance value X provided that the reactance value Xc of the load impedance value 703c is fixed and the reactance values Xb=Xd≡X is examined. The reactance value is set as Xc=−40 [Ω]. In the present example, it is necessary to provide two load impedance elements in a manner similar to that of the example of the configuration shown in FIG. 64.

FIG. 70 is a graph of measurement results of the sector pattern antenna apparatus shown in FIG. 69, where a radiation gain and a relative gain with respect to the reactance values Xb=Xd are shown. It can be clearly understood from FIG. 70 that there is very little change in the radiation gain G180 though the reactance values Xb=Xd=X of the load impedance elements 703b and 703d are changed. However, it is understood that the radiation gain G0 results in a very small value when the reactance value X=20 to 30 [Ω]. In other words, the relative gain (G180-G0) obtains a very large value. It is also understood that the maximum radiation gain Gmax gradually decreases.

When the desirable values of the radiation gain G180, maximum radiation gain Gmax and radiation gain G0 here are set respectively to a gain equal to or larger than 4 dBi, a gain equal to or larger than 7 dBi, and a gain equal to or larger than 2 dBi in a manner similar to those of the first and second implemental examples of the twelfth embodiment, the above-mentioned range is obtained when the reactance values Xb=Xd=X of the load impedance elements 703b and 703d are 50≦X≦30 [Ω]. At that time, the radiation gain G180 is 4.0 to 4.5 dBi, the radiation gain G0 is −1.4 to 1.0 dBi, and the maximum radiation gain Gmax is 7.0 to 8.1 dBi. An optimum value here is X=20 [Ω].

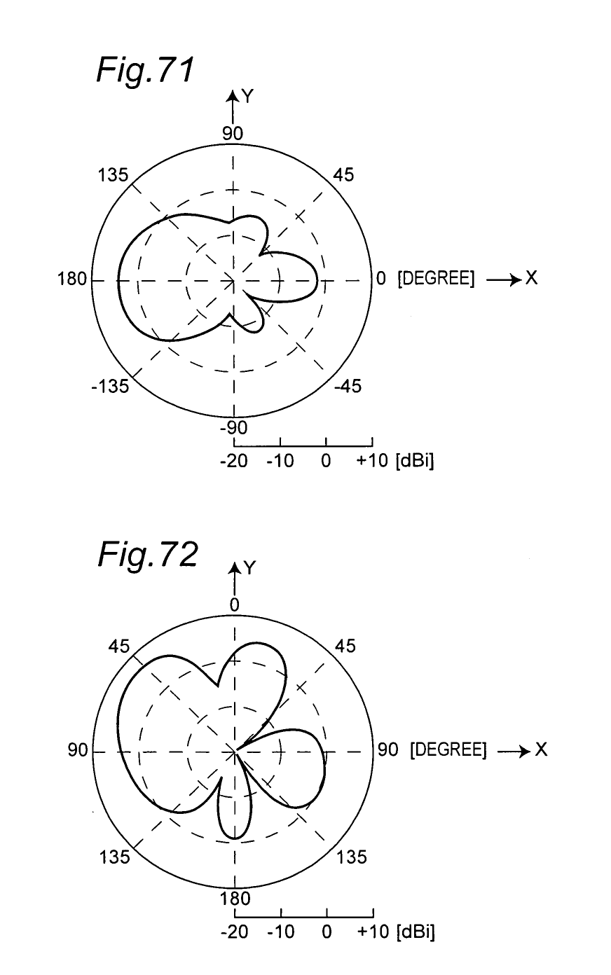

FIGS. 71 and 72 are graphs of measurement results of the sector pattern antenna apparatus shown in FIG. 69, where a radiation characteristic on the horizontal plane of the sector pattern antenna apparatus of FIG. 69 is shown in FIG. 71, and a radiation characteristic on the vertical plane of the sector pattern antenna apparatus of FIG. 69 is shown in FIG. 72. As is apparent from FIGS. 71 and 72, the radiation gain G180 was 4.0 dBi, the radiation gain G0 was −1.4 d Bi, the relative gain (G180-G0) was accordingly 5.4 dB, and the maximum radiation gain Gmax was 7.2 dBi. Thus, the radiation gain G180 resulted in the smaller value as compared with the first and second implemental examples of the twelfth embodiment described above.

In the sector pattern antenna apparatus according to the present embodiment, an angle on the horizontal plane covered by one antenna unit is 90 degrees because the horizontal plane is divided into four sector patterns. Therefore, a half-power angle thereof is most desirably 90 degrees, and it is desirable to approximate the half-power angle on the horizontal plane, other than the radiation gain, to the angle of the area to be covered (90 degrees in the present embodiment) in the antenna unit having the sector pattern. However, according to the radiation patterns on the horizontal plane shown in FIGS. 62 and 67, the half-power angle, which is a half angle width of the maximum value of the gain, showed the relatively narrow value of 65 degrees in the both cases. The value is desirably as close as possible to 90 degrees. However, the half-power angle was 75 degrees in the radiation pattern shown in FIG. 71, which was wider as compared with the examples shown in FIGS. 62 and 67.

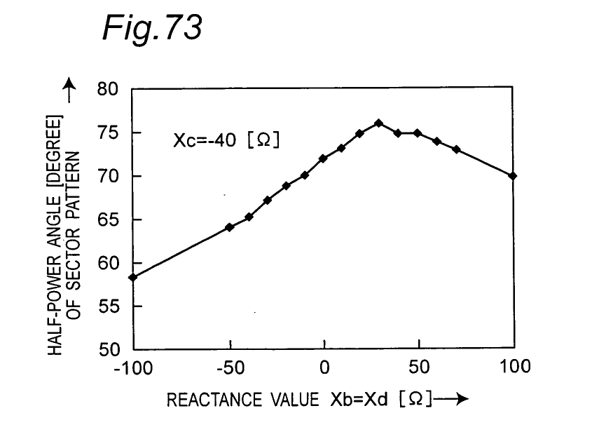

FIG. 73 is a graph of measurement results of the sector pattern antenna apparatus shown in FIG. 69, showing a half-power angle of a sector pattern with respect to the reactance values Xb=Xd. FIG. 73 shows a variation in the half-power angle when the respective reactance values X (≡Xb=Xd) of the other load impedance elements 703b and 703d are changed in the case of the reactance value Xc of the load impedance element 703c being Xc=−40 [Ω]. It is clearly understood from FIG. 73 that the half-power angle is 76 degrees, which is the maximum value, when the reactance value X=30 [Ω]. It is also understood that nearly the maximum value of 75 degrees was obtained as the half-power angle when X=20 [Ω] showing the radiation characteristic of the third implemental example of the twelfth embodiment. According to the above-mentioned configuration, the sector pattern antenna apparatus can be realized capable of changing the half-power angle.

In the descriptions of the respective implemental examples of the twelfth embodiment, the radio signal is fed to the antenna element 713a, in other words, the antenna unit 701a is operated. The same advantageous effect can be obtained when the radio signal is fed to the other antenna units 701b to 701d by constituting the other antenna units 701b to 701d in a manner similar to that of above.

In the first to third implemental examples of the twelfth embodiment described above, when a variable capacitance capacitor or a variable capacitance diode is used as the load impedance elements 703a to 703d, two electrostatic capacitances can be realized using one element. In such a manner, not only the number of the elements can be reduced because only one load impedance element is required, but also the switches 702a to 702d of one to two connection type can be advantageously used.

### First Modified Example of Twelfth Embodiment

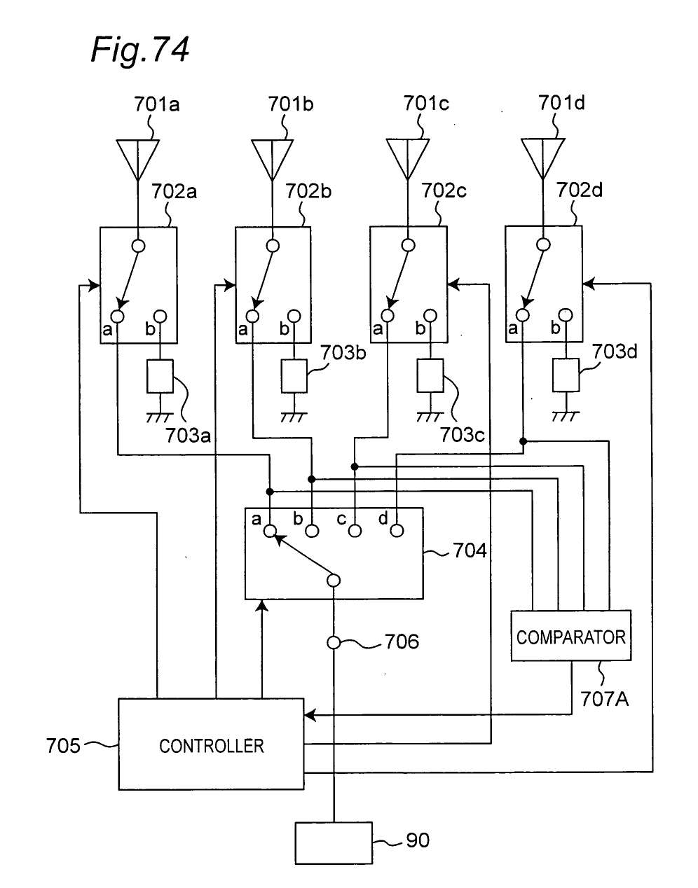

FIG. 74 is a block diagram showing a configuration of a sector pattern antenna apparatus according to a first modified example of the twelfth embodiment of the present invention.

In the first modified example of the twelfth embodiment, the radio signals inputted to the respective contacts “a” to “d” of the switch 704 are compared, and the controller 705 controls the switches 702a to 702d and the switch 704 based on the results of the comparison. The switches 702a to 702d are all switched over to the contact “a” side, and the antenna units 701a to 701d are connected to the contacts “a” to “d” of the switch 704. The comparator 707 compares the signal levels (or power levels) of four radio signals received by the respective antenna units 701a to 701d, and outputs information relating to the antenna unit having the maximum signal level to the controller 705. In response to this, the controller 705 controls the switches 702a to 702d and the switch 704 so that the antenna unit having the maximum signal level is connected to the output terminal 706, and controls the switches 702a to 702d so that the antenna units having other signal levels to the load impedance elements. This leads to that the antenna unit to be used can be judged at a higher speed. The apparatus shown in FIG. 74 can realize the apparatus configuration resulting from a combination of the apparatus configurations shown in FIGS. 60, 65 and 69.

### Second Modified Example of Twelfth Embodiment

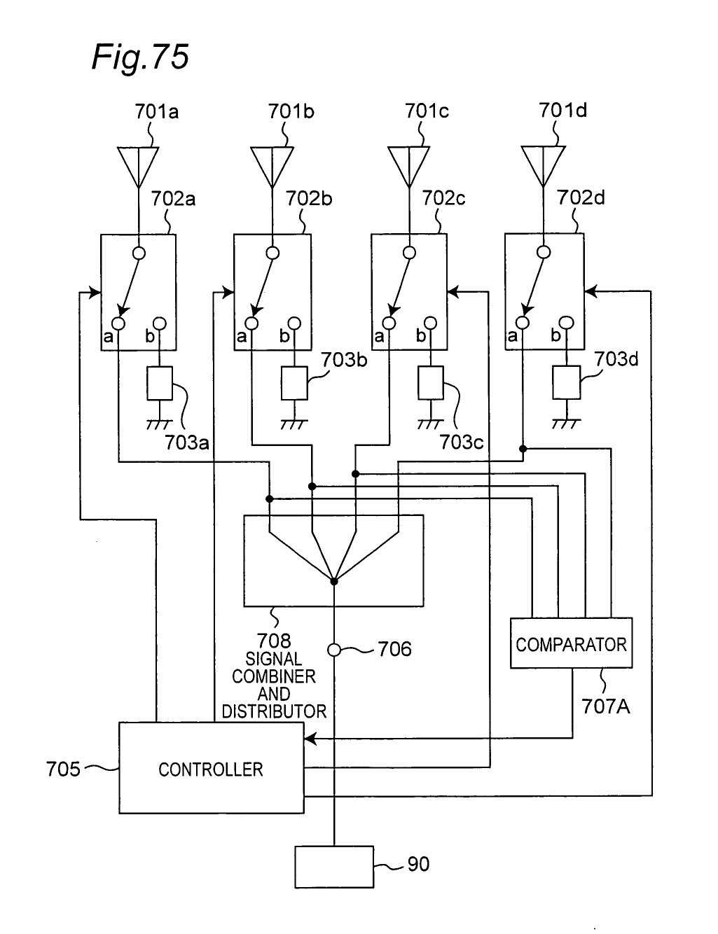

FIG. 75 is a block diagram showing a configuration of a sector pattern antenna apparatus according to a second modified example of the twelfth embodiment of the present invention.

The second modified example of the twelfth embodiment is characterized in that a signal combiner and distributor 708 is used in place of the switch 703 shown in FIG. 74. The radio signals from the antenna units 701a to 701d are combined by the signal combiner and distributor 708, and the resulting radio signal is outputted to the radio communication apparatus circuit 90 via the output terminal 706. The radio signal to be transmitted, which is inputted from the radio communication apparatus circuit 90 via the output terminal 706, is distributed into four radio signals by the signal combiner and distributor 708. The distributed four radio signals are outputted to the respective antenna units 701a to 701d via the respective contacts “a” of the switches 702a to 702d. A comparator 707A detects the signal levels of four radio signals detectable at once and compares them so as to judge the antenna unit having the maximum signal level, and outputs the information to the controller 705.

In the sector pattern antenna apparatus constituted as above, control-signal lines from the controller 705 to the switch 704 can be reduced, which realizes the downsizing of the control circuit. Further, the control processing of the controller 705 can be reduced.

### Third Modified Example of Twelfth Embodiment

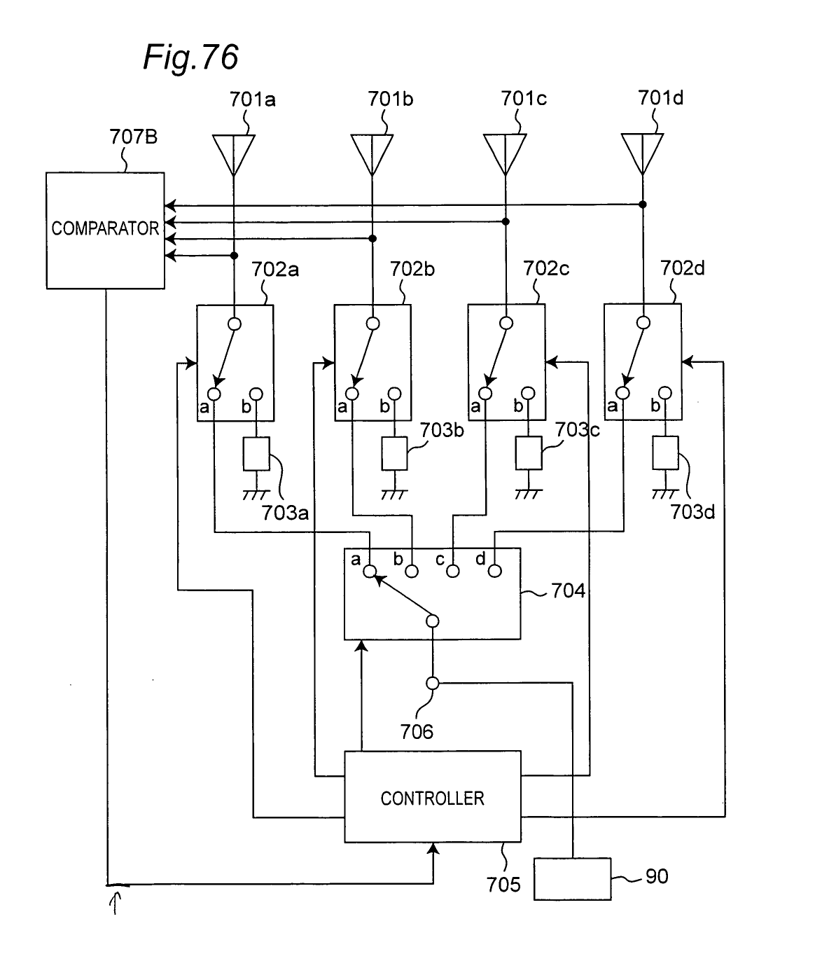

FIG. 76 is a block diagram showing a configuration of a sector pattern antenna apparatus according to a third modified example of the twelfth embodiment of the present invention.

The third modified example of the twelfth embodiment is characterized in that, as compared with the second modified example of the twelfth embodiment shown in FIG. 75, the signal levels of the radio signals respectively received by the antenna units 701a to 701d are directly compared by a comparator 707B, and the comparator 707B outputs the information relating to the antenna unit having the maximum signal level to the controller 705. The rest of the configuration is not any different to the configuration according to the second modified example of the twelfth embodiment. According to the third modified example of the twelfth embodiment, the antenna unit to be used can be judged at a higher speed, and the apparatus configuration resulting from a combination of the apparatus configurations shown in FIGS. 60, 65 and 69 can be realized.

### Fourth Modified Example of Twelfth Embodiment

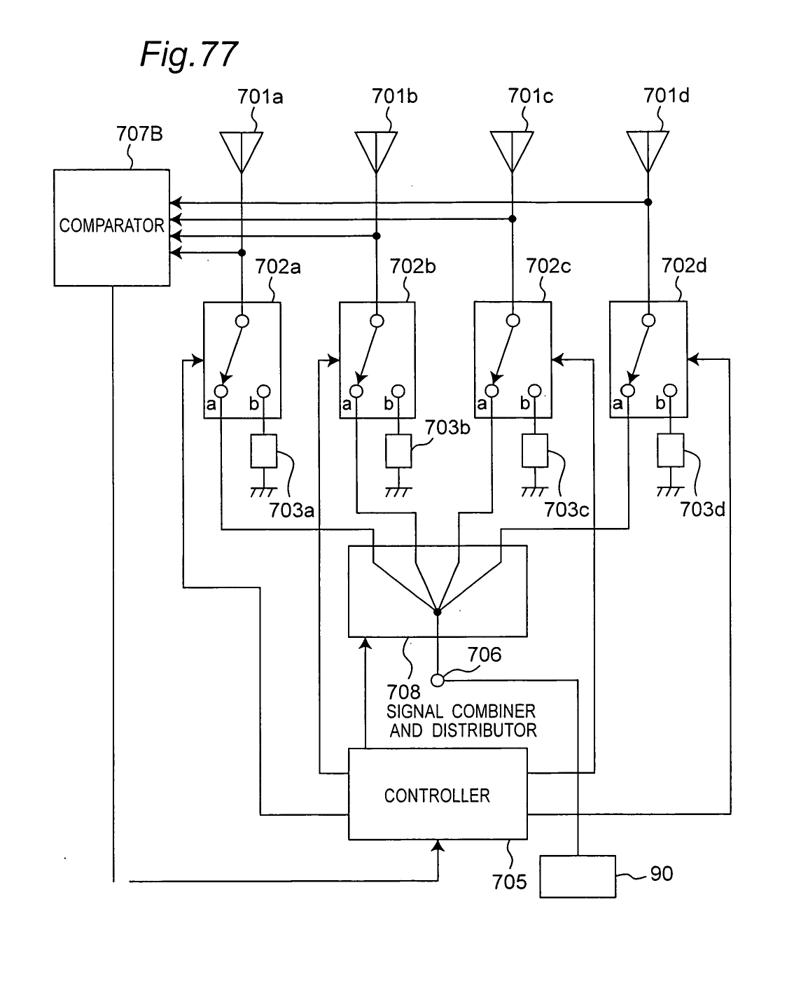

FIG. 77 is a block diagram showing a configuration of a sector pattern antenna apparatus according to a fourth modified example of the twelfth embodiment of the present invention.

The fourth modified example of the twelfth embodiment results from the combination of the second and third modified examples of the twelfth embodiment, and is characterized in that the signal combiner and distributor 708 is provided in place of the switch 704 shown in FIG. 76. According to the fourth modified example of the twelfth embodiment, the control-signal lines from the controller 705 to the switch 704 can be reduced, and this leads to that the control circuit can be downsized. Further, the control processing executed by the controller 705 can be also reduced.

### Fifth Modified Example of Twelfth Embodiment

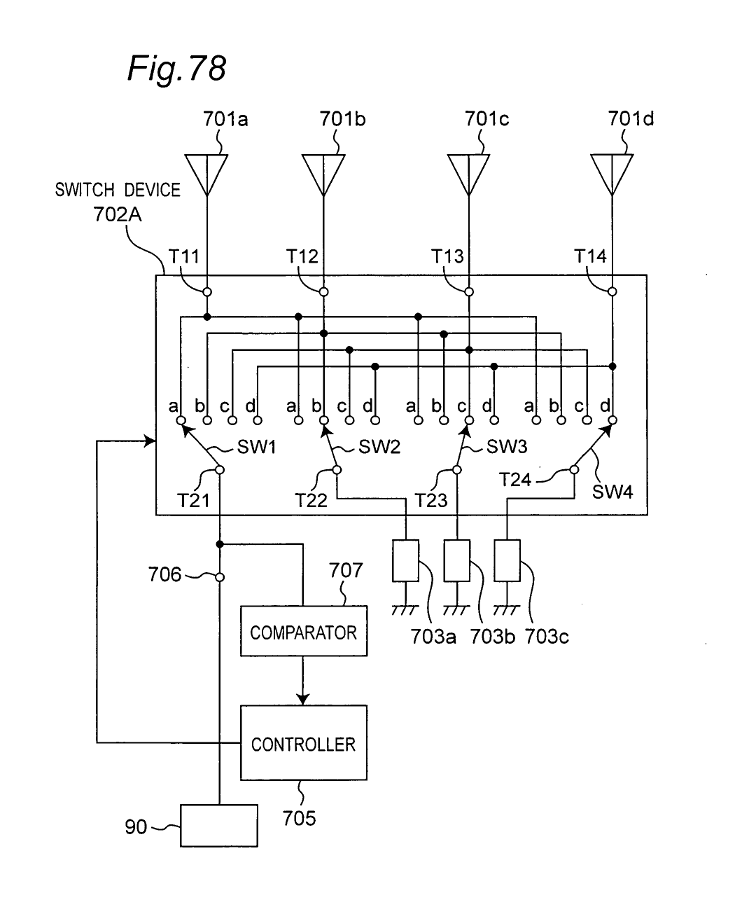

FIG. 78 is a block diagram showing a configuration of a sector pattern antenna apparatus according to a fifth modified example of the twelfth embodiment of the present invention. In the fifth modified example of the twelfth embodiment, a switch device 702A of four to four connection type is provided in place of the switches 702a to 702d and the switch 704.

Referring to FIG. 78, the switch 702A includes four switches SW1, SW2, SW3 and SW4. The antenna unit 701a is connected to respective contacts “a” of four switches SW1, SW2, SW3 and SW4 via a terminal T11. The antenna unit 701b is connected to respective contacts “b” of four switches SW1, SW2, SW3 and SW4 via a terminal T12. The antenna unit 701c is connected to respective contacts “c” of four switches SW1, SW2, SW3 and SW4 via a terminal T13. The antenna unit 701d is connected to respective contacts “d” of four switches SW1, SW2, SW3 and SW4 via a terminal T14. A common terminal T21 of the switch SW1 is connected to the output terminal 706 and the comparator 707. A common terminal T22 of the switch SW2 is grounded via the load impedance element 703a. A common terminal T23 of the switch SW3 is grounded via the load impedance element 703b. A common terminal T24 of the switch SW4 is grounded via the load impedance element 703c.

The controller 705 controls the switches SW1, SW2, SW3 and SW4 of the switch device 702A based on the information relating to the antenna unit that receives the radio signal having the maximum signal level (one of 701a to 701d) from the comparator 705 so that the relevant antenna unit is connected to the output terminal 706 and the other antenna units are selectively connected to the load impedance elements 703a, 703b and 703d.

According to the fifth modified example of the twelfth embodiment constituted as described above, the number of the provided components can be largely reduced and the circuits can be simplified by using the switch device 702A of four to four connection type. According to the apparatus shown in FIG. 78, the apparatus configuration resulting from a combination of the apparatus configurations shown in FIGS. 60, 65 and 69 can be realized.

### Sixth Modified Example of Twelfth Embodiment

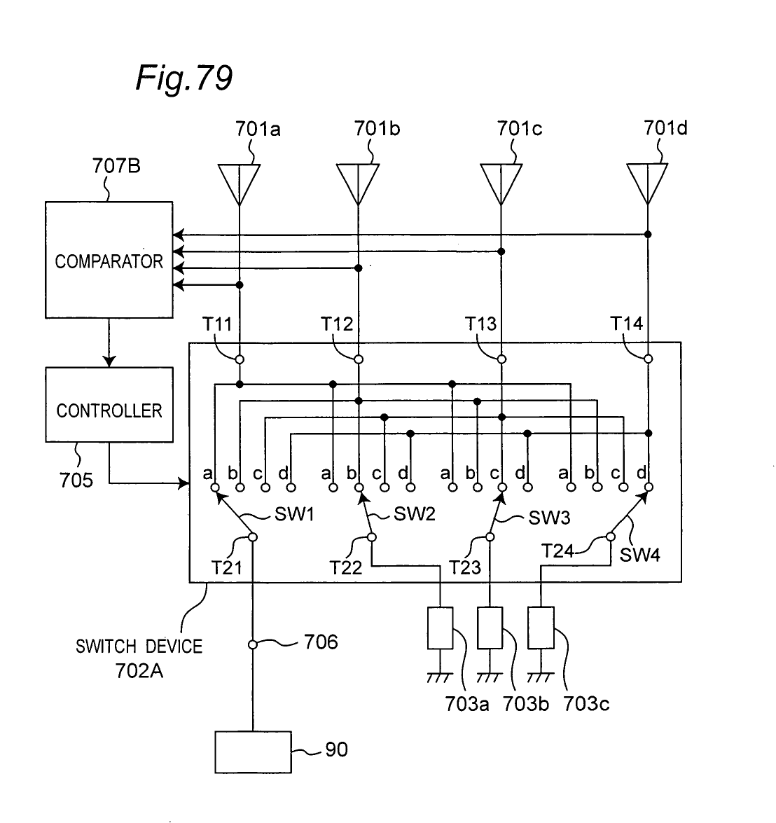

FIG. 79 is a block diagram showing a configuration of a sector pattern antenna apparatus according to a sixth modified example of the twelfth embodiment of the present invention.

In the sixth comparative example of the twelfth embodiment, the comparator 707B shown in FIG. 76 is provided in place of the comparator 707 shown in FIG. 78. The signal levels of the radio signals respectively received by the antenna units 701a to 701d are directly compared by the comparator 707B. The comparator 707B outputs the information relating to the antenna unit having the maximum signal level to the controller 705. The controller 705 controls the switches SW1, SW2, SW3 and SW4 of the switch device 702A based on the information of the antenna unit that receives the radio signal having the maximum signal level from the comparator 705 in such manner that the relevant antenna unit is connected to the output terminal 706 and other antenna units are selectively connected to the load impedance elements 703a, 703b and 703d. According to the sixth modified example of the twelfth embodiment constituted as described above, the antenna unit to be used can be judged at a higher speed, and the apparatus configuration resulting from a combination of the apparatus configurations shown in FIGS. 60, 65 and 69 can be realized.

As described above, according to the embodiment and the modified examples thereof, the plurality of waveguide antenna units and switches or switch device are provided. As a result, the antenna apparatus can be realized for maintaining a reduced size, having a thin shape, having a simplified structure, and being capable of radiating the radio wave with concentration of the power of the radio wave in the desired direction. Further, the antenna apparatus can be realized capable of such a control that the main beam having the maximum radiation gain is set in the desired direction for the transmission and reception.

### Other Modified Examples of Twelfth Embodiment

In the modified examples and the implemental examples of the twelfth embodiment, the sector pattern antenna apparatus including four antenna units 701a to 701d having the sector patterns in which the main beam directions are different from and orthogonal to each other is described as an example of the configuration. However, the present invention is not limited thereto. As described below, a plurality of antenna units having a plurality of sector patterns in which the main beam directions are different to each other may be provided. Because an antenna for strongly radiating the radio wave in two directions is required in order to cover a long and thin space, for example, a sector pattern antenna apparatus including antenna units each having two sector patterns may be provided. In the antenna apparatus thus constituted, the load impedance element is connected to the antenna units not used for the transmission and reception. Alternatively, a sector pattern antenna apparatus including antenna units each having two or at least five sector patterns may be provided. When the number of the sector patterns is increased, the antenna apparatus can be realized for achieving the higher-gain sector patterns by sharpening the main beam of one sector pattern with concentration of the energy.

In addition, the load impedance element may be adapted in such manner that one end thereof is grounded using a chip resistance, coil or capacitor. Accordingly, the circuits can be downsized. When the load impedance element includes only the reactance value component, the load impedance element may be adapted in such manner that one end of a high-frequency transmission line such as a micro strip line and coaxial line is short-circuited or left open. This leads to that an ideal load impedance element with a reduced loss can be realized.

The apparatus arrangements according to the twelfth embodiment and implemental examples and modified examples thereof may be applied to the device configurations according to the first to eleventh embodiments and implemental examples and modified examples thereof.

### INDUSTRIAL APPLICABILITY

As thus far described, according to the antenna apparatus according to the present invention, the plurality of antenna units for transmitting and receiving a radio signal using main beams of respective sector patterns, at least one load impedance element, and control means for controlling the antenna apparatus so that, among a plurality of antenna units, the antenna unit that transmits and receives a radio signal is connected to the radio communication apparatus circuit and the other antenna units are connected to the load impedance elements. As a result, the antenna apparatus can be realized for maintaining a reduced size, having a thin shape, having a simplified structure, and being capable of radiating the radio wave with concentration of the power of the radio wave in the desired direction. Further, the antenna apparatus can be realized for being capable of controlling the same apparatus so that the main beam having the maximum radiation gain is set in the desired direction for the transmission and reception.

1. An antenna apparatus comprising:
a plurality of antenna units for respectively transmitting and receiving a radio signal using a main beam of a sector pattern thereof;
at least one load impedance element; and
a controller for controlling the antenna apparatus so that the antenna unit that transmits and receives the radio signal of the plurality of antenna units is connected to a radio communication apparatus circuit and the other antenna units are connected to the load impedance element.

2. The antenna apparatus as claimed in claim 1,
wherein the plurality of antenna units is arranged so that directions of the main beams of the respective antenna units are different to each other.

3. The antenna apparatus as claimed in claim 1,
wherein the plurality of antenna units is arranged so that directions of the main beams of the respective antenna units are orthogonal to each other.

4. The antenna apparatus as claimed in claim 1,
wherein the controller controls the antenna apparatus so that the antenna unit that receives the radio signal having the maximum signal level among the radio signals received by the respective antenna units is connected to the radio communication apparatus circuit.

5. The antenna apparatus as claimed in claim 1,
wherein the plurality of antenna units is respectively formed by waveguide array antenna apparatus comprising a plurality of waveguide antenna units provided on a ground conductor, each of waveguide antenna units including a rectangular waveguide and an antenna element,
wherein each of the rectangular waveguides comprises the ground conductor, a ceiling conductor facing the ground conductor, and two side conductors that connect the ground conductor with the ceiling conductor and face each other, and has one end short-circuited by a terminating conductor and an open end, the open ends of the respective rectangular waveguides are arranged on corresponding sides of a polygon on the ground conductor having sides of the same number as that of the rectangular waveguides, and the rectangular waveguides extend outward from the corresponding sides of the polygon on the ground conductor,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

6. The antenna apparatus as claimed in claim 5,
wherein the plurality of waveguide antenna units has substantially the same structure as each other, the open ends of the respective rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

7. The antenna apparatus as claimed in claim 1,
wherein the plurality of antenna units is respectively formed by a waveguide array antenna apparatus comprising a plurality of waveguide antenna units provided on a ground conductor, each of the waveguide antenna units including a rectangular waveguide and an antenna element,
wherein each of the rectangular waveguides comprises the ground conductor, a ceiling conductor facing the ground conductor, and two side conductors that connect the ground conductor with the ceiling conductor and face each other, and has one end short-circuited by a terminating conductor and an open end, the open ends of the respective rectangular waveguides are arranged on corresponding sides of a polygon on the ground conductor having sides of the same number as that of the rectangular waveguides, the rectangular waveguides extend outward from the corresponding sides of the polygon on the ground conductor, and at least one of the rectangular waveguides comprises at least one slot formed in the ceiling conductor in a width direction of the rectangular waveguide,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

8. The antenna apparatus as claimed in claim 7,
wherein the waveguide array antenna apparatus comprises slots of the same number as an integral multiple of number of the feeding points, the slots are provided in each of the ceiling conductors constituting the waveguide antenna units of the same number as that of the feeding points, the numbers of the slots provided on the respective ceiling conductors are equal to each other, the plurality of the waveguide antenna units has the same structure as each other, the open ends of the rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

9. The antenna apparatus as claimed in claim 7,
wherein the slots are respectively formed at positions between connecting points with the antenna elements of the ceiling conductors, and the terminating conductors.

10. The antenna apparatus as claimed in claim 5,
wherein at least one part of an internal space in each of the rectangular waveguides is filled with a dielectric material.

11. The antenna apparatus as claimed in claim 10,
wherein the ground conductor is made of an electrical conductor pattern formed on a first surface of a dielectric substrate having first and second surfaces opposing to each other,
wherein the respective ceiling conductors are made of an electrical conductor pattern formed on the second surface of the dielectric substrate, and
wherein the side conductors and the terminating conductors are respectively formed by a plurality of through-hole conductors formed by filling through holes formed in the dielectric substrate in a thickness direction thereof with conductors.

12. The antenna apparatus as claimed in claim 1,
wherein the plurality of antenna units is respectively formed by a waveguide array antenna apparatus comprising a plurality of waveguide antenna units provided on a ground conductor, each of the waveguide antenna units including a rectangular waveguide and an antenna element,
wherein each of the rectangular waveguides comprises the ground conductor, a ceiling conductor facing the ground conductor, and two partitioning-wall conductors that connect the ground conductor with the ceiling conductor and face each other, the rectangular waveguides are arranged in such manner that the partitioning-wall conductors are respectively shared between the two rectangular waveguides adjacent to each other, each of the rectangular waveguides comprises one end short-circuited by a terminating conductor and an open end, the open ends of the respective rectangular waveguides are arranged on corresponding sides of a polygon on the ground conductor having sides of the same number as that of the rectangular waveguides, and the rectangular waveguides extend outward from the corresponding sides of the polygon on the ground conductor,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

13. The antenna apparatus as claimed in claim 12,
wherein the plurality of waveguide antenna units has the same structure as each other, the open ends of the respective rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

14. The antenna apparatus as claimed in claim 1,
wherein the plurality of antenna units is respectively formed by a waveguide array antenna apparatus comprising a plurality of waveguide antenna units provided on a ground conductor, each of the waveguide antenna units including a rectangular waveguide and an antenna element,
wherein each of the rectangular waveguides comprises the ground conductor, a ceiling conductor facing the ground conductor, and two partitioning-wall conductors that connect the ground conductor with the ceiling conductor and face each other, the rectangular waveguides are arranged in such manner that the partitioning-wall conductors are respectively shared between the two rectangular waveguides adjacent to each other, each of the rectangular waveguides has one end short-circuited by a terminating conductor and an open end, the open ends of the respective rectangular waveguides are arranged on corresponding sides of a polygon on the ground conductor having sides of the same number as that of the rectangular waveguides, the rectangular waveguides extend outward from the corresponding sides of the polygon on the ground conductor, and at least one of the rectangular waveguides comprises at least one slot formed in the ceiling conductor in a width direction of the rectangular waveguide,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

15. The antenna apparatus as claimed in claim 14,
wherein the waveguide array antenna apparatus comprises slots of the same number as an integral multiple of number of the feeding points, slots are provided in the ceiling conductors constituting the waveguide antenna units of the same number as that of the feeding points, the numbers of the slots provided in respective ceiling conductors are equal to each other, the plurality of the waveguide antenna units has the same structure as each other, the open ends of the rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

16. The antenna apparatus as claimed in claim 14,
wherein the slots are respectively formed at positions between connecting points with the antenna elements of the ceiling conductors, and the terminating conductors.

17. The antenna apparatus as claimed in claim 12,
wherein at least one part of an internal space in each of the rectangular waveguides is filled with a dielectric material.

18. The antenna apparatus as claimed in claim 17,
wherein the ground conductor is made of an electrical conductor pattern formed on a first surface of a dielectric substrate having first and second surfaces opposing to each other,
wherein the ceiling conductors are each made of an electrical conductor pattern formed on the second surface of the dielectric substrate, and
wherein the partitioning-wall conductors and the terminating conductors are respectively formed by a plurality of through-hole conductors formed by filling through holes formed in the dielectric substrate in a thickness direction thereof with conductors.

19. (Canceled)

20. (Canceled)

21. (Canceled)

22. (Canceled)

23. (Canceled)

24. (Canceled)

25. (Canceled)

26. The antenna apparatus as claimed in claim 1,
wherein the controller comprises:
a plurality of first switch provided to respectively correspond to the respective antenna units; and
a second switch connected to the first switch, and
wherein each of the first switch selectively connects the respective antenna units to one of the second switch and the load impedance element,
wherein the second switch selectively connects one of the plurality of first switch to the radio communication apparatus circuit, and
wherein the controller controls the plurality of first switch means and the second switch, so that, among the plurality of antenna units, the antenna unit that transmits and receives the radio signal is connected to the radio communication apparatus circuit, and the other antenna units are connected to the load impedance element.

27. The antenna apparatus as claimed in claim 1,
wherein the controller comprises:
a plurality of first switch provided to respectively correspond to the respective antenna units; and
a signal combiner and distributor means connected to the first switch, and
wherein each of the first switch selectively connects the antenna units to one of the signal combiner and distributor means and the load impedance element,
wherein the signal combiner and distributor means combine the respective radio signals outputted from the plurality of first switch, and outputs a combined signal to the radio communication apparatus circuit, and
wherein the controller controls the plurality of first switch, so that, among the plurality of antenna units, the antenna unit that transmits and receives the radio signal is connected to the radio communication apparatus circuit, and the other antenna units are connected to the load impedance element.

28. (Canceled)

29. (Canceled)

30. (Canceled)

31. (Canceled)

32. A waveguide array antenna apparatus comprising a plurality of waveguide antenna units provided on a ground conductor, each of the waveguide antenna units including a rectangular waveguide and an antenna element,
wherein each of the rectangular waveguides comprises the ground conductor, a ceiling conductor facing the ground conductor, and two side conductors that connect the ground conductor with the ceiling conductor and face each other, and has one end short-circuited by a terminating conductor and an open end, the open ends of the respective rectangular waveguides are arranged on corresponding sides of a polygon on the ground conductor having sides of the same number as that of the rectangular waveguides, and the rectangular waveguides extend outward from the corresponding sides of the polygon on the ground conductor,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

33. The waveguide array antenna apparatus as claimed in claim 32,
wherein the plurality of waveguide antenna units has the same structure as each other, the open ends of the respective rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

34. A waveguide array antenna apparatus comprising a plurality of waveguide antenna units provided on a ground conductor, each of the waveguide antenna units including a rectangular waveguide and an antenna element,
wherein each of the rectangular waveguides comprises the ground conductor, a ceiling conductor facing the ground conductor, and two side conductors that connect the ground conductor with the ceiling conductor and face each other, and has one end short-circuited by a terminating conductor and an open end, the open ends of the respective rectangular waveguides are arranged on corresponding sides of a polygon on the ground conductor having sides of the same number as that of the rectangular waveguides, the rectangular waveguides extend outward from the corresponding sides of the polygon on the ground conductor, and at least one of the rectangular waveguides comprises at least one slot formed in the ceiling conductor in a width direction of the rectangular waveguide,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

35. The waveguide array antenna apparatus as claimed in claim 34,
wherein the waveguide array antenna apparatus comprises slots of the same number as an integral multiple of number of the feeding points, slots are provided in the ceiling conductors constituting the waveguide antenna units of the same number as that of the feeding points, the numbers of the slots provided on the respective ceiling conductor are equal to each other, the plurality of the waveguide antenna units has the same structure as each other, the open ends of the rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

36. The waveguide array antenna apparatus as claimed in claim 34,
wherein the slots are respectively formed at positions between connecting points with the antenna elements of the ceiling conductors, and the terminating conductors.

37. The waveguide array antenna apparatus as claimed in claim 32,
wherein at least one part of an internal space in each of the rectangular waveguides is filled with a dielectric material.

38. The waveguide array antenna apparatus as claimed in claim 37,
wherein the ground conductor is made of an electrical conductor pattern formed on a first surface of a dielectric substrate having first and second surfaces opposing to each other,
wherein the ceiling conductors are each made of an electrical conductor pattern formed on the second surface of the dielectric substrate, and
wherein the side conductors and the terminating conductors are respectively formed by a plurality of through-hole conductors formed by filling through holes formed in the dielectric substrate in a thickness direction thereof with a conductor.

39. A waveguide array antenna apparatus comprising a plurality of waveguide antenna units provided on a ground conductor, each of the waveguide antenna units including a rectangular waveguide and an antenna element,
wherein, each of the rectangular waveguides comprises the ground conductor, a ceiling conductor facing the ground conductor, and two partitioning-wall conductors that connect the ground conductor with the ceiling conductor and face each other, the rectangular waveguides are arranged in such manner that the partitioning-wall conductors are respectively shared between the two rectangular waveguides adjacent to each other, each of the rectangular waveguides has one end short-circuited by a terminating conductor and an open end, the open ends of the respective rectangular waveguides are arranged on corresponding sides of a polygon on the ground conductor having sides of the same number as that of the rectangular waveguides, and the rectangular waveguides extend outward from the corresponding sides of the polygon on the ground conductor,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

40. The waveguide array antenna apparatus as claimed in claim 39,
wherein the plurality of waveguide antenna units has the same structure as each other, the open ends of the respective rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

41. A waveguide array antenna apparatus comprising a plurality of waveguide antenna units provided on a ground conductor, each of the waveguide antenna units including a rectangular waveguide and an antenna element,
wherein each of the rectangular waveguides comprises the ground conductor, a ceiling conductor facing the ground conductor, and two partitioning-wall conductors that connect the ground conductor with the ceiling conductor and face each other, the rectangular waveguides are arranged in such manner that the partitioning-wall conductors are respectively shared between the two rectangular waveguides adjacent to each other, each of the rectangular waveguides has one end short-circuited by a terminating conductor and an open end, the open ends of the respective rectangular waveguides are arranged on corresponding sides of a polygon on the ground conductor having sides of the same number as that of the rectangular waveguides, the rectangular waveguides extend outward from the corresponding sides of the polygon on the ground conductor, and at least one of the rectangular waveguides comprises at least one slot formed in the ceiling conductor in a width direction of the rectangular waveguide,
wherein one ends of the respective antenna elements are electrically connected to the ceiling conductors in vicinity of the open ends of the respective rectangular waveguides, and another ends thereof are electrically connected to each of a plurality of feeding points arranged on the ground conductor, and
wherein the waveguide antenna units respectively transmit and receive the radio signal using a predetermined directivity characteristic at the open ends of the rectangular waveguides constituting the waveguide antenna units.

42. The waveguide array antenna apparatus as claimed in claim 41,
wherein the waveguide array antenna apparatus comprises slots of the same number as an integral multiple of number of the feeding points, slots are provided in the ceiling conductors constituting the waveguide antenna units of the same number as that of the feeding points, the numbers of the slots provided on the respective ceiling conductors are equal to each other, the plurality of the waveguide antenna units has the same structure each other, the open ends of the rectangular waveguides are arranged on corresponding sides of a regular polygon on the ground conductor having sides of the same number as that of the rectangular waveguides, and the respective rectangular waveguides extend outward from the corresponding sides of the regular polygon on the ground conductor.

43. The waveguide array antenna apparatus as claimed in claim 41,
wherein the slots are respectively formed at positions between connecting points with the antenna elements of the ceiling conductors, and the terminating conductors.

44. The waveguide array antenna apparatus as claimed in claim 39,
wherein at least one part of an internal space in each of the rectangular waveguides is filled with a dielectric material.

45. The waveguide array antenna apparatus as claimed in claim 44,
wherein the ground conductor is made of an electrical conductor pattern formed on a first surface of a dielectric substrate having first and second surfaces opposing to each other,
wherein the respective ceiling conductors are made of an electrical conductor pattern formed on the second surface of the dielectric substrate, and
wherein the partitioning-wall conductors and the terminating conductors are respectively formed by a plurality of through-hole conductors formed by filling through holes formed in the dielectric substrate in a thickness direction thereof with a conductor.

46. (Canceled)

47. (Canceled)

48. (Canceled)

49. (Canceled)

50. (Canceled)

51. (Canceled)

52. (Canceled)

53. (Canceled)

54. (Canceled)
